(19) United States
(12) Patent Application Publication
(10) Pub. No.: US 2025/0167946 A1
(43) Pub. Date: May 22, 2025

(54) METHOD AND APPARATUS FOR APPLYING TRANSMISSION BEAM OF UPLINK CONTROL CHANNEL IN WIRELESS COMMUNICATION SYSTEM

(71) Applicant: Samsung Electronics Co., Ltd., Gyeonggi-do (KR)

(72) Inventors: Seongmok LIM, Gyeonggi-do (KR); Kyoungmin PARK, Gyeonggi-do (KR); Youngrok JANG, Gyeonggi-do (KR); Ameha Tsegaye ABEBE, Gyeonggi-do (KR); Hyoungju JI, Gyeonggi-do (KR)

(21) Appl. No.: 18/841,567

(22) PCT Filed: Feb. 24, 2023
(86) PCT No.: PCT/KR2023/002682

§ 371 Date: Aug. 26, 2024

(30) Foreign Application Priority Data
Feb. 24, 2022 (KR) 10-2022-0024513

(51) Int. Cl. H04L 5/00; H04W 72/0446

(52) U.S. Cl. CPC H04L 5/0044; H04W 72/0446

(57) ABSTRACT

The present disclosure relates to a 5G or 6G communication system for supporting a higher data transmission rate. According to various embodiments of the present disclosure, a method performed by a UE in a wireless communication system may comprise the steps of: receiving, from a base station, configuration information for one or more physical uplink control channel (PUCCH) resources indicating at least one transmission configuration indicator (TCI) state, and information about a TCI state application time; receiving, from the base station, first downlink control information (DCI) including information indicating first one or more TCI states, receiving, from the base station, second DCI including information indicating second one or more TCI states and an indicator for at least one PUCCH resource, and scheduling a PUCCH; and transmitting the PUCCH to the base station on the basis of the first DCI, the second DCI, and the TCI state application time.

### TECHNICAL FIELD

The disclosure relates to operations of a UE and a base station in a wireless communication system. Specifically, the disclosure relates to a method and a device for applying multiple transmission/reception beams in a wireless communication system.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. I don't know if this works. In addition, it has been considered to implement 6G mobile communication technologies (referred to as Beyond 5G systems) in terahertz bands (e.g., 95 GHz to 3 THz bands) in order to accomplish transmission rates fifty times faster than 5G mobile communication technologies and ultra-low latencies one-tenth of 5G mobile communication technologies.

In the initial stage of 5G mobile communication technologies, in order to support services and to satisfy performance requirements in connection with enhanced Mobile BroadBand (eMBB), Ultra Reliable & Low Latency Communications (URLLC), and massive Machine-Type Communications (mMTC), there has been ongoing standardization regarding beamforming and massive MIMO for alleviating radio-wave path loss and increasing radio-wave transmission distances in mmWave, numerology (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large-capacity data transmission and a polar code for highly reliable transmission of control information, L2 pre-processing, and network slicing for providing a dedicated network customized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience. New Radio Unlicensed (NR-U) aimed at system operations conforming to various regulation-related requirements in unlicensed bands, NR UE Power Saving, Non-Terrestrial Network (NTN) which is UE-satellite direct communication for securing coverage in an area in which communication with terrestrial networks is unavailable, and positioning.

Moreover, there has been ongoing standardization in wireless interface architecture/protocol fields regarding technologies such as Industrial Internet of Things (IIoT) for supporting new services through interworking and convergence with other industries, JAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service fields regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

If such 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting Augmented Reality (AR), Virtual Reality (VR), Mixed Reality (MR), etc., 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for securing coverage in terahertz bands of 6G mobile communication technologies, Full Dimensional MIMO (FD-MIMO), multi-antenna transmission technologies such as array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

With the advance of wireless communication systems as described above, various services can be provided, and accordingly there is a need for ways to smoothly provide these services. In particular, there is a need for a method for efficient application of a transmission beam of an uplink data channel.

### DISCLOSURE OF INVENTION

### Technical Problem

Various embodiments of the disclosure are to provide a device and a method capable of efficiently providing services in a wireless communication system.

### Solution to Problem

According to various embodiments of the disclosure, a user equipment (UE) in a wireless communication system may include: at least one transceiver; and a controller coupled to the at least one transceiver, wherein the controller is configured to receive, from a base station, configuration information on one or more physical uplink control channel (PUCCH) resources indicating at least one transmission configuration indicator (TCI) state and information on a TCI state application time, receive, from the base station, first downlink control information (DCI) including information indicating first one or more TCI states, receive, from the base station, second DCI which is for scheduling of a PUCCH and includes information indicating second one or more TCI states and an indicator for at least one PUCCH resource, and transmit the PUCCH to the base station based on the first DCI, the second DCI, and the TCI state application time.

According to various embodiments of the disclosure, a base station in a wireless communication system may include: at least one transceiver; and a controller coupled to the at least one transceiver, wherein the controller is configured to transmit, to a UE, configuration information on one or more physical uplink control channel (PUCCH) resources indicating at least one transmission configuration indicator (TCI) state and information on a TCI state application time, transmit, to the UE, first downlink control information (DCI) including information indicating first one or more TCI states, transmit, to the UE, second DCI which is for scheduling of a PUCCH and includes information indicating second one or more TCI states and an indicator for at least one PUCCH resource, and receive the PUCCH from the UE based on the first DCI, the second DCI, and the TCI state application time.

According to various embodiments of the disclosure, a method performed by a UE in a wireless communication system may include: receiving, from a base station, configuration information on one or more physical uplink control channel (PUCCH) resources indicating at least one transmission configuration indicator (TCI) state and information on a TCI state application time; receiving, from the base station, first downlink control information (DCI) including information indicating first one or more TCI states; receiving, from the base station, second DCI which is for scheduling of a PUCCH and includes information indicating second one or more TCI states and an indicator for at least one PUCCH resource; and transmitting the PUCCH to the base station based on the first DCI, the second DCI, and the TCI state application time.

### Advantageous Effects of Invention

According to various embodiments of the disclosure, a device and a method capable of efficiently providing services in a wireless communication system are provided.

### BRIEF DESCRIPTION OF DRAWINGS

FIG. 1 illustrates a basic structure of a time-frequency domain in a wireless communication system according to an embodiment of the disclosure.

FIG. 2 illustrates a structure of a frame, a subframe, and a slot in a wireless communication system according to an embodiment of the disclosure.

FIG. 3 illustrates an example of bandwidth part configuration in a wireless communication system according to an embodiment of the disclosure.

FIG. 4 illustrates an example of control resource set configuration of a downlink control channel in a wireless communication system according to an embodiment of the disclosure.

FIG. 5A illustrates a structure of a downlink control channel in a wireless communication system according to an embodiment of the disclosure.

FIG. 5B illustrates, in terms of spans, a case in which a UE may have multiple PDCCH monitoring occasions inside a slot in a wireless communication system according to an embodiment of the disclosure.

FIG. 6 illustrates an example of a DRX operation in a wireless communication system according to an embodiment of the disclosure.

FIG. 7 illustrates an example of base station beam allocation according to TC) state configuration in a wireless communication system according to an embodiment of the disclosure.

FIG. 8 illustrates an example of a method for TCI state allocation with regard to a PDCCH in a wireless communication system according to an embodiment of the disclosure.

FIG. 9 illustrates a TCI indication MAC CE signaling structure for a PDCCH DMRS in a wireless communication system according to an embodiment of the disclosure

FIG. 10 illustrates an example of beam configuration with regard to a control resource set and a search space in a wireless communication system according to an embodiment of the disclosure.

FIG. 11 illustrates an example of a method in which, upon receiving a downlink control channel, a UE selects a receivable control resource set in consideration of priority in a wireless communication system according to an embodiment of the disclosure.

FIG. 12 illustrates an example of a method in which a base station and a UE transmit/receive data in consideration of a downlink data channel and a rate matching resource in a wireless communication system according to an embodiment of the disclosure.

FIG. 13 illustrates an example of frequency domain resource allocation with regard to a PDSCH in a wireless communication system according to an embodiment of the disclosure.

FIG. 14 illustrates an example of time domain resource allocation with regard to a PDSCH in a wireless communication system according to an embodiment of the disclosure.

FIG. 15 illustrates a process for beam configuration and activation with regard to a PDSCH.

FIG. 16 illustrates an example of a MAC CE for PUCCH resource group-based spatial relation activation in the wireless communication system according to an embodiment of the disclosure;

FIG. 17 illustrates an example of PUSCH repeated transmission type B in a wireless communication system according to an embodiment of the disclosure.

FIG. 18 illustrates radio protocol structures of a base station and a UE in single cell, carrier aggregation, and dual connectivity situations in a wireless communication system according to an embodiment of the disclosure.

FIG. 19 illustrates an example of antenna port configurations and resource allocation for cooperative communication in the wireless communication system according to an embodiment of the disclosure;

FIG. 20 illustrates an example of downlink control information (DCI) configurations for cooperative communication in the wireless communication system according to an embodiment of the disclosure;

FIG. 21 illustrates an enhanced PDSCH TCI state activation/deactivation MAC-CE structure;

FIG. 22 illustrates an RLM RS selection procedure according to an embodiment of the disclosure;

FIG. 23 illustrates an example of a MAC-CE structure for joint TCI state activation and indication in the wireless communication system according to an embodiment of the disclosure;

FIG. 24 illustrates an example of a MAC-CE structure for joint TCI state activation and indication in the wireless communication system according to an embodiment of the disclosure;

FIG. 25 illustrates an example of a MAC-CE structure for joint TCI state activation and indication in the wireless communication system according to an embodiment of the disclosure;

FIG. 26 illustrates an example of a MAC-CE structure for separate TCI state activation and indication in the wireless communication system according to an embodiment of the disclosure;

FIG. 27 illustrates an example of a MAC-CE structure for separate TCI state activation and indication in the wireless communication system according to an embodiment of the disclosure;

FIG. 28 illustrates an example of a MAC-CE structure for separate TCI state activation and indication in the wireless communication system according to an embodiment of the disclosure;

FIG. 29 illustrates an example of a MAC-CE structure for separate TCI state activation and indication in the wireless communication system according to an embodiment of the disclosure;

FIG. 30 illustrates an example of a MAC-CE structure for joint and separate TCI state activation and indication in the wireless communication system according to an embodiment of the disclosure;

FIG. 31 illustrates an example of a MAC-CE structure for joint and separate TCI state activation and indication in the wireless communication system according to an embodiment of the disclosure;

FIG. 32 illustrates a beam application time that may be considered when a unified TCI scheme is used in the wireless communication system according to an embodiment of the disclosure;

FIG. 33 illustrates an example of a MAC-CE structure for activation and indication of multiple joint TCI states in the wireless communication system according to an embodiment of the disclosure;

FIG. 34 illustrates an example of a MAC-CE structure for activation and indication of multiple separate TCI states in the wireless communication system according to an embodiment of the disclosure;

FIG. 35 illustrates an example of a MAC-CE structure for activation and indication of multiple separate TCI states in the wireless communication system according to an embodiment of the disclosure;

FIG. 36 illustrates a procedure of receiving a PDSCH and transmitting a PUCCH by a terminal in accordance with PDCCH reception indicating a TCI state according to an embodiment of the disclosure;

FIG. 37A illustrates an operation flow of a base station when an uplink transmission beam of a PUCCH is determined based on a higher-layer parameter according to an embodiment of the disclosure;

FIG. 37B illustrates an operation flow of a terminal when an uplink transmission beam of a PUCCH is determined based on a higher-layer parameter according to an embodiment of the disclosure;

FIG. 38 illustrates an example of a MAC CE for activating the number of indicated TCI states to be applied and a method of applying the TCI states according to an embodiment of the disclosure; and

FIG. 39 illustrates an example of a MAC CE for activating the number of indicated TCI states to be applied and a method of applying the TCI states according to an embodiment of the disclosure.

FIG. 40 illustrates a structure of a UE in a wireless communication system according to an embodiment of the disclosure.

FIG. 41 illustrates a structure of a base station in a wireless communication system according to an embodiment of the disclosure.

### MODE FOR THE INVENTION

Hereinafter, embodiments of the disclosure will be described in detail with reference to the accompanying drawings. In describing the embodiments, descriptions related to technical contents well-known in the relevant art and not associated directly with the disclosure will be omitted. Such an omission of unnecessary descriptions is intended to prevent obscuring of the main idea of the disclosure and more clearly transfer the main idea. For the same reason, in the accompanying drawings, some elements may be exaggerated, omitted, or schematically illustrated. Furthermore, the size of each element does not completely reflect the actual size. In the respective drawings, identical or corresponding elements are provided with identical reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The embodiments of the disclosure are provided to completely disclose the disclosure and inform those skilled in the art of the scope of the disclosure, and the disclosure is defined only by the scope of the appended claims. Throughout the specification, the same or like reference signs indicate the same or like elements. Furthermore, in describing the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. In the disclosure, a “downlink (DL)” may refer to a radio link via which a base station transmits a signal to a terminal, and an “uplink (UL)” may refer to a radio link via which a terminal transmits a signal to a base station. Furthermore, in the following description, LTE or LTE-A systems may be described by way of example, but the embodiments of the disclosure may also be applied to other communication systems having similar technical backgrounds or channel types. Examples of such communication systems may include 5th generation mobile communication technologies (5G, new radio, and NR) developed beyond LTE-A, and in the following description, the “5G” may be the concept that covers the exiting LTE, LTE-A, and other similar services. In addition, based on determinations by those skilled in the art, the disclosure may also be applied to other communication systems through some modifications without significantly departing from the scope of the disclosure. The contents of the disclosure may be applied to frequency division duplex (FDD) or time division duplex (TDD) systems.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). In some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the “unit” refers to a software element or a hardware element, such as a Field Programmable Gate Array (FPGA) or an Application Specific Integrated Circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card. Furthermore, the “unit” in various embodiments of the disclosure may include one or more processors. Furthermore, in describing the disclosure, a detailed description of known functions or configurations incorporated herein will be omitted when it is determined that the description may make the subject matter of the disclosure unnecessarily unclear. Hereinafter, various embodiments of the disclosure will be described with reference to the accompanying drawings.

A wireless communication system is advancing to a broadband wireless communication system for providing high-speed and high-quality packet data services using communication standards, such as high-speed packet access (HSPA) of 3GPP, LTE (long-term evolution or evolved universal terrestrial radio access (E-UTRA)), LTE-Advanced (LTE-A), LTE-Pro, high-rate packet data (HRPD) of 3GPP2, ultra-mobile broadband (UMB), IEEE 802.16e, and the like, as well as typical voice-based services.

As a typical example of the broadband wireless communication system, an LTE system employs an orthogonal frequency division multiplexing (OFDM) scheme in a downlink (DL) and employs a single carrier frequency division multiple access (SC-FDMA) scheme in an uplink (UL). The uplink may refer to a radio link via which a user equipment (UE) or a mobile station (MS) transmits data or control signals to a base station (BS) or eNode B. The downlink may refer to a radio link via which the base station transmits data or control signals to the UE. The above multiple access scheme may separate data or control information of respective users by allocating and operating time-frequency resources for transmitting the data or control information for each user so as to avoid overlapping each other, that is, so as to establish orthogonality.

Since a 5G communication system, which is a post-LTE communication system, must freely reflect various requirements of users, service providers, and the like, services satisfying various requirements must be supported. The services considered in the 5G communication system include enhanced mobile broadband (eMBB) communication, massive machine-type communication (mMTC), ultra-reliability low-latency communication (URLLC), and the like.

eMBB aims at providing a data rate higher than that supported by existing LTE, LTE-A, or LTE-Pro. For example, in the 5G communication system, eMBB must provide a peak data rate of 20 Gbps in the downlink and a peak data rate of 10 Gbps in the uplink for a single base station. Furthermore, the 5G communication system must provide an increased user-perceived data rate to the UE, as well as the maximum data rate. In order to satisfy such requirements, transmission/reception technologies including a further enhanced multi-input multi-output (MIMO) transmission technique are required to be improved. In addition, the data rate required for the 5G communication system may be obtained using a frequency bandwidth more than 20 MHz in a frequency band of 3 to 6 GHz or 6 GHz or more, instead of transmitting signals using a transmission bandwidth up to 20 MHz in a band of 2 GHz used in LTE.

In addition, mMTC is being considered to support application services such as the Internet of Things (IoT) in the 5G communication system. mMTC has requirements, such as support of connection of a large number of UEs in a cell, enhancement coverage of UEs, improved battery time, a reduction in the cost of a UE, and the like, in order to effectively provide the Internet of Things. Since the Internet of Things provides communication functions ile being provided to various sensors and various devices, it must support a large number of UEs (e.g., 1,000.000 UEs/km²) in a cell. In addition, the UEs supporting mMTC may require wider coverage than those of other services provided by the 5G communication system because the UEs are likely to be located in a shadow area, such as a basement of a building, which is not covered by the cell due to the nature of the service. The UE supporting mMTC must be configured to be inexpensive, and may require a very long battery life-time such as 10 to 15 years because it is difficult to frequently replace the battery of the UE.

URLLC is a cellular-based mission-critical wireless communication service. For example, URLLC may be used for services such as remote control for robots or machines, industrial automation, unmanned aerial vehicles, remote health care, and emergency alert. Thus, URLLC must provide communication with ultra-low latency and ultra-high reliability. For example, a service supporting URLLC must satisfy an air interface latency of less than 0.5 ms, and may also requires a packet error rate of 10⁻⁵ or less. Therefore, for the services supporting URLLC, a 5G system must provide a transmit time interval (TTI) shorter than those of other services, and also may require a design for assigning a large number of resources in a frequency band in order to secure reliability of a communication link.

The three services in 5G, that is, eMBB. URLLC, and mMTC, may be multiplexed and transmitted in a single system. In this case, different transmission/reception techniques and transmission/reception parameters may be used between services in order to satisfy different requirements of the respective services. Of course, 5G is not limited to the three services described above.

In the following description, some of terms and names defined in the 3GPP standards (standards for 5G, NR, LTE, or similar systems) may be used for the sake of descriptive convenience. However, the disclosure is not limited by these terms and names, and may be applied in the same way to systems that conform other standards. Furthermore, in the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as used herein, and other terms referring to subjects having equivalent technical meanings may be used.

### [NR Time-Frequency Resources]

Hereinafter, a frame structure of a 5G system will be described in more detail with reference to the accompanying drawings.

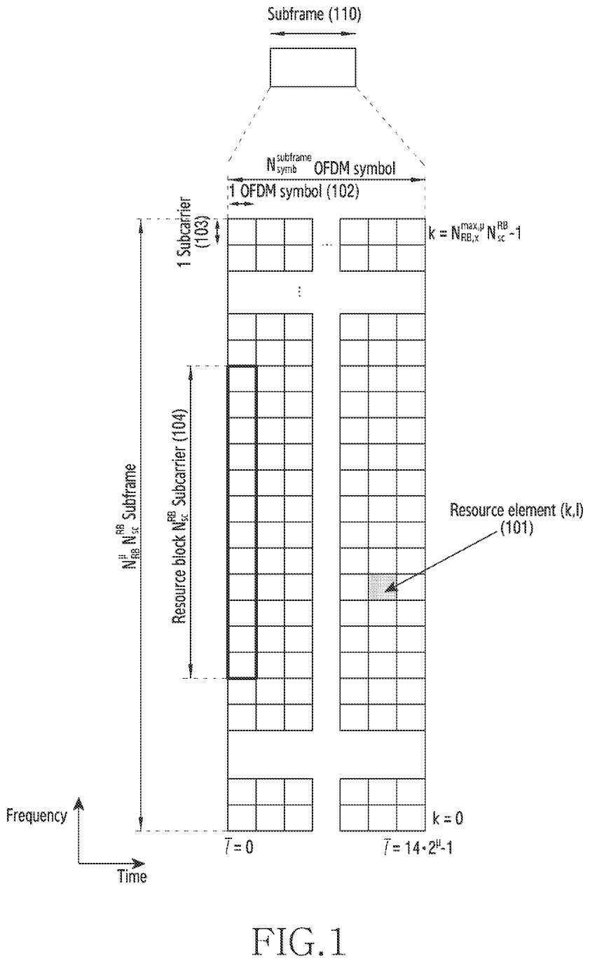

FIG. 1 illustrates a basic structure of a time-frequency domain in a wireless communication system according to an embodiment of the disclosure. Specifically, FIG. 1 illustrates ae basic structure of a time-frequency domain, which is a radio resource domain used to transmit data or control channels, in a 5G system.

The basic unit of resources in the time-frequency domain is a resource element (RE) 101, which may be defined as one orthogonal frequency division multiplexing (OFDM) symbol 102 on the time axis and one subcarrier 103 on the frequency axis. In the frequency domain, N_{SC}^{RB} (for example, 12) consecutive REs may constitute one resource block (RB) 104. Referring to FIG. 1, N_{symb}^{subframe,μ} is the number of OFDM symbols per subframe 110 for subcarrier spacing configuration μ. A detailed description of the resource structure in the 5G system may refer to standard TS 38 211 section 4.

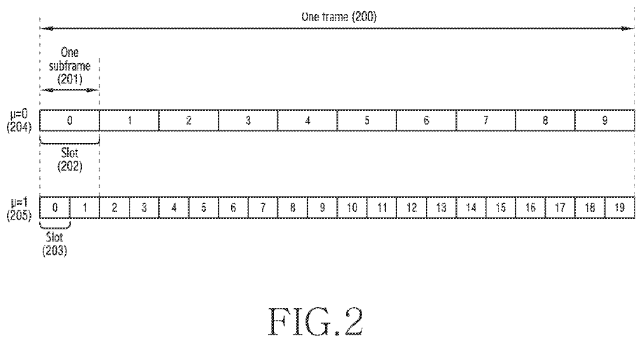

FIG. 2 illustrates a structure of a frame, a subframe, and a slot in a wireless communication system according to an embodiment of the disclosure. Specifically, FIG. 2 illustrates an example of a structure of a frame 200, a subframe 201, and a slot 202.

One frame 200 may be defined as 10 ms. One subframe 201 may be defined as 1 millisecond (ms), and thus one frame 200 may include a total of ten subframes 201. One slot 202 or 203 may be defined as 14 OFDM symbols (that is, the number of symbols per one slot N_{symb}^{slot}=14). One subframe 201 may include one or multiple slots 202 and 203. The number of slots 202 and 203 per one subframe 201 may vary depending on configuration values p for the subcarrier spacing 204 or 205. The example of FIG. 2 shows the case of μ=0 (204) and the case of μ=1 (205) as a configuration value for a subcarrier spacing. In the case of μ=0 (204), one subframe 201 may include one slot 202, and in the case of μ=1 (205), one subframe 201 may include two slots 203. That is, the number of slots per one subframe Nₛₗₒₜ^{sunframe,μ} may differ depending on the subcarrier spacing configuration value μ, and the number of slots per one frame Nₛₗₒₜ^{frame,μ} may differ accordingly. Nₛₗₒₜ^{sunframe,μ} and Nₛₗₒₜ^{frame,μ} may be defined according to each subcarrier spacing configuration p as in Table 1 below.

TABLE 1

| μ | N_{symb}^{slot} | Nₛₗₒₜ^{frame,μ} | Nₛₗₒₜ^{sunframe,μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

### [Bandwidth Part (BWP)]

Hereinafter, bandwidth part (BWP) configuration in a 5G communication system will be described in detail with reference to the accompanying drawings.

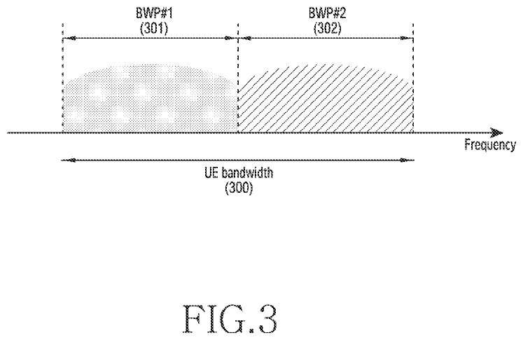

FIG. 3 illustrates an example of bandwidth part configuration in a wireless communication system according to an embodiment of the disclosure. Specifically, referring to FIG. 3, FIG. 3 illustrates an example in which a UE bandwidth 300 is configured to include two bandwidth parts, that is, bandwidth part #1 (BWP #1) 301 and bandwidth part #2 (BWP #2) 302.

A base station may configure one or multiple bandwidth parts for a UE. The base station may configure the following pieces of information with regard to each bandwidth part as given in Table 2 below.

TABLE 2

```
BWP ::=  SEQUENCE {
        bwp-Id  BWP-Id,
  (bandwidth part identifier)
        locationAndBandwidth INTEGER (1..65536),
        (bandwidth part location)
        subcarrierSpacing ENUMERATED {n0, n1, n2, n3,
n4, n5},
        (subcarrier spacing)
        cyclicPrefix ENUMERATED
{ extended }
        (cyclic prefix)
}
```

Referring to Table 2, “locationAndBandwidth” indicates the location and bandwidth of a corresponding bandwidth part in the frequency domain. “subcarrierSpacing” indicates a subcarrier spacing to be used in a corresponding bandwidth part. “cyclicPrefix” indicates whether a cyclic prefix (CP) is used for a corresponding bandwidth part.

According to an embodiment of the disclosure, the bandwidth part configuration is not limited by Table 2, and in addition to the configuration information in Table 2, various parameters related to the bandwidth part may be configured for the UE. The base station may transfer the configuration information to the UE through upper layer signaling, for example, radio resource control (RRC) signaling. One configured bandwidth part or at least one bandwidth part among multiple configured bandwidth parts may be activated. The base station may transfer whether or not to activate a configured bandwidth part to the UE semi-statically through RRC signaling. The base station may transfer whether or not to activate a configured bandwidth part to the UE dynamically through downlink control information (DCI).

According to an embodiment, before a radio resource control (RRC) connection, an initial bandwidth part (BWP) for initial access may be configured for the UE by the base station through a master information block (MIB). To be more specific, in order to receive system information (which may correspond to remaining system information (RMSI) or system information block 1 (SIB1)) required for initial access through the MIB, the UE may receive, in the initial access stage, configuration information on a search space and a control resource set (CORESET) through which a PDCCH is transmissible. The UE may receive configuration information with regard to a search space through the MIB. Each of the control resource set and the search space configured through the MIB may be considered identity (ID) 0. The base station may notify the UE of configuration information, such as frequency allocation information, time allocation information, and numerology, regarding CORESET #0 through the MIB. In addition, the base station may notify the UE of configuration information regarding the monitoring cycle and occasion regarding control resource set #0 (for example, configuration information regarding search space #0) through the MIB. The UE may consider that a frequency domain configured by control resource set #0 acquired from the MIB is an initial bandwidth part for initial access. The ID of the initial bandwidth part may be considered to be 0.

According to various embodiments of the disclosure, the bandwidth part-related configuration supported by 5G may be used for various purposes.

According to an embodiment, if the bandwidth supported by the UE is smaller than the system bandwidth, this may be supported through the bandwidth part configuration. For example, the base station may configure the frequency location of the bandwidth part (configuration information 2) for the UE, and the UE may transmit/receive data at a specific frequency location within the system bandwidth.

In addition, according to an embodiment, the base station may configure multiple bandwidth parts for the UE for the purpose of supporting different numerologies. For example, in order to support a UE's data transmission/reception using both a subcarrier spacing of 15 kHz and a subcarrier spacing of 30 kHz, two bandwidth parts may be configured as subcarrier spacings of 15 kHz and 30 kHz, respectively. Different bandwidth parts may be subjected to frequency division multiplexing (FDM), and if data is to be transmitted/received at a specific subcarrier spacing, the bandwidth part configured as the corresponding subcarrier spacing may be activated.

In addition, according to an embodiment, the base station may configure bandwidth parts having different sizes of bandwidths for the UE for the purpose of reducing power consumed by the UE. For example, if the UE supports a substantially large bandwidth, for example, 100 MHz, and always transmits/receives data with the corresponding bandwidth, a substantially large amount of power consumption may occur. Particularly, it may be substantially inefficient from the viewpoint of power consumption to unnecessarily monitor the downlink control channel with a large bandwidth of 100 MHz in the absence of traffic. In order to reduce power consumed by the UE, the base station may configure a bandwidth part of a relatively small bandwidth (for example, a bandwidth part of 20 MHz) for the UE. The UE may perform a monitoring operation in the 20 MHz bandwidth part in the absence of traffic, and may transmit/receive data with the 100 MHz bandwidth part as instructed by the base station if data has occurred.

In connection with the bandwidth part configuring method, UEs, before being RRC-connected, may receive configuration information regarding the initial bandwidth part through an MIB in the initial access step. More specifically, a control resource set (CORESET) may be configured for the UE. The control resource set configured for the UE may be a control resource set for a downlink control channel which may be used to transmit DCI for scheduling an SIB from the MIB of a physical broadcast channel (PBCH). The bandwidth of the control resource set configured through the MIB may be regarded as an initial bandwidth part. The UE may receive, through the configured initial bandwidth part, a PDSCH through which an SIB is transmitted. The initial bandwidth part may be used not only for the purpose of receiving the SIB, but also for other system information (OSI), paging, random access, or the like.

### [Bandwidth Part (BWP) Change]

If a UE has one or more bandwidth parts configured therefor, the base station may instruct to the UE to change (or switch) the bandwidth parts by using a bandwidth part indicator field inside DCI. As an example, if the currently activated bandwidth part of the UE is bandwidth part #1 301 in FIG. 3, the base station may indicate bandwidth part #2 302 with a bandwidth part indicator inside DCI. The UE may change the bandwidth part to bandwidth part #2 302 indicated by the bandwidth part indicator inside received DCI.

As described above, DCI-based bandwidth part changing may be indicated by DCI for scheduling a PDSCH or a PUSCH. Upon receiving a bandwidth part change request, the UE needs to be able to receive or transmit the PDSCH or PUSCH scheduled by the corresponding DCI in the changed bandwidth part with no problem. To this end, requirements for the delay time (T_{BWP}) required during a bandwidth part change are specified in standards. The requirements for the delay time (T_{BWP}) may be defined, for example, as follows, but the example given below is not limiting.

TABLE 3

| | NR Slot | BWP switch delay T_{BWP} (slots) | |
|---|---|---|---|
| μ | length (ms) | Type 1^{Note 1} | Type 2^{Note 1} |
| 0 | 1 | 1 | 3 |
| 1 | 0.5 | 2 | 5 |
| 2 | 0.25 | 3 | 9 |
| 3 | 0.125 | 6 | 18 |

Note 1:
Depends on UE capability.
Note 2:
If the BWP switch involves changing of SCS, the BWP switch delay is determined by the larger one between the SCS before BWP switch and the SCS after BWP switch.

The requirements for the bandwidth part change delay time may support type 1 or type 2, depending on the capability of the UE. The UE may report the supportable bandwidth part delay time type to the base station.

If the UE has received DCI including a bandwidth part change indicator in slot n, according to the above-described requirement regarding the bandwidth part change delay time, the UE may complete a change to the new bandwidth part indicated by the bandwidth part change indicator at a timepoint not later than slot n+T_{BWP}. The UE may transmit/receive a data channel scheduled by the corresponding DCI in the changed new bandwidth part. If the base station wants to schedule a data channel by using the new bandwidth part, the base station may determine time domain resource allocation regarding the data channel in consideration of the UE's bandwidth part change delay time (T_{BWP}). When scheduling a data channel by using the new bandwidth part, the base station may schedule the corresponding data channel after the bandwidth part change delay time, in connection with the method for determining time domain resource allocation regarding the data channel. The UE may not expect that the DCI that indicates a bandwidth part change will indicate a slot offset (K0 or K2) value smaller than the bandwidth part change delay time (T_{BWP}).

If the UE has received DCI (for example, DCI format 1_1 or 0_1) indicating a bandwidth part change, the UE may perform no transmission or reception during a time interval from the third symbol of the slot used to receive a PDCCH including the corresponding DCI to the start point of the slot indicated by a slot offset (K0 or K2) value indicated by a time domain resource allocation indicator field in the corresponding DCI. For example, if the UE has received DCI indicating a bandwidth part change in slot n, and if the slot offset value indicated by the corresponding DCI is K, the UE may perform no transmission or reception from the third symbol of slot n to the symbol before slot n+K (for example, the last symbol of slot n+K−1).

### [SS/PBCH Block]

Hereinafter, synchronization signal (SS)/PBCH blocks in 5G will be described.

An SS/PBCH block may refer to a physical layer channel block including a primary SS (PSS), a secondary SS (SSS), and a PBCH. Specifically, functions of the PSS, SSS, and PBCH are as described below.

PSS: A signal which becomes a reference signal for downlink time/frequency synchronization, and may provide some partial information of a cell ID.

SSS: A reference for downlink time/frequency synchronization, and may provide the remaining cell ID information not provided by the PSS. Additionally, the SSS may serve as a reference signal for PBCH demodulation of a PBCH.

PBCH: may provide essential system information necessary for the UE's data channel and control channel transmission/reception. The essential system information may include search space-related control information indicating a control channel's radio resource mapping information, scheduling control information regarding a separate data channel for transmitting system information, and the like.

SS/PBCH block: may include a combination of a PSS, an SSS, and a PBCH. One or multiple SS/PBCH blocks may be transmitted within a time period of 5 ms, and each transmitted SS/PBCH block may be distinguished by an index.

The UE may detect the PSS and the SSS in the initial access stage, and may decode the PBCH. The UE may acquire an MIB from the PBCH, and this may be used to configure control resource set (CORESET) #0 (for example, corresponding to a control resource set having a control resource set index of 0). The UE may monitor control resource set #0 by assuming that the demodulation reference signal (DMRS) transmitted in the selected SS/PBCH block and control resource set #0 is quasi-co-located (QCL). The UE may receive system information with downlink control information transmitted in control resource set #0. The UE may acquire configuration information related to a random access channel (RACH) necessary for initial access from the received system information. The UE may transmit a physical RACH (PRACH) to the base station in consideration of a selected SS/PBCH index, and the base station, upon receiving the PRACH, may acquire information regarding the SS/PBCH block index selected by the UE. The base station may know which block the UE has selected from respective SS/PBCH blocks. The base station may know the fact that the UE has monitored control resource set #0 associated with the selected SS/PBCH block.

### [PDCCH: Regarding DCI]

Hereinafter, downlink control information (DCI) in a 5G communication system will be described in detail.

In a 5G system, a base station may transfer scheduling information regarding uplink data (or physical uplink shared channel (PUSCH)) or downlink data (or physical downlink shared channel (PDSCH)) to a UE through DCI. The UE may monitor, with regard to the PUSCH or PDSCH, a fallback DCI format and a non-fallback DCI format. The fallback DCI format may include a fixed field predefined between the base station and the UE, and the non-fallback DCI format may include a configurable field.

The DCI may be subjected to channel coding and modulation processes and then transmitted through a physical downlink control channel (PDCCH) after a channel coding and modulation process. A cyclic redundancy check (CRC) may be attached to the DCI message payload. The CRC may be scrambled by a radio network temporary identifier (RNTI) corresponding to the identity of the UE. Different RNTIs may be used according to the purpose of the DCI message (for example, UE-specific data transmission, power control command, or random access response, or the like). The RNTI may not be explicitly transmitted, but may be transmitted while being included in a CRC calculation process. Upon receiving a DCI message transmitted through the PDCCH, the UE may identify the CRC by using the allocated RNTI. If the CRC identification result is right, the UE may know that the corresponding message has been transmitted to the UE.

According to an embodiment, DCI for scheduling a PDSCH regarding system information (SI) may be scrambled by an SI-RNTI. DCI for scheduling a PDSCH regarding a random access response (RAR) message may be scrambled by an RA-RNTI. DCI for scheduling a PDSCH regarding a paging message may be scrambled by a P-RNTI. DCI for notifying of a slot format indicator (SFI) may be scrambled by an SFI-RNTI. DCI for notifying of transmit power control (TPC) may be scrambled by a TPC-RNTI. DCI for scheduling a UE-specific PDSCH or PUSCH may be scrambled by a cell RNTI (C-RNTI). According to an embodiment, the P-RNTI and the SI-RNTI may be common RNTIs which are not allocated to a specific UE but allocated to all UEs in a cell.
DCI format 0_0 may be used as fallback DC for scheduling the PUSCH and the CRC may be scrambled by a C-RNTI. For example DCI format 0_0 in which the CRC is scrambled by a C-RNTI may include information as shown in Table 4 below. However, according to an embodiment, information included in DCI format 0_0 in which the CRC is scrambled by a C-RNTI is not limited to the information in Table 4.

TABLE 4

```
  - Identifier for DCI formats − [1] bit
  - Frequency domain resource assignment −[┌log₂(N_{RB}^{UL,BWP}(N_{RB}^{UL,BWP} + 1) [symbol]  ]
bits
  - Time domain resource assignment − X bits
  - Frequency hopping flag − 1 bit.
  - Modulation and coding scheme − 5 bits
  - New data indicator − 1 bit
  - Redundancy version − 2 bits
  - HARQ process number − 4 bits
  - Transmit power control (TPC) command for scheduled PUSCH− [2] bits
  - Uplink/supplementary uplink indicator (UL/SUL indicator) − 0 or 1 bit
```

DCI format 0_1 may be used as non-fallback DCI for scheduling the PUSCH, and the CRC may be scrambled by a C-RNTI. For example, D format 0_1 in which the CRC is scrambled by a C-RNTI may include information as shown in Table 5 below. However, according to an embodiment, information included in DCI format 0_1 in which the CRC is scrambled by a C-RNTI is not limited to the information in Table 5.

```
TABLE 5
  - Carrier indicator - 0 or 3 bits
  - UL/SUL indicator - 0 or 1 bit
  - Identifier for DCI formats - [1] bits
  - Bandwidth part indicator - 0, 1 or 2 bits
  - Frequency domain resource assignment
      • For resource allocation type 0, ┌N_{RB}^{UL,BWP}/P┐ bits
      • For resource allocation type 1, ┌log₂(N_{RB}^{UL,BWP}(N_{RB}^{UL,BWP} + 1)/2)┐ bits
  - Time domain resource assignment -1, 2, 3, or 4 bits
  - Virtual resource block-to-physical resource block (VRB-to-PRB) mapping - 0
or 1 bit, only for resource allocation type 1.
      • 0 bit if only resource allocation type 0 is configured;
      • 1 bit otherwise.
  - Frequency hopping flag - 0 or 1 bit, only for resource allocation type 1.
      • 0 bit if only resource allocation type 0 is configured;
      • 1 bit otherwise.
  - Modulation and coding scheme - 5 bits
  - New data indicator - 1 bit
  - Redundancy version - 2 bits
  - HARQ process number - 4 bits
  - 1st downlink assignment index- 1 or 2 bits
      • 1 bit for semi-static HARQ-ACK codebook;
      • 2 bits for dynamic HARQ-ACK codebook with single HARQ-ACK
        codebook.
  - 2nd downlink assignment index - 0 or 2 bits
      • 2 bits for dynamic HARQ-ACK codebook with two HARQ-ACK sub-
        codebooks;
      • 0 bit otherwise.
  - TPC command for scheduled PUSCH - 2 bits
  $‐ SRS resource indicator - ⌈ {log}_{2} ( {\sum }_{k = 1}^{{L}_{max}} ( \begin{matrix}{N}_{SRS} \\ k\end{matrix} ) ) ⌉ or ⌈ {log}_{2} ( {N}_{SRS} ) ⌉ bits$
      $⌈ {log}_{2} ( {\sum }_{k = 1}^{{L}_{max}} ( \begin{matrix}{N}_{SRS} \\ k\end{matrix} ) ) ⌉ bits for non ‐ codebook based PUSCH transmission ;$
      • ┌log₂(N_{SRS})┐ bits for cookbook based PUSCH transmission.
  - Precoding information and number of layers-up to 6 bits
  - Antenna ports - up to 5 bits
  - SRS request - 2 bits
  - CSI request - 0, 1, 2, 3, 4, 5, or 6 bits
  - Code block group (CBG) transmission information - 0, 2, 4, 6, or 8 bits
  - Phase tracking reference signal (PTRS)-demodulation reference signal (DMRS)
association - 0 or 2 bits.
  - beta_offset indicator- 0 or 2 bits
  - DMRS sequence initialization - 0 or 1 bit
```

DO format 1_0 may be used as fallback DC for scheduling the PDSCH, and the CRC may be scrambled by a C-RNTI. For example, DCI format 1_0 in which the CRC is scrambled by a C-RNTI may include information as shown in Table 6 below. However, according to an embodiment, information included in DCI format 1_0 in which the CRC is scrambled by a C-RNTI is not limited to the information in Table 6.

```
TABLE 6
  - Identifier for DCI formats − [1] bit
  - Frequency domain resource assignment −[┌log₂(N_{RB}^{DL,BWP}(N_{RB}^{DL,BWP} + 1)/2)┐ bits
  - Time domain resource assignment − X bits
  - VRB-to-PRB mapping − 1 bit.
  - Modulation and coding scheme − 5 bits
  - New data indicator − 1 bit
  - Redundancy version − 2 bits
  - HARQ process number − 4 bits
  - Downlink assignment index − 2 bits
  - TPC command for scheduled PUCCH − [2] bits
  - Physical uplink control channel (PUCCH) resource indicator− 3 bits
  - PDSCH-to-HARQ feedback timing indicator− [3] bits
```

DCI format 1_1 may be used as non-fallback DCI for scheduling the PDSCH, and the CRC may be scrambled by a C-RNTI. For example, DCI format 0_0 in which the CRC is scrambled by a C-RNTI may include the following pieces of information in Table 7 below, for example. However, according to an embodiment, information included in DCI format 1_1 in which the CRC is scrambled by a C-RNTI is not limited to the information in Table 7.

TABLE 7

```
      - Carrier indicator − 0 or 3 bits
      - Identifier for DCI formats − [1] bits
      - Bandwidth part indicator − 0, 1 or 2 bits
      - Frequency domain resource assignment
            • For resource allocation type 0, ┌N_{RB}^{DL,BWP}/P┐ bits
            • For resource allocation type 1, ┌log₂(N_{RB}^{DL,BWP}(N_{RB}^{DL,BWP} + 1)/2)┐ bits
      - Time domain resource assignment −1, 2, 3, or 4 bits
      - VRB-to-PRB mapping − 0 or 1 bit, only for resource allocation type 1.
            • 0 bit if only resource allocation type 0 is configured;
            • 1 bit otherwise.
      - PRB bundling size indicator − 0 or 1 bit
      - Rate matching indicator − 0, 1, or 2 bits
      - ZP CSI-RS trigger − 0, 1, or 2 bits
        For transport block 1:
        - Modulation and coding scheme − 5 bits
        - New data indicator − 1 bit
        - Redundancy version − 2 bits
        For transport block 2:
        - Modulation and coding scheme − 5 bits
        - New data indicator − 1 bit
        - Redundancy version − 2 bits
    - HARQ process number − 4 bits
    - Downlink assignment index − 0 or 2 or 4 bits
    - TPC command for scheduled PUCCH − 2 bits
  - PUCCH resource indicator − 3 bits
  - PDSCH-to-HARQ feedback timing indicator − 3 bits
  - Antenna ports − 4, 5 or 6 bits
  - Transmission configuration indication − 0 or 3 bits
  - SRS request − 2 bits
  - CBG transmission information − 0, 2, 4, 6, or 8 bits
  - CBG flushing out information − 0 or 1 bit
  - DMRS sequence initialization − 1 bit
```

### [PDCCH: CORESET, REG, CCE, and Search Space]

Hereinafter, a downlink control channel in a 5G communication system will be described in more detail with reference to the accompanying drawings.

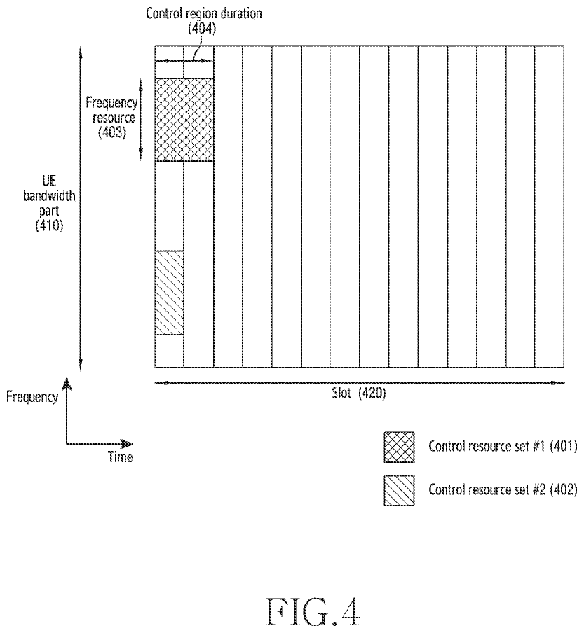

FIG. 4 illustrates an example of control resource set configuration of a downlink control channel in a wireless communication system according to an embodiment of the disclosure. More specifically, referring to FIG. 4. FIG. 4 illustrates an example of a control resource set used to transmit a downlink control channel in a 5G wireless communication system. Referring to FIG. 4, FIG. 4 illustrates an example in which a UE bandwidth part 410 is configured along the frequency axis, and two control resource sets (control resource set #1 401 and control resource set #2 402) are configured within one slot 420 along the time axis. The control resource sets 401 and 402 may be configured in a specific frequency resource 410 within the entire UE bandwidth part 403 along the frequency axis. One or multiple OFDM symbols may be configured along the time axis, and this may be defined as a control resource set duration 404. Referring to FIG. 4, control resource set #1 401 is configured to have a control resource set duration corresponding to two symbols, and control resource set #2 402 is configured to have a control resource set duration corresponding to one symbol.

A control resource set in 5G described above may be configured for a UE by a base station through upper laver signaling (for example, system information, master information block (MIB), radio resource control (RRC) signaling). The description that a control resource set is configured for a UE may mean that information such as a control resource set identity, the control resource sets frequency location, and the control resource set's symbol duration is provided. For example configuration information regarding the control resource set may include the following pieces of information in Table 8. However, according to an embodiment, configuration information regarding the control resource set is not limited to the information in Table 8.

TABLE 8

```
ControlResourceSet ::= SEQUENCE {
        -- Corresponds to L1 parameter ‘CORESET-ID’
        controlResourceSetId
        ControlResourceSetId,
  (control resource set identity))
        frequencyDomainResources BIT STRING (SIZE
(45)),
  (frequency domain resource assignment information)
        duration
        INTEGER (1..maxCoReSetDuration),
  (time domain resource assignment information)
        cce-REG-MappingType
        CHOICE {
  (CCE-to-REG mapping type)
              interleaved
              SEQUENCE {
                      reg-BundleSize
              ENUMERATED {n2, n3, n6},
      (REG bundle size)
                      precoderGranularity
              ENUMERATED {sameAsREG-bundle, allContiguousRBs},
                      interleaverSize
              ENUMERATED {n2, n3, n6}
                      (interleaver size)
                      shiftIndex
                      INTEGER(0..maxNrofPhysicalResourceBlocks-1)
                                              OPTIONAL
                (interleaver shift)
      },
      nonInterleaved
      NULL
      },
      tci-StatesPDCCH
      SEQUENCE(SIZE (1..maxNrofTCI-StatesPDCCH)) OF TCI-StateId
              OPTIONAL,
  (QCL configuration information)
      tci-PresentInDCI
      ENUMERATED {enabled}
                              OPTIONAL, -- Need S
}
```

In Table 8, tci-StatesPDCCH (simply referred to as transmission configuration indication (TCI) state) configuration information may include information of one or multiple synchronization signal (SS)/physical broadcast channel (PBCH) block index or channel state information reference signal (CSI-RS) index, which is quasi-co-located with a DMRS transmitted in a corresponding control resource set.

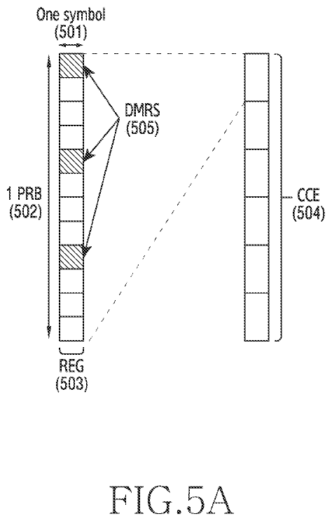

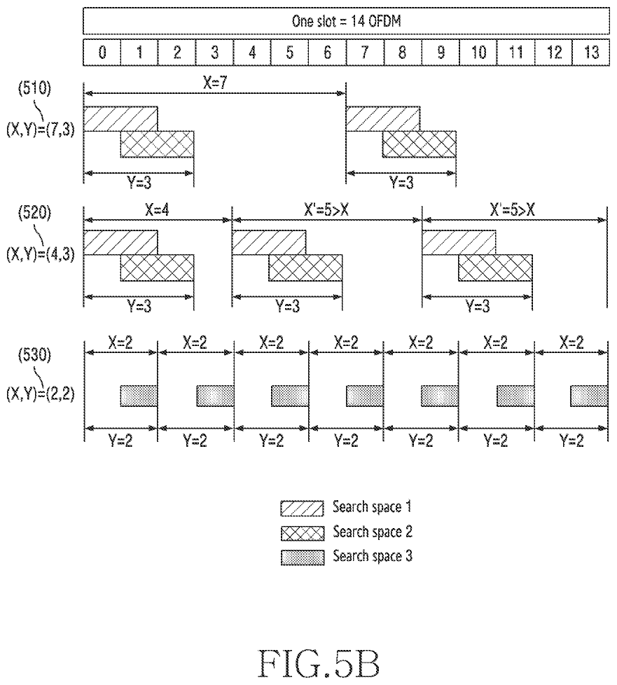

FIG. 5A illustrates a structure of a downlink control channel in a wireless communication according to an embodiment of the disclosure. Specifically, referring to FIG. 5A, FIG. 5A illustrates an example of the basic unit of time and frequency resources constituting a downlink control channel available in 5G. Referring to FIG. 5A, the basic unit of time and frequency resources constituting a control channel may be referred to as a resource element group (REG) % n, and the REG 503 may be defined by one OFDM symbol % n along the time axis and one physical resource block (PRB) 502 (for example, 12 subcarriers) along the frequency axis. The base station may configure a downlink control channel allocation unit by concatenating the REGs 503.

Provided that the basic unit of downlink control channel allocation in 5G is a control channel element 504 as illustrated in FIG. 5A, one CCE 504 may include multiple REGs 503. Referring to the REG 503 illustrated in FIG. 5A, the REG 503 may include 12 Res. If one CCE 504 includes six REGs 503, one CCE 504 may then include 72 REs. A downlink control resource set, once configured, may include multiple CCEs 504. A specific downlink control channel may be mapped to one or multiple CCEs 504 and then transmitted according to the aggregation level (AL) in the control resource set. The CCEs 504 in the control resource set are distinguished by numbers. The numbers of CCEs 504 may be allocated according to a logical mapping scheme.

The basic unit of the downlink control channel illustrated in FIG. 5A (for example, the REG 503) may include both REs to which DCI is mapped, and an area to which a reference signal (DMRS 505) for decoding the same is mapped. Referring to FIG. 5A, three DRMSs 505 may be transmitted inside one REG 503. The number of CCEs necessary to transmit a PDCCH may be 1, 2, 4, 8, or 16 according to the aggregation level (AL), and different number of CCEs may be used to implement link adaption of the downlink control channel. For example, when AL=L, one downlink control channel may be transmitted through L CCEs. The UE needs to detect a signal while having no information regarding the downlink control channel, and a search space indicating a set of CCEs may thus be defined for blind decoding. The search space may be a set of downlink control channel candidates including CCEs that the UE must attempt to decode in a given aggregation level. Since there are various aggregation levels making one bundle of 1, 2, 4, 8, or 16 CCEs, the UE may have a plurality of search spaces. A search space set may be defined as a set of search spaces at all configured ALs.

Search spaces may be classified into common search spaces and UE-specific search spaces. A group of UEs or all UEs may search a common search space of the PDCCH in order to perform dynamic scheduling regarding system information. In addition, a group of UEs or all UEs may search a common search space of the PDCCH in order to receive cell-common control information such as a paging message. For example, PDSCH scheduling allocation information for transmitting an SIB including a cell operator information or the like may be received by searching the common search space of the PDCCH. In the case of a common search space, a group of UEs or all UEs need to receive the PDCCH, and the same may thus be defined as a predetermined set of CCEs. Scheduling allocation information regarding a UE-specific PDSCH or PUSCH may be received by investigating the UE-specific search space of the PDCCH. The UE-specific search space may be defined UE-specifically as a function of various system parameters and the identity of the UE.

In 5G, a parameter for a search space regarding a PDCCH may be configured for the UE by the base station through upper layer signaling (for example, SIB, MIB, RRC signaling). For example the base station may provide the UE with configurations such as the number of PDCCH candidates at each aggregation level L, the monitoring cycle regarding the search space, the monitoring occasion with regard to each symbol in a slot regarding the search space, the search space type (common search space or UE-specific search space), a combination of an RNTI and a DCI format to be monitored in the corresponding search space, a control resource set index for monitoring the search space, and the like. For example configuration information for the search space regarding the PDCCH may include the following pieces of information given in Table 9 below. However according to an embodiment, configuration information for the search space regarding the PDCCH is not limited to the information in Table 9.

TABLE 9

```
Search Space ::= SEQUENCE {
        -- Identity of the search space. SearchSpaceId = 0 identifies the SearchSpace
configured via PBCH (MIB) or ServingCellConfigCommon.
        searchSpaceId
        SearchSpaceId,
  (search space identity)
        controlResourceSetId
        ControlResourceSetId,
  (control resource set identity)
        monitoringSlotPeriodicityAndOffset CHOICE {
  (monitoring slot level periodicity)
              sl1
                    NULL,
              sl2
                    INTEGER (0..1),
              sl4
                    INTEGER (0..3),
              sl5
              INTEGER (0.4),
              sl8
                    INTEGER (0..7),
              sl10
              INTEGER (0..9),
              sl16
              INTEGER (0..15),
              s120
              INTEGER (0..19)
        }
                    OPTIONAL,
  duration(monitoring duration) INTEGER (2..2559)
        monitoringSymbolsWithinSlot BIT
STRING (SIZE (14))
                              OPTIONAL,
  (monitoirng symbols within slot)
        nrofCandidates
        SEQUENCE {
  (number of PDCCH candidates for each aggregation level)
              aggregationLevel1
        ENUMERATED {n0, n1, n2, n3, n4, n5, n6, n8},
              aggregationLevel2
        ENUMERATED {n0, n1, n2, n3, n4, n5, n6, n8},
              aggregationLevel4
        ENUMERATED {n0, n1, n2, n3, n4, n5, n6, n8},
              aggregationLevel8
        ENUMERATED {n0, n1, n2, n3, n4, n5, n6, n8},
              aggregationLevel16
        ENUMERATED {n0, n1, n2, n3, n4, n5, n6, n8}
        },
        searchSpaceType
        CHOICE {
        (search space type)
              -- Configures this search space as common search space (CSS) and DCI
formats to monitor.
              common
              SEQUENCE {
        (common search space)
      }
              ue-Specific
              SEQUENCE {
        (UE-specific search space)
                        -- Indicates whether the UE monitors in this USS for DCI formats
0-0 and 1-0 or for formats 0-1 and 1-1.
                        formats
                        ENUMERATED {formats0-0-And-1-0, formats0-1-And-1-1},
                        ...
              }
```

According to configuration information for the search space regarding the PDCCH, the base station may configure one or multiple search space sets for the UE. According to an embodiment of the disclosure, the base station may configure search space set 1 and search space set 2 for the UE. The base station may configure DCI format A scrambled by an X-RNTI to be monitored in a common search space in search space set 1. The base station may configure DCI format B scrambled by a Y-RNTI to be monitored in a UE-specific search space in search space set 2.

According to configuration information, one or multiple search space sets may exist in a common search space or a UE-specific search space. For example, search space set #1 and search space set #2 may be configured as a common search space. Search space set #3 and search space set #4 may be configured as a UE-specific search space.

Combinations of DCI formats and RNTIs given below may be monitored in a common search space. Of course, according to various embodiments of the disclosure, combination of DCI formats and RNTIs are not limited to examples below.
DCI format 0_0/1_0 with CRC scrambled by C-RNTI, CS-RNTI, SP-CSI-RNTI, RA-RNTI, TC-RNTI, P-RNTI, SI-RNTI
DCI format 2_0 with CRC scrambled by SFI-RNTI
DCI format 2_1 with CRC scrambled by INT-RNTI
DCI format 2_2 with CRC scrambled by TPC-PUSCH-RNTI, TPC-PUCCH-RNTI
DCI format 2_3 with CRC scrambled by TPC-SRS-RNTI

Combinations of DCI formats and RNTIs given below may be monitored in a UE-specific search space. Of course, according to various embodiments of the disclosure, combination of DCI formats and RNTIs are not limited to examples below.
DCI format 0_0/1_0 with CRC scrambled by C-RNTI, CS-RNTI, TC-RNTI
DCI format 1_0/1_1 with CRC scrambled by C-RNTI, CS-RNTI, TC-RNTI

Enumerated RNTIs may follow the definition and usage given below.
Cell RNTI (C-RNTI): used to schedule a UE-specific PDSCH
Temporary cell RNTI (TC-RNTI): used to schedule a UE-specific PDSCH
Configured scheduling RNTI (CS-RNTI): used to schedule a semi-statically configured UE-specific PDSCH
Random access RNTI (RA-RNTI): used to schedule a PDSCH in a random access step
Paging RNTI (P-RNTI): used to schedule a PDSCH in which paging is transmitted
System information RNTI (SI-RNTI): used to schedule a PDSCH in which system information is transmitted
Interruption RNTI (INT-RNTI): used to indicate whether a PDSCH is punctured
Transmit power control for PUSCH RNTI (TPC-PUSCH-RNTI): used to indicate a power control command regarding a PUSCH
Transmit power control for PUCCH RNTI (TPC-PUCCH-RNTI): used to indicate a power control command regarding a PUCCH
Transmit power control for SRS RNTI (TPC-SRS-RNTI): used to indicate a power control command regarding an SRS

The DCI formats enumerated herein may follow the definitions given in Table 10 below.

TABLE 10

| DCI format | Usage |
|---|---|
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and OFDM |
| | symbol(s) where UE may assume no transmission is |
| | intended for the UE |
| 2_2 | Transmission of TPC commands for PUCCH and |
| | PUSCH |
| 2_3 | Transmission of a group of TPC commands for SRS |
| | transmissions by one or more UEs |

In 5G, the search space at aggregation level L in connection with control resource set p and search space set s may be expressed by Equation 1 below

$$L \cdot \{ ( {Y}_{p , {n}_{s , f}^{μ}} + ⌊ \frac{{m}_{s , {n}_{Cl}} \cdot {N}_{CCE , p}}{L \cdot {M}_{s , max}^{( L )}} ⌋ + {n}_{Cl} ) mod ⌊ \frac{{N}_{CCE , p}}{L} ⌋ \} + i \qquad [ Equation 1 ]$$

L: aggregation level
n_{CI}: carrier index
N_{CCE,p}: total number of CCEs existing in control resource set p
n_{s,f}^{μ}: slot index
M_{s,max}^{(L)}: number of PDCCH candidates at aggregation level L
m_{s,n}_{_{CI}}=0, . . . , M_{s,max}^{(L)}−1: PDCCH candidate index at aggregation level L=0, . . . , L−1
Y_{p,n}_{_{s,f}}_{^{μ}}=(Ap·Y_{p,n}_{_{s,f}}_{^{μ}}₋₁)mod D, Y_{p,-1}=n_{RNTI}≠0, Aₚ=39827 for p mod 3=0, Aₚ=39829 for p mod 3=1, Aₚ=39839 for p mod 3=2, D=65537
n_{RNTI}: UE identity

The Y_{p,n}_{_{s,f}}_{^{μ}} value may correspond to 0 in the case of a common search space.

The Y_{p,n}_{_{s,f}}_{^{μ}} value may correspond to a value changed by the UE's identity (C-RNTI or ID configured for the UE by the base station) and the time index in the case of a UE-specific search space.

In 5G, multiple search space sets may be configured by different parameters (for example, parameters in Table 9), and the group of search space sets monitored by the UE at each timepoint may differ. For example, if search space set #1 is configured at by X-slot cycle, if search space set #2 is configured at by Y-slot cycle, and if X and Y are different, the UE may monitor search space set #1 and search space set #2 both in a specific slot, and may monitor one of search space set #1 and search space set #2 both in another specific slot.

### [PDCCH: Span]

The UE may perform UE capability reporting at each subcarrier spacing with regard to a case in which the same has multiple PDCCH monitoring occasions inside a slot. The concept “span” may be used in this regard. A span refers to consecutive symbols configured such that the UE can monitor the PDCCH inside the slot. Each PDCCH monitoring occasion is inside one span. A span may be described by (X,Y) wherein X refers to the minimum number of symbols by which the first symbols of two consecutive spans are spaced apart from each other, and Y refers to the number of consecutive symbols configured such that the PDCCH can be monitored inside one span. The UE may monitor the PDCCH in a range inside a span corresponding to Y symbols from the first symbol of the span.

FIG. 5B illustrates, in terms of spans, an example in which a UE may have multiple PDCCH monitoring occasions inside a slot in a wireless communication system according to an embodiment of the disclosure. More specifically, referring to FIG. 5B, FIG. 5B illustrates, in terms of spans, a case in which a UE may have multiple PDCCH monitoring occasions inside a slot in a wireless communication system. Possible spans are (X,Y)=(7,3), (4,3), (2,2), and the three cases may be indicated by (510), (520, and (530) in FIG. 5B, respectively. According to an embodiment, (510) may describe a case in which there are two spans described by (7,4) inside a slot. The spacing between the first symbols of two spans is described as X=7, a PDCCH monitoring occasion may exist inside a total of Y=3 symbols from the first symbol of each span, and search spaces 1 and 2 may exist inside Y=3 symbols, respectively. According to another embodiment, (520) may describe a case in which there are a total of three spans described by (4,3) inside a slot, and the second and third spans are spaced apart by X′=5 symbols which are larger than X=4.

### [PDCCH: UE Capability Report]

The slot location at which the above-described common search space and the UE-specific search space are positioned may be indicated by parameter “monitoringSymbolsWitninSlot” in Table 11-1. The symbol location inside the slot is indicated as a bitmap through parameter “monitoringSymbolsWithinSlot” in Table 9. Meanwhile, the symbol location inside a slot at which the UE can monitor search spaces may be reported to the base station through the following UE capabilities.

UE capability 1 (hereinafter, referred to as FG 3-1). UE capability 1 may have the following meaning: if there is one monitoring occasion (MO) regarding type 1 and type 3 common search spaces or UE-specific search spaces inside a slot, as in following Table 11-1, the UE can monitor the corresponding MO when the corresponding MO is located inside the first three symbols inside the slot. UE capability 1 is a mandatory capability which is to be supported by all UEs that support NR, and whether or not UE ca ability 1 is supported is not explicitly reported to the base station.

TABLE 11-1

| | Feature | | Field name in |
|---|---|---|---|
| Index | group | Components | TS 38.331 [2] |
| 3-1 | Basic | 1) One configured CORESET | n/a |
| | DL | per BWP per cell in addition to | |
| | control | CORESET0 | |
| | channel | CORESET resource allocation | |
| | | of 6RB bit-map and duration | |
| | | of 1-3 OFDM symbols for FR1 | |
| | | For type 1 CSS without | |
| | | dedicated RRC configuration | |
| | | and for type 0, 0A, and 2 CSSs, | |
| | | CORESET resource allocation | |
| | | of 6RB bit-map and duration | |
| | | 1-3 OFDM symbols for FR2 | |
| | | For type 1 CSS with dedicated | |
| | | RRC configuration and for type | |
| | | 3 CSS, UE specific SS, CORESET | |
| | | resource allocation of 6RB | |
| | | bit-map and duration 1-2 OFDM | |
| | | symbols for FR2 | |
| | | REG-bundle sizes of | |
| | | 2/3 RBs or 6 RBs | |
| | | Interleaved and non-interleaved | |
| | | CCE-to-REG mapping | |
| | | Precoder-granularity | |
| | | of REG-bundle size | |
| | | PDCCH DMRS scrambling | |
| | | determination | |
| | | TCI state(s) for a CORESET | |
| | | configuration | |
| | | 2) CSS and UE-SS configurations | |
| | | for unicast PDCCH | |
| | | transmission per BWP per cell | |
| | | PDCCH aggregation | |
| | | levels 1, 2, 4, 8, 16 | |
| | | UP to 3 search space sets in | |
| | | a slot for a scheduled SCell per | |
| | | BWP | |
| | | This search space limit is before | |
| | | applying all dropping rules. | |
| | | For type 1 CSS with dedicated | |
| | | RRC configuration, type 3 | |
| | | CSS, and UE-SS, the monitoring | |
| | | occasion is within the first 3 | |
| | | OFDM symbols of a slot | |
| | | For type 1 CSS without | |
| | | dedicated RRC configuration | |
| | | and for type 0, 0A, and 2 CSS, the | |
| | | monitoring occasion can be any | |
| | | OFDM symbol(s) of a slot, with | |
| | | the monitoring occasions for | |
| | | any of Type 1-CSS without | |
| | | dedicated RRC configuration, or | |
| | | Types 0, 0A, or 2 CSS | |
| | | configurations within a single | |
| | | span of three consecutive OFDM | |
| | | symbols within a slot | |
| | | 3) Monitoring DCI | |
| | | formats 0_0, 1_0, 0_1, 1_1 | |
| | | 4) Number of PDCCH blind | |
| | | decodes per slot with a given SCS | |
| | | follows Case 1-1 table | |
| | | 5) Processing one unicast DCI | |
| | | scheduling DL and one unicast | |
| | | DCI scheduling UL per slot | |
| | | per scheduled CC for FDD | |
| | | 6) Processing one unicast DCI | |
| | | scheduling DL and 2 unicast | |
| | | DCI scheduling UL per slot | |
| | | per scheduled CC for TDD | |

UE capability 2 (hereinafter, referred to as FG 3-2). UE capability 2 has the following meaning if there is one monitoring occasion (MO) regarding common search space or a UE-specific search space inside a slot, as in following Table 11-2 the UE can monitor the corresponding MO no matter what of the start symbol location of the corresponding MO may be. UE capability 2 is optionally supported by the UE, and whether or not UE capability 2 is supported is explicitly reported to the base station.

TABLE 11-2

| In- | Feature | | |
|---|---|---|---|
| dex | group | Components | Field name in TS 38.331 [2] |
| 3-2 | PDCCH | For a given UE, | pdcchMonitoringSingleOccasion |
| | monitoring | all search space | |
| | on | configurations | |
| | any span of | are within the | |
| | up to 3 | same span of | |
| | consecutive | 3 consecutive | |
| | OFDM | OFDM symbols | |
| | symbols of a | in the slot | |
| | slot | | |

UE capability 3 (hereinafter, referred to as FG 3-5, 3-5a, or 3-5b). UE capability 3 has the following meaning: if there are multiple monitoring occasions (MO) regarding a common search space or a UE-specific search space inside a slot, as in following Table 11-3, the pattern of the MO which the UE can monitor is indicated. The above-mentioned pattern includes the spacing X between start symbols of different MOs, and the maximum symbol length Y regarding one MO. The combination of (X,Y) supported by the UE may be one or multiple among {(2,2), (4,3), (7,3)}. UE capability 3 is optionally supported b the UE, and whether or not UE capability 3 is supported and the above-mentioned combination of (X,Y) are explicitly reported to the base station.

TABLE 11-3

| | | | Field name in |
|---|---|---|---|
| | | | TS 38.331 |
| Index | Feature group | Components | [2] |
| 3-5 | For type 1 CSS | For type 1 CSS with dedicated RRC configuration, | pdcch- |
| | with dedicated | type 3 CSS, and UE-SS, monitoring occasion can | MonitoringAnyOccasions |
| | RRC | be any OFDM symbol(s) of a slot for Case 2 | { |
| | configuration, | | 3-5. withoutDCI-Gap |
| | type 3 CSS, | | 3-5a. withDCI-Gap |
| | and UE-SS, | | } |
| | monitoring | | |
| | occasion can be | | |
| | any OFDM | | |
| | symbol(s) of a | | |
| | slot for Case 2 | | |
| 3-5a | For type 1 CSS | For type 1 CSS with dedicated RRC configuration, | |
| | with dedicated | type 3 CSS and UE-SS, monitoring occasion can be | |
| | RRC | any OFDM symbol(s) of a slot for Case 2, with | |
| | configuration, | minimum time separation (including the cross-slot | |
| | type 3 CSS, | boundary case) between two DL unicast DCIs, | |
| | and UE-SS, | between two UL unicast DCIs, or between a DL and | |
| | monitoring | an UL unicast DCI in different monitoring | |
| | occasion can be | occasions where at least one of them is not the | |
| | any OFDM | monitoring occasions of FG-3-1, for a same UE as | |
| | symbol(s) of a | 2OFDM symbols for 15 kHz | |
| | slot for Case 2 | 4OFDM symbols for 30 kHz | |
| | with a DCI gap | 7OFDM symbols for 60 kHz with NCP | |
| | | 11OFDM symbols for 120 kHz | |
| | | Up to one unicast DL DCI and up to one unicast UL | |
| | | DCI in a monitoring occasion except for the | |
| | | monitoring occasions of FG 3-1. | |
| | | In addition for TDD the minimum separation | |
| | | between the first two UL unicast DCIs within the | |
| | | first 3 OFDM symbols of a slot can be zero | |
| | | OFDM symbols. | |
| 3-5b | All PDCCH | PDCCH monitoring occasions of FG-3-1, plus | |
| | monitoring | additional PDCCH monitoring occasion(s) can be | |
| | occasion can be | any OFDM symbol(s) of a slot for Case 2, and for | |
| | any OFDM | any two PDCCH monitoring occasions belonging | |
| | symbol(s) of a | to different spans, where at least one of them is not | |
| | slot for Case 2 | the monitoring occasions of FG-3-1, in same or | |
| | with a span gap | different search spaces, there is a minimum time | |
| | | separation of X OFDM symbols (including the | |
| | | cross-slot boundary case) between the start of two | |
| | | spans, where each span is of length up to Y | |
| | | consecutive OFDM symbols of a slot. Spans do not | |
| | | overlap. Every span is contained in a single slot. | |
| | | The same span pattern repeats in every slot. The | |
| | | separation between consecutive spans within and | |
| | | across slots may be unequal but the same (X, Y) | |
| | | limit must be satisfied by all spans. Every | |
| | | monitoring occasion is fully contained in one span. | |
| | | In order to determine a suitable span pattem, first a | |
| | | bitmap b(1), 0 <= 1 <= 13 is generated, where b(1) = 1 if | |
| | | symbol 1 of any slot is part of a monitoring | |
| | | occasion, b(1) = 0 otherwise. The first span in the | |
| | | span pattern begins at the smallest 1 for which | |
| | | b(1) = 1. The next span in the span pattern begins at | |
| | | the smallest 1 not included in the previous span(s) | |
| | | for which b(1) = 1. The span duration is | |
| | | max {maximum value of all CORESET durations, | |
| | | minimum value of Y in the UE reported candidate | |
| | | value} except possibly the last span in a slot which | |
| | | can be of shorter duration. A particular PDCCH | |
| | | monitoring configuration meets the UE capability | |
| | | limitation if the span arrangement satisfies the gap | |
| | | separation for at least one (X, Y) in the UE reported | |
| | | candidate value set in every slot, including cross | |
| | | slot boundary. | |
| | | For the set of monitoring occasions which are | |
| | | within the same span: | |
| | | Processing one unicast DCI scheduling | |
| | | DL and one unicast DCI scheduling UL per | |
| | | scheduled CC across this set of monitoring | |
| | | occasions for FDD | |
| | | Processing one unicast DCI scheduling | |
| | | DL and two unicast DCI scheduling UL per | |
| | | scheduled CC across this set of monitoring | |
| | | occasions for TDD | |
| | | Processing two unicast DCI scheduling | |
| | | DL and one unicast DCI scheduling UL per | |
| | | scheduled CC across this set of monitoring | |
| | | occasions for TDD | |
| | | The number of different start symbol indices of | |
| | | spans for all PDCCH monitoring occasions per slot, | |
| | | including PDCCH monitoring occasions of FG-3- | |
| | | 1, is no more than floor(14/X) (X is minimum | |
| | | among values reported by UE). | |
| | | The number of different start symbol indices of | |
| | | PDCCH monitoring occasions per slot including | |
| | | PDCCH monitoring occasions of FG-3-1, is no | |
| | | more than 7. | |
| | | The number of different start symbol indices of | |
| | | PDCCH monitoring occasions per half-slot | |
| | | including PDCCH monitoring occasions of FG-3- | |
| | | 1 is no more than 4 in SCell. | |

The UE may report whether the above-described capability 2 and/or capability 3 are supported and relevant parameters to the base station. The base station may allocate time-domain resources to the common search space and the UE-specific search space, based on the UE capability report. During the resource allocation, the base station may ensure that the MO is not positioned not at a location at which the UE cannot monitor the same.

### [PDCCH: BD/CCE Limit]

If there are multiple search space sets configured for a UE, the following conditions may be considered in connection with a method for determining a search space set to be monitored by the UE.

According to an embodiment, if the value of “monitonngCapabilityConfig-r16” (upper layer signaling) has been configured to be “r15monitoringcapability” for the UE, the UE defines maximum values regarding the number of PDCCH candidates that can be monitored and the number of CCEs constituting the entire search space (as used herein, the entire search space refers to the entire CCE set corresponding to a union domain of multiple search space sets) with regard to each slot. According to an embodiment, if the value of “monitoringCapabilityConfig-r16” has been configured to be “r16monitoringcapability”, the UE defines maximum values regarding the number of PDCCH candidates that can be monitored and the number of CCEs constituting the entire search space (as used herein, the entire search space refers to the entire CCE set corresponding to a union domain of multiple search space sets) with regard to each span.

### [Condition 1: Maximum Number of PDCCH Candidates Limited]

As described above, according to the upper layer signaling configuration value, the maximum number M of PDCCH candidates that the UE can monitor may follow Table 12-1 given below if the same is defined with reference to a slot in a cell configured to have a subcarrier spacing of 15-2^{μ} kHz, and may follow Table 12-2 given below if the same is defined with reference to a span.

TABLE 12-1

| | Maximum number of PDCCH |
|---|---|
| | candidates per slot and |
| μ | per serving cell (M^{μ}) |
| 0 | 44 |
| 1 | 36 |
| 2 | 22 |
| 3 | 20 |

TABLE 12-2

| | Maximum number M^{μ} of monitored PDCCH | | |
|---|---|---|---|
| | candidates per span for combination (X, Y) and per | | |
| | serving cell | | |
| μ | (2, 2) | (4, 3) | (7, 3) |
| 0 | 14 | 28 | 44 |
| 1 | 12 | 24 | 36 |

### [Condition 2: Maximum Number of CCEs Limited]

As described above, according to the upper layer signaling configuration value, the maximum number C of CCEs constituting the entire search space (for example, the entire search space refers to the entire CCE set corresponding to a union domain of multiple search space sets) may follow Table 12-3 given below if the same is defined with reference to a slot in a cell configured to have a subcarrier spacing of 15-2^{μ} kHz, and may follow Table 12-4 given below if the same is defined with reference to a span.

TABLE 12-3

| | Maximum number of non-overlapped |
|---|---|
| μ | CCEs per slot and per serving cell (C^{μ}) |
| 0 | 56 |
| 1 | 56 |
| 2 | 48 |
| 3 | 32 |

TABLE 12-4

| | Maximum number C^{μ} of non-overlapped CCEs per | | |
|---|---|---|---|
| | span for combination (X, Y) and per serving cell | | |
| μ | (2, 2) | (4, 3) | (7, 3) |
| 0 | 18 | 36 | 56 |
| 1 | 18 | 36 | 56 |

For the sake of descriptive convenience, a situation satisfying both conditions 1 and 2 above at a specific timepoint may be defined as “condition A”. Therefore, the description that condition A is not satisfied may mean that at least one of conditions 1 and 2 above is not satisfied.

### [PDCCH: Overbooking]

According to the configuration of search space sets of the base station, a case in which condition A is not satisfied may occur at a specific timepoint. If condition A is not satisfied at a specific timepoint, the UE may select and monitor only some of search space sets configured to satisfy condition A at the corresponding timepoint. If condition A is not satisfied at a specific timepoint, the base station may transmit a PDCCH to the selected search space set.

A method for selecting some search spaces from all configured search space sets may follow methods as described below.

If condition A regarding a PDCCH fails to be satisfied at a specific timepoint (slot), the UE (or the base station) may preferentially select a search space set having a search space type configured as a common search space, among search space sets existing at the corresponding timepoint, over a search space set configured as a UE-specific search space.

If all search space sets configured as common search spaces have been selected (for example, if condition A is satisfied even after all search spaces configured as common search spaces have been selected), the UE (or the bae station) may select search space sets configured as UE-specific search spaces. If there are multiple search space sets configured as UE-specific search spaces, a search space set having a lower search space set index may have a higher priority. UE-specific search space sets may be selected as long as condition A is satisfied, in consideration of the priority.

### [QCL, TCI State]

In a wireless communication system, one or more different antenna ports (which may be replaced with one or more channels, signals, and combinations thereof, but will be referred to as different antenna ports, as a whole, for convenience of description of the disclosure) may be associated with each other by a quasi-co-location (QCL) configuration as in Table 10 below. A TCI state may be for indicating the QCL relation between a PDCCH (or a PDCCH DRMS) and another RS or channel. The description that a reference antenna port A (reference RS #A) and another target antenna port B (target RS #B) are QCLed with each other may mean that the UE is allowed to apply some or all of large-scale channel parameters estimated in the antenna port A to channel measurement form the antenna port B. The QCL needs to be associated with different parameters according to the situation such as 1) time tracking influenced by average delay and delay spread, 2) frequency tracking influenced by Doppler shift and Doppler spread, 3) radio resource management (RRM) influenced by average gain, or 4) beam management (BM) influenced by a spatial parameter. Accordingly, four types of QCL relations are supported in NR as in Table 13 below.

TABLE 13

| QCL type | Large-scale characteristics |
|---|---|
| A | Doppler shift, Doppler spread, average delay, delay spread |
| B | Doppler shift, Doppler spread |
| C | Doppler shift, average delay |
| D | Spatial Rx parameter |

The spatial RX parameter may refer to some or all of various parameters as a whole, such as angle of arrival (AoA), power angular spectrum (PAS) of AoA, angle of departure (AoD), PAS of AoD, transmit/receive channel correlation, transmit/receive beamforming, and spatial channel correlation.

The QCL relations may be configured for the UE through RRC parameter TCI-state and QCL-info as in Table 14 below. Referring to Table 14, the base station may configure one or more TCI states for the UE, thereby informing of a maximum of two kinds of QCL relations (qcl-Type1, qcl-Type2) regarding the RS that refers to the ID of the TCI state (for example, the target RS). Each piece of QCL information (QCL-Info) that each TCI state may include the serving cell index and the BWP index of the reference RS indicated by the corresponding QCL information, the type and ID of the reference BS, and a QCL type as in Table 13 above.

TABLE 14

```
TCI-State ::= SEQUENCE {
        tci-StateId TCI-
StateId,
        (ID of corresponding TCI state)
        qcl-Type1 QCL-Info.
        (QCL information of first refernece RS of RS (target RS) referring to corresponding TCI
state ID)
        qcl-Type2 QCL-Info
                                      OPTIONAL, -- Need R
        (QCL information of second refernece RS of RS (target RS) referring to corresponding
TCI state ID)
        ...
}
QCL-Info ::= SEQUENCE {
        cell
        ServCellIndex OPTIONAL, --Need R
        (serving cell index of reference RS indicated by corresponding QCL information)
        bwp-Id BWP-Id
                OPTIONAL, -- Cond CSI-RS-Indicated
        (BWP index of reference RS indicated by corresponding QCL information)
        referenceSignal CHOICE {
                csi-rs
        NZP-CSI-RS-ResourceId,
                ssb
        SSB-Index
                (one of CSI-RS ID or SSB ID indicated by corresponding QCL information)
        },
        qcl-Type ENUMERATED
{typeA, typeB, typeC, typeD},
        ...
}
```

### [Discontinuous Reception (DRX)]

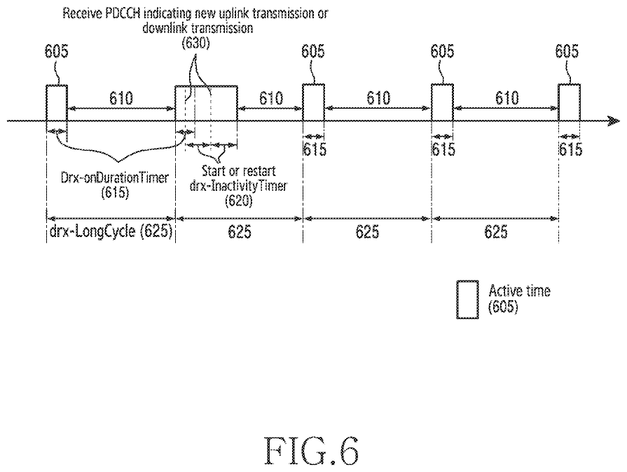

FIG. 6 illustrates discontinuous reception (DRX).

DRX refers to an operation in which a UE currently using a service discontinuously receives data in an RRC-connected state in which a radio link is configured between the base station and the UE. If the DRX is applied, the UE may turn on a receiver at a specific timepoint so as to monitor a control channel, and may turn off the receiver if there is no data received for a predetermined period of time, thereby reducing power consumed by the UE. The DRX operation may be controlled by a MAC layer device, based on various parameters and timers.

Referring to FIG. 6, the active time 605 refers to a time during which the UE wakes up at each DRX cycle and monitors the PDCCH. The active timer 605 may be defined as follows.
drx-onDurationTimer or drx-InactivityTimer or drx-RetransmissionTimerDL or drx-RetransmissionTimerUL or ra-ContentionResolutionTimer is running, or
a Scheduling Request is sent on PUCCH and is pending, or
a PDCCH indicating a new transmission addressed to the C-RNTI of the MAC entity has not been received after successful reception of a Random Access Response for the Random Access Preamble not selected by the MAC entity among the contention-based Random Access Preamble
Drx-onDurationTimer, drx-InactivityTimer, drx-RetransmissionTimerDL, drx-RetransmissionTimerUL, ra-ContentionResolutionTimer, and the like are timers having values configured by the base station, and have functions which cause the UE to monitor the PDCCH in a situation in which a predetermined condition is satisfied.

The drx-onDurationTimer 615 is a parameter for configuring the minimum time during which the UE is awake at the DRX cycle. The drx-InactivityTimer 620 is a parameter for configuring a time during which the UE is additionally awake upon receiving a PDCCH indicating new uplink transmission or downlink transmission (630), drx-RetransmissionTimerDL is a parameter for configuring the maximum time during which the UE is awake in order to receive downlink retransmission in a downlink HARQ procedure, drx-RetransmissionTimerUL is a parameter for configuring the maximum time during which the UE is awake in order to receive an uplink retransmission grant in an uplink HARQ procedure. For example, drx-onDurationTimer, drx-InactivityTimer, drx-RetransmissionTimerDL, and drx-RetransmissionTimerUL may be configured as, for example, time, the number of subframes, the number of slots, and the like. ra-ContentionResolutionTimer is a parameter for monitoring the PDCCH in a random access procedure.

The inActive time 610 refers to a time configured such that the PDCCH is not monitored during the DRX operation or a time configured such that the PDCCH is not received. The inActive time 610 may be obtained by subtracting the active timer 605 from the entire time during which the DRX operation is performed. If the UE does not monitor the PDCCH during the active time 605, the UE may enter a sleep or inActive state, thereby reducing power consumption.

The DRX cycle may refer to the cycle at which the UE wakes up and monitors the PDCCH. For example, the DRX cycle may refer to the time interval between when the UE monitors a PDCCH and when the next PDCCH is monitored, or the cycle at which on-duration occurs. There may be two kinds of DRX cycles: a short DRX cycle and a long DRX cycle. The short DRX cycle may be optionally applied.

The long DRX cycle 625 is the longer cycle between two DRX cycles configured for the UE. While operating with long DRX, the UE restarts the drx-onDurationTimer 615 at a timepoint at which the long DRX cycle 625 has elapsed from the start point (for example, start symbol) of the drx-onDurationTimer 615. If operating at the long DRX cycle 625, the UE may start the drx-onDurationTimer 615 in a slot after drx-SlotOffset in a subframe satisfying Equation 2 below, drx-SlotOffset may refer to a delay before the drx-onDurationTimer 615 is started, drx-SlotOffset may be configured, for example, as time, the number of slots, or the like.

[(SFN×10)+subframe number]modulo(drx-LongCycle)=drx-StartOffset [Equation 2]
wherein drx-LongCycleStartOffset may be used to define the long DRX cycle 625, and drx-StartOffset may be used to define a subframe to start the long DRX cycle 625, drx-LongCycleStartOffset may be configured as, for example, time, the number of subframes, the number of slots, or the like.

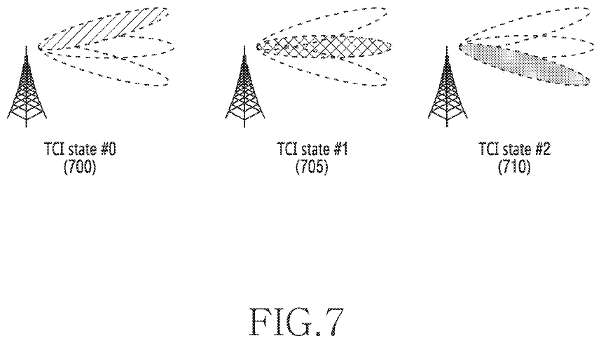

FIG. 7 illustrates an example of base station beam allocation according to TCI state configuration in a wireless communication system according to an embodiment of the disclosure. More specifically, referring to FIG. 7, FIG. 7 illustrates an example in which a base station allocates beams according to TCI state configuration.

Referring to FIG. 7, the base station may transfer information regarding N different beams to the UE through N different TCI states. Referring to FIG. 7, for example, in the case of N=3, the base station may configure qcl-Type2 parameters included in three TCI states 700, 705, and 710 in QCL type D while being associated with CSI-RSs or SSBs corresponding to different beams. The base station may announce that antenna ports referring to the different TCI states 700, 705, and 710 are associated with different spatial Rx parameters (for example, different beams).

Tables 15-1 to 15-5 below enumerate valid TCI state configurations according to the target antenna port type.

Table 15-1 enumerates valid TCI state configurations when the target antenna port is a CSI-RS for tracking (TRS). The TRS may refer to an NZP CSI-RS which has no repetition parameter configured therefor, and trs-Info of which is configured as “true”, among CRI-RSs. In Table 15-1, configuration no. 3 may be used for an aperiodic TRS. However, according to various embodiments of the disclosure, TCI state configuration may not be limited to the examples given in Table 15-1 below.

TABLE 15-1
Valid TCI state configurations when the target antenna port is a
CSI-RS for tracking (TRS)

| Valid TCI state | | | DL RS 2 | qcl-Type2 |
|---|---|---|---|---|
| Configuration | DLRS 1 | qcl-Type1 | (If configured) | (If configured) |
| 1 | SSB | QCL-TypeC | SSB | QCL-TypeD |
| 2 | SSB | QCL-TypeC | CSI-RS (BM) | QCL-TypeD |
| 3 | TRS | QCL-TypeA | TRS (same as | QCL-TypeD |
| | (periodic) | | DL RS 1) | |

Table 15-2 enumerates valid TCI state configurations when the target antenna port is a CSI-RS for CSI. The CST-RS for CSI may refer to an NZP CST-RS which has no parameter indicating repetition (for example, repetition parameter) configured therefor, and trs-Info of which is not configured as “true”, among CRI-RSs. However, according to various embodiments of the disclosure, TCI state configuration may not be limited to the examples given in Table 15-2 below.

TABLE 15-2
Valid TCI state configurations when the target antenna
port is a CSI-RS for CSI

| Valid TCI state | | | DL RS 2 | qcl-Type2 |
|---|---|---|---|---|
| Configuration | DL RS 1 | qcl-Type1 | (If configured) | (If configured) |
| 1 | TRS | QCL-TypeA | SSB | QCL-TypeD |
| 2 | TRS | QCL-TypeA | CSI-RS for BM | QCL-TypeD |
| 3 | TRS | QCL-TypeA | TRS (same as | QCL-TypeD |
| | | | DL RS 1) | |
| 4 | TRS | QCL-TypeB | | |

Table 15-3 enumerates valid Tin state configurations when the target antenna port is a CSI-RS for beam management (BM) (for example, which has the same meaning as CSI-RS for L1 RSRP reporting). The CSI-RS for BM refers to an NZP CSI-RS which has a repetition parameter configured to have a value of “on” or “off”, and trs-Info of which is not configured as “true”, among CRI-RSs. However, according to various embodiments of the disclosure, TCI state configuration may not be limited to the examples given in Table 15-3 below.

TABLE 15-3
Valid TCI state configurations when the target antenna port is a
CSI-RS for BM (for L1 RSRP reporting)

| Valid TCI state | | | DL RS 2 | qcl-Type2 |
|---|---|---|---|---|
| Configuration | DLRS 1 | qcl-Type1 | (If configured) | (If configured) |
| 1 | TRS | QCL-TypeA | TRS (same as | QCL-TypeD |
| | | | DL RS 1) | |
| 2 | TRS | QCL-TypeA | CSI-RS (BM) | QCL-TypeD |
| 3 | SS/PBCH | QCL-TypeC | SS/PBCH | QCL-TypeD |
| | Block | | Block | |

Table 15-4 enumerates valid TCI state configurations when the target antenna port is a PDCCH DMRS. However, according to various embodiments of the disclosure, TCI state configuration may not be limited to the examples given in Table 15-4 below.

TABLE 15-4
Valid TCI state configurations when the target antenna port is a
PDCCH DMRS

| Valid | | | DL RS 2 | qcl-Type2 |
|---|---|---|---|---|
| TCI state | | | (If | (If |
| Configuration | DL RS 1 | qcl-Type1 | configured) | configured) |
| 1 | TRS | QCL-TypeA | TRS (same as | QCL-TypeD |
| | | | DL RS 1) | |
| 2 | TRS | QCL-TypeA | CSI-RS (BM) | QCL-TypeD |
| 3 | CSI-RS (CSI) | QCL-TypeA | CSI-RS (same | QCL-TypeD |
| | | | as DL RS 1) | |

Table 15-5 enumerates valid TCI state configurations when the target antenna port is a PDSCH DMRS. However, according to various embodiments of the disclosure, TCI state configuration may not be limited to the examples given in Table 15-5 below.

TABLE 15-5
Valid TCI state configurations when the target antenna port is
a PDSCH DMRS

| Valid | | | DL RS 2 | qcl-Type2 |
|---|---|---|---|---|
| TCI state | | | (If | (If |
| Configuration | DLRS 1 | qcl-Type1 | configured) | configured) |
| 1 | TRS | QCL-TypeA | TRS | QCL-TypeD |
| 2 | TRS | QCL-TypeA | CSI-RS (BM) | QCL-TypeD |
| 3 | CSI-RS (CSI) | QCL-TypeA | CSI-RS (CSI) | QCL-TypeD |

According to a representative QCL configuration method based on Tables 15-1 to 15-5 above, the target antenna port and reference antenna port for each step may be configured and operated such as “SSB”->“TRS”->“CSI-RS for CSI, or CSI-RS for BM, or PDCCH DMRS, or PDSCH DMRS”. Accordingly, it may be possible to help the UE's receiving operation by associating statistical characteristics that can be measured from the SSB and TRS with respective antenna ports.

### [PDCCH: Regarding TCI State]

Specific TCI state combinations applicable to a PDCCH DMRS antenna port may be given in Table 16 below. The fourth row in Table 16 may correspond to a combination assumed by the UE before RRC configuration, and no configuration may be possible after the RRC.

TABLE 16

| Valid TCI | | | DL RS 2 | qcl-Type2 |
|---|---|---|---|---|
| state | | | (if | (if |
| Configuration | DL RS 1 | qcl-Type1 | configured) | configured) |
| 1 | TRS | QCL- | TRS | QCL-TypeD |
| | | TypeA | | |
| 2 | TRS | QCL- | CSI-RS (BM) | QCL-TypeD |
| | | TypeA | | |
| 3 | CSI-RS (CSI) | QCL- | | |
| | | TypeA | | |
| 4 | SS/PBCH | QCL- | SS/PBCH | QCL-TypeD |
| | Block | TypeA | Block | |

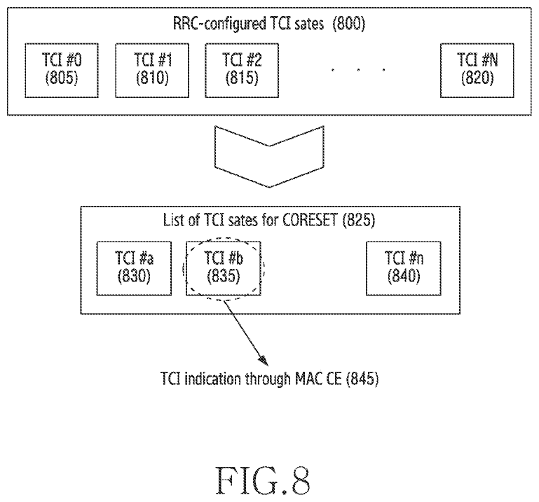

FIG. 8 illustrates an example of a method for TCI state allocation with regard to a PDCCH in a wireless communication system according to an embodiment of the disclosure. In NR, a hierarchical signaling method as illustrated in FIG. 8 may be supported for dynamic allocation regarding a PDCCH beam. Referring to FIG. 8, the base station may configure N TCI states 805, 810, . . . , 820 for the UE through RRC signaling 800, and may configure some thereof as TCI states for a CORESET (825). The base station may then indicate one of the TCI states 830, 835, and 340 for the CORESET to the UE through MAC CE signaling (845). The UE may then receive a PDCCH, based on beam information included in the TCI state indicated by the MAC CE signaling.

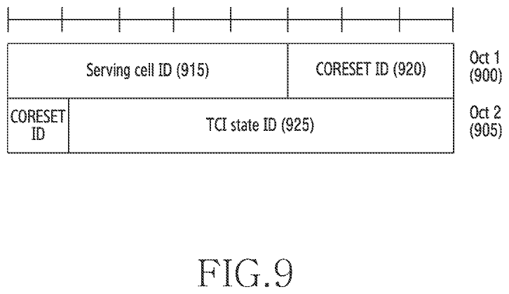

FIG. 9 illustrates a TCI indication MAC CE signaling structure for a PDCCH DMRS in a wireless communication system according to an embodiment of the disclosure. Referring to FIG. 9, FIG. 9 illustrates a TCI indication MAC CE signaling structure for a PDCCH DMRS. Referring to FIG. 9, the TCI indication MAC CE signaling for the PDCCH DMRS may be configured by 2 bytes (16 bits), and include a 5-bit serving cell ID 915, a 4-bit CORESET ID 920, and a 7-bit TCI state ID 925.

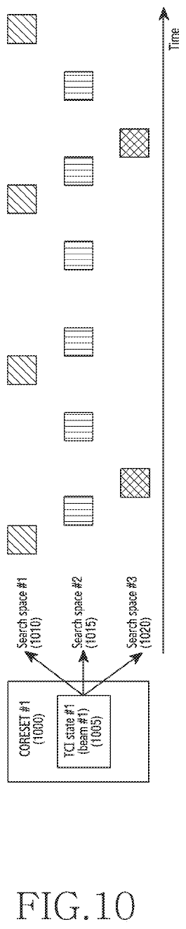

FIG. 10 illustrates beam configuration with regard to a control resource set and a search space in a wireless communication system according to an embodiment of the disclosure. More specifically. FIG. 10 illustrates an example of beam configuration with regard to a control resource set (CORESET) and a search space according to the above description. Referring to FIG. 10, the base station may indicate one of TCI state lists included in CORESET 1000 configuration through MAC CE signaling (1005). Until a different TCI state is indicated for the corresponding CORESET through different MAC CE signaling, the UE may consider that identical QCL information (beam #1) 1005 is all applied to one or more search spaces 1010, 1015, and 1020 connected to the CORESET. The above-described PDCCH beam allocation method may have a problem in that it is difficult to indicate a beam change faster than MAC CE signaling delay, and the same beam is unilaterally applied to each CORESET regardless of search space characteristics, thereby making flexible PDCCH beam operation difficult. Following embodiments of the disclosure provide more flexible PDCCH beam configuration and operation methods. Although multiple distinctive examples will be provided for convenience of description of embodiments of the disclosure, they are not mutually exclusive, and can be combined and applied appropriately for each situation.

The base station may configure one or multiple TCI states for the UE with regard to a specific control resource set. The base station may activate one of the configured TCI states through a MAC CE activation command. For example, {TCI state #0, TCI state #1, TCI state #2} may be configured as TCI states for control resource set #1. The base station may transmit an activation command to the UE through a MAC CE such that TCI state #0 is assumed as the TCI state regarding control resource set #1. The UE may receive the DMRS of the corresponding control resource set, based on the activation command regarding the TCI state received through the MAC CE. The UE may receive the DMRS of the corresponding control resource set, based on QCL information in the activated TCI state

With regard to a control resource set having a configured index of 0 (control resource set #0), if the UE has failed to receive a MAC CE activation command regarding the TCI state of control resource set #0, the UE may assume that the DMRS transmitted in control resource set #0 has been QCL-ed with a SS/PBCH block identified in the initial access process, or in a non-contention-based random access process not triggered by a PDCCH command.

With regard to a control resource set having a configured index value other than 0 (control resource set #X), if the UE has no TCI state configured regarding control resource set #X, or if the UE has one or more TCI states configured therefor but has failed to receive a MAC CE activation command for activating one thereof, the UE may assume that the DMRS transmitted in control resource set #X has been QCL-ed with a SS/PBCH block identified in the initial access process.

### [PDCCH: Regarding QCL Prioritization Rule]

Hereinafter, operations for determining QCL priority regarding a PDCCH will be described in detail.

The UE may operate according to carrier aggregation inside a single cell or band. If multiple control resource sets which exist inside a single or multiple in-cell activated bandwidth parts overlap temporally while having identical or different QCL-TypeD characteristics in a specific PDCCH monitoring occasion, the UE may select a specific control resource set according to a QCL priority determining operation and may monitor control resource sets having the same QCL-TypeD characteristics as the corresponding control resource set. For example, if multiple control resource sets overlap temporally, only one QCL-TypeD characteristic can be received. The QCL priority may be determined by the following criteria.
Criterion 1. A control resource set connected to a common search space having the lowest index inside a cell corresponding to the lowest index among cells including a common search space
Criterion 2. A control resource set connected to a UE-specific search space having the lowest index inside a cell corresponding to the lowest index among cells including a UE-specific search space

As described above, if one criterion among the criteria is not satisfied, the next criterion may be applied. For example, if control resource sets overlap temporally in a specific PDCCH monitoring occasion, and if all control resource sets are not connected to a common search space but connected to a UE-specific search space (for example, if criterion 1 is not satisfied), the UE may omit application of criterion 1 and apply criterion 2.

If selecting control resource set according to the above-mentioned criteria, the UE may additionally consider the two aspects with regard to QCL information configured for the control resource set. Firstly, if control resource set 1 has CSI-RS 1 as a reference signal having a relation of QCL-TypeD, if this CSI-RS 1 has a relation of QCL-TypeD with reference signal SSB 1, and if another control resource set 2 has a relation of QCL-TypeD with reference signal SSB 1, the UE may consider that the two control resource sets 1 and 2 have different QCL-TypeD characteristics. Secondly, if control resource set 1 has CSI-RS 1 configured for cell 1 as a reference signal having a relation of QCL-TypeD, if this CSI-RS 1 has a relation of QCL-TypeD with reference signal SSB 1, if control resource set 2 has a relation of QCL-TypeD with reference signal CSI-RS 2 configured for cell 2, and if this CSI-RS 2 has a relation of QCL-TypeD with the same reference signal SSB 1, the UE may consider that the two control resource sets have the same QCL-TypeD characteristics.

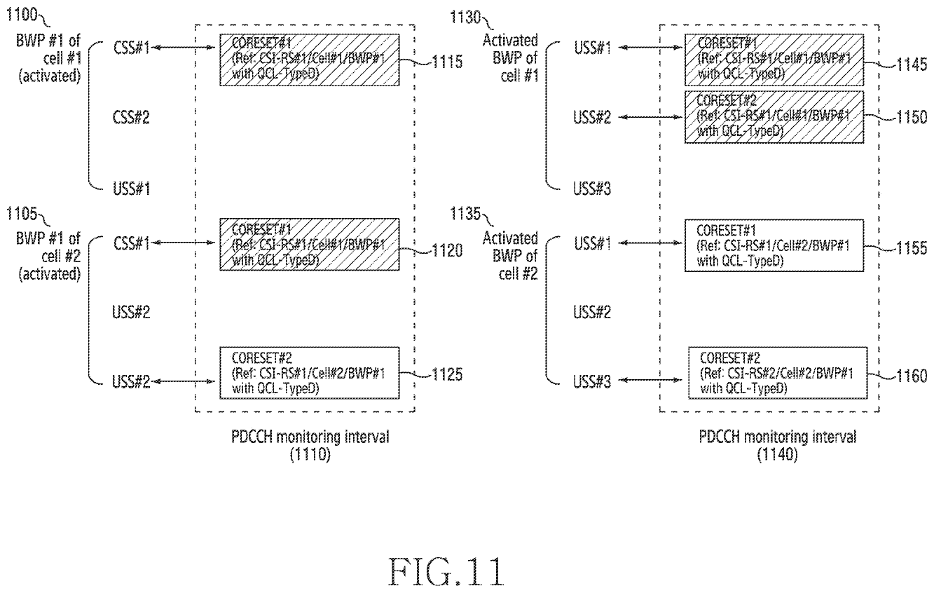

FIG. 11 illustrates an example of a method in which, upon receiving a downlink control channel, a UE selects a receivable control resource set in consideration of priority in a wireless communication system according to an embodiment of the disclosure. More specifically, FIG. 11 illustrates a method in which, upon receiving a downlink control channel, a UE selects a receivable control resource set in consideration of priority in a wireless communication system according to an embodiment of the disclosure. According to an embodiment, the UE may be configured to receive multiple control resource sets overlapping temporally in a specific PDCCH monitoring occasion 1110. The multiple control resource sets may be connected to a common search space or a UE-specific search space with regard to multiple cells. In the corresponding PDCCH monitoring occasion, control resource set no. 1 1115 connected to common search space no. 1 may exist in bandwidth part no. 1 1100 of cell no. 1. Control resource set no. 1 1120 connected to common search space no. 1 and control resource set no. 2 1125 connected to UE-specific search space no. 2 may exist in bandwidth part no. 1 1105 of cell no. 2. The control resource sets 1115 and 1120 may have a relation of QCL-TypeD with CSI-RS resource no. 1 configured in bandwidth part no. 1 of cell no. 1. The control resource set 1125 may have a relation of QCL-TypeD with CSI-RS resource no. 1 configured in bandwidth part no. 1 of cell no. 2. If criterion 1 is applied to the corresponding PDCCH monitoring occasion 1110, all other control resource sets having the same reference signal of QCL-TypeD as control resource set no. 1 1115 may be received. The UE may receive the control resource sets 1115 and 1120 in the corresponding PDCCH monitoring occasion 1110. According to another embodiment, the UE may be configured to receive multiple control resource sets overlapping temporally in a specific PDCCH monitoring occasion 1140. The multiple control resource sets may be connected to a common search space or a UE-specific search space with regard to multiple cells. In the corresponding PDCCH monitoring occasion, control resource set no. 1 1145 connected to UE-specific search space no. 1 and control resource set no. 2 1150 connected to UE-specific search space no. 2 may exist in bandwidth part no. 1 1130 of cell no. 1. In the corresponding PDCCH monitoring occasion, control resource set no. 1 1155 connected to UE-specific search space no. 1 and control resource set no. 2 1160 connected to UE-specific search space no. 3 may exist in bandwidth part no. 1 1135 of cell no. 2. The control resource sets 1145 and 1150 may have a relation of QCL-TypeD with CSI-RS resource no. 1 configured in bandwidth part no. 1 of cell no. 1. The control resource set 1155 may have a relation of QCL-TypeD with CSI-RS resource no. 1 configured in bandwidth part no. 1 of cell no. 2. The control resource set 1160 may have a relation of QCL-TypeD with CSI-RS resource no. 2 configured in bandwidth part no. 1 of cell no. 2. If criterion 1 is applied to the corresponding PDCCH monitoring occasion 1140, there is no common search space, and the next criterion, that is, criterion 2, may thus be applied. If criterion 2 is applied to the corresponding PDCCH monitoring occasion 1140, all other control resource sets having the same reference signal of QCL-TypeD as control resource set no. 1 1145 may be received. The UE may receive the control resource sets 1145 and 1150 in the corresponding PDCCH monitoring occasion 1140.

### [Regarding Rate Matching/Puncturing]

Hereinafter, a rate matching operation and a puncturing operation will be described in detail.

If time and frequency resource A to transmit symbol sequence A overlaps time and frequency resource B, a rate matching or puncturing operation may be considered as an operation of transmitting/receiving channel A in consideration of resource C (region in which resource A and resource B overlap). Specific operations may follow the following description.

### Rate Matching Operation

The base station may transmit channel A after mapping the same only to remaining resource domains other than resource C (area overlapping resource B) among the entire resource A which is to be used to transmit symbol sequence A to the UE. For example, assuming that symbol sequence A is configured as {symbol #1, symbol #2, symbol #3, symbol4}, resource A is {resource #1, resource #2, resource #3, resource #4}, and resource B is {resource #3, resource #5}, the base station may send symbol sequence A after successively mapping the same to remaining resources {resource #1, resource #2, resource #4} other than {resource #3} (corresponding to resource C) among resource A. Consequently, the base station may transmit symbol sequence {symbol #1, symbol #2, symbol #3} after mapping the same to {resource #1, resource #2, resource #4}, respectively.

The UE may assess resource A and resource B from scheduling information regarding symbol sequence A from the base station. The UE may assess resource C (region in which resource A and resource B overlap), based on the assessed resource A and resource B. The UE may receive symbol sequence A based on an assumption that symbol sequence A has been mapped and transmitted in the remaining area other than resource C among the entire resource A. For example, assuming that symbol sequence A is configured as {symbol #1, symbol #2, symbol #3, symbol4}, resource A is {resource #1, resource #2, resource #3, resource #4}, and resource B is {resource #3, resource #5}, the base station may send symbol sequence A after successively mapping the same to remaining resources {resource #1, resource #2, resource #4} other than {resource #3} (corresponding to resource C) among resource A. Consequently, the UE may perform a series of following receiving operations based on an assumption that symbol sequence {symbol #1, symbol #2, symbol #3} has been transmitted after being mapped to {resource #1, resource #2, resource #4}, respectively.

### Puncturing Operation

If there is resource C (region overlapping resource B) among the entire resource A which is to be used to transmit symbol sequence A to the UE, the base station may map symbol sequence A to the entire resource A, but may not perform transmission in the resource area corresponding to resource C, and may perform transmission with regard to only the remaining resource area other than resource C among resource A. For example, assuming that symbol sequence A is configured as {symbol #1, symbol #2, symbol #3, symbol4}, resource A is {resource #1, resource #2, resource #3, resource #4}, and resource B is {resource #3, resource #5), the base station may map symbol sequence {symbol #1, symbol #2, symbol #3, symbol #4} to resource A (resource #1, resource #2, resource #3, resource #4), respectively, may transmit only symbol sequence {symbol #1, symbol #2, symbol #4} corresponding to remaining resources {resource #1, resource #2, resource #4} other than {resource #3} (corresponding to resource C) among resource A, and may not transmit {symbol #3} mapped to {resource #3} (corresponding to resource C). Consequently, the base station may transmit symbol sequence {symbol #1, symbol #2, symbol #4} after mapping the same to {resource #1, resource #2, resource #4}, respectively.

The UE may assess resource A and resource B from scheduling information regarding symbol sequence A from the base station. The UE may assess resource C (region in which resource A and resource B overlap), based on the assessed resource A and resource B. The UE may receive symbol sequence A based on an assumption that symbol sequence A has been mapped to the entire resource A but transmitted only in the remaining area other than resource C among the resource area A. For example, if symbol sequence A is configured as {symbol #1, symbol #2, symbol #3, symbol4}, if resource A is {resource #1, resource #2, resource #3, resource #4}, and if resource B is {resource #3, resource #5}, the UE may assume that symbol sequence A {symbol #1, symbol #2, symbol #3, symbol4} is mapped to resource A {resource #1, resource #2, resource #3, resource #4}, respectively, but {symbol #3} mapped to {resource #3} (corresponding to resource C) is not transmitted, and based on the assumption that symbol sequence {symbol #1, symbol #2, symbol #4} corresponding to remaining resources {resource #1, resource #2, resource #4} other than {resource #3} (corresponding to resource C) among resource A has been mapped and transmitted, the UE may receive the same. Consequently, the UE may perform a series of following receiving operations based on an assumption that symbol sequence {symbol #1, symbol #2, symbol #4} has been transmitted after being mapped to {resource #1, resource #2, resource #4}, respectively.

Hereinafter, a method for configuring a rate matching resource for the purpose of rate matching in a 5G communication system will be described. Rate matching may refer to adjusting the size of a signal in consideration of the amount of resources that can be used to transmit the signal. For example, data channel rate matching may mean that a data channel is not mapped and transmitted with regard to specific time and frequency resource domains, and the size of data is adjusted accordingly.

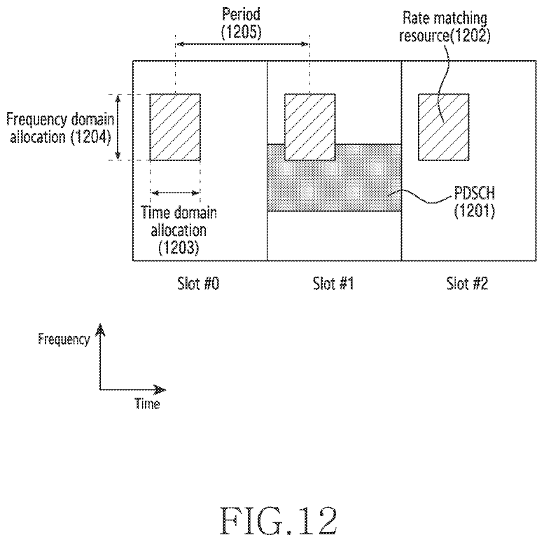

FIG. 12 illustrates an example of a method in which a base station and a UE transmit/receive data in consideration of a downlink data channel and a rate matching resource in a wireless communication system according to an embodiment of the disclosure. More specifically. FIG. 12 is a diagram for explaining a method in which a base station and a UE transmit/receive data in consideration of a downlink data channel and a rate matching resource.

Referring to FIG. 12, FIG. 12 illustrates a downlink data channel (PDSCH) 1201 and a rate matching resource 1202. The base station may configure one or multiple rate matching resources 1202 for the UE through upper layer signaling (for example, RRC signaling). Rate matching resource 1202 configuration information may include time-domain resource allocation information 1203, frequency-domain resource allocation information 1204, and periodicity information 1205. A bitmap corresponding to the frequency-domain resource allocation information 1204 will hereinafter be referred to as “first bitmap”, a bitmap corresponding to the time-domain resource allocation information 1203 will be referred to as “second bitmap”, and a bitmap corresponding to the periodicity information 1205 will be referred to as “third bitmap”. If all or some of time and frequency resources of the scheduled PDSCH 1201 overlap a configured rate matching resource 1202, the base station may rate-match and transmit the PDSCH 1201 in a rate matching resource 1202 part, and the UE may perform reception and decoding after assuming that the PDSCH 1201 has been rate-matched in a rate matching resource 1202 part.

The base station may dynamically notify the UE, through DCI, of whether the PDSCH will be rate-matched in the configured rate matching resource part through an additional configuration (for example, corresponding to “rate matching indicator” inside DCI format described above). Specifically, the base station may select some from the configured rate matching resources and group them into a rate matching resource group, and may indicate, to the UE, whether the PDSCH is rate-matched with regard to each rate matching resource group through DCI by using a bitmap type. For example, if four rate matching resources RMR #1, RMR #2, RMR #3, and RMR #4 are configured, the base station may configure a rate matching groups RMG #1={RMR #1, RMR #2}, RMG #2={RMR #3, RMR #4}, and may indicate, to the UE, whether rate matching occurs in RMG #1 and RMG #2, respectively, through a bitmap by using two bits inside the DCI field. For example, in a case where rate matching is to be conducted, the base station may indicate this case by “1”, and in a case where rate matching is not to be conducted, the base station may indicate this case by “0”.

5G supports granularity of “RB symbol level” and “RE level” as a method for configuring the above-described rate matching resources for a UE. More specifically, the following configuration method may be followed.

### RB Symbol Level

The UE may have a maximum of four RateMatchPatterns configured per each bandwidth part through upper layer signaling, and one RateMatchPattern may include the following contents:
may include, in connection with a reserved resource inside a bandwidth part, a resource having time and frequency resource domains of the corresponding reserved resource configured as a combination of an RB-level bitmap and a symbol-level bitmap in the frequency domain. The reserved resource may span one or two slots. A time domain pattern (periodicityAndPattern) may be additionally configured wherein time and frequency domains including respective RB-level and symbol-level bitmap pairs are repeated.
may include a resource area corresponding to a time domain pattern configured by time and frequency domain resource areas configured by a control resource set inside a bandwidth part and a search space configuration in which corresponding resource areas are repeated.

### RE Level

The UE may have the following contents configured through upper layer signaling:
configuration information (lte-CRS-ToMatchAround) regarding a RE corresponding to a LTE CRS (Cell-specific Reference Signal or common reference signal) pattern, which may include LTE CRS's port number (nrofCRS-Ports) and LTE-CRS-vshift(s) value (v-shift), location information (carrierFreqDL) of a center subcarrier of a LTE carrier from a reference frequency point (for example, reference point A), the LTE carrier's bandwidth size (carrierBandwidthDL) information, subframe configuration information (mbsfn-SubframConfigList) corresponding to a multicast-broadcast single-frequency network (MBSFN), and the like. The UE may determine the position of the CRS inside the NR slot corresponding to the LTE subframe, based on the above-mentioned pieces of information.
may also include configuration information regarding a resource set corresponding to one or multiple zero power (ZP) CSI-RSs inside a bandwidth part.

### [Regarding LTE CRS Rate Match]

Hereinafter, a rate matching process regarding the above-mentioned LTE CRS will be described. In NR, for coexistence between long term evolution (LTE) and new RAT (NR) (LTE-NR coexistence), the pattern of cell-specific reference signal (CRS) of LTE may be configured for an NR UE. More specifically, the CRS pattern may be provided by RRC signaling including at least one parameter inside ServingCellConfig IE (information element) or ServingCellConfigCommon IE. Examples of the parameter may include lte-CRS-ToMatchAround, lte-CRS-PatternList1-r16, Ite-CRS-PatternList2-r16, crs-RateMatch-PerCORESETPoolIndex-r16, and the like.

Rel-15 NR may provide a function by which one CRS pattern can be configured per serving cell through parameter lte-CRS-ToMatchAround. Rel-16 NR may extend the above function such that multiple CRS patterns can be configured per serving cell. More specifically, a UE having a single-TRP (transmission and reception point) configuration may now have one CRS pattern configured per one LTE carrier, and a UE having a multi-TRP configuration may now have two CRS patterns configured per one LTE carrier. For example, the UE having a single-TRP configuration may have a maximum of three CRS patterns configured per serving cell through parameter lte-CRS-PatternList1-r16. As another example, the UE having a multi-TRP configuration may have a CRS configured for each TRP. The CRS pattern regarding TRP1 may be configured through parameter lte-CRS-PatternList1-r16, and the CRS pattern regarding TRP2 may be configured through parameter Ite-CRS-PatternList2-r16. If two TRPs are configured as above, whether the CRS patterns of TRP and TRP2 are both to be applied to a specific physical downlink shared channel (PDSCH) or only the CRS pattern regarding one TRP is to be applied may be determined through parameter crs-RateMatch-PerCORESETPoolIndex-r16. If parameter crs-RateMatch-PeiCORESETPoolIndex-r16 is configured “enabled”, only the CRS pattern of one TRP is applied, and both CRS patterns of the two TRPs are applied in other cases.

Table 17 shows a ServingCellConfig IE including the CRS patterns, and Table 18 shows a RateMatchPatteeLTE-CRS IE including at least one parameter regarding CRS patterns.

TABLE 17

```
ServingCellConfig ::= SEQUENCE {
    tdd-UL-DL-Configuration Dedicated TDD-UL-DL-ConfigDedicated
OPTIONAL, -- Cond TDD
    initialDownlinkBWP BWP-DownlinkDedicated
OPTIONAL, -- Need M
    downlinkBWP-ToReleaseList SEQUENCE (SIZE (1..maxNrofBWPs)) OF BWP-
Id OPTIONAL, -- Need N
    downlinkBWP-ToAddModList SEQUENCE (SIZE (1..maxNrofBWPs)) OF
BWP-Downlink OPTIONAL, -- Need N
    firstActiveDownlinkBWP-Id BWP-Id
OPTIONAL, -- Cond SyncAndCellAdd
    bwp-InactivityTimer ENUMERATED {ms2, ms3, ms4,
ms5, ms6, ms8, ms10, ms20, ms30,
ms40,ms50, ms60, ms80,ms100, ms200,ms300, ms500,
ms750, ms1280, ms1920, ms2560, spare 10, spare9, spare8,
spare7, spare6, spare5, spare4, spare3, spare2, spare1 } OPTIONAL, -- Need R
    defaultDownlinkBWP-Id BWP-Id
OPTIONAL, -- Need S
    uplinkConfig UplinkConfig
OPTIONAL, -- Need M
    supplementaryUplink UplinkConfig
OPTIONAL, -- Need M
    pdcch-ServingCellConfig SetupRelease { PDCCH-
ServingCellConfig } OPTIONAL, -- Need M
    pdsch-ServingCellConfig SetupRelease { PDSCH-
ServingCellConfig } OPTIONAL, -- Need M
    csi-MeasConfig SetupRelease { CSI-
MeasConfig } OPTIONAL, -- Need M
    sCellDeactivationTimer ENUMERATED {ms20, ms40, ms80,
ms160, ms200, ms240,
                                                                        ms320,
ms400, ms480, ms520, ms640, ms720,
                                                                        ms840,
ms1280, spare2, spare 1} OPTIONAL, -- Cond ServingCellWithoutPUCCH
    crossCarrierSchedulingConfig CrossCarrierSchedulingConfig
OPTIONAL, -- Need M
    tag-Id TAG-Id,
    dummy ENUMERATED
{enabled} OPTIONAL, -- Need
R
    pathlossReferenceLinking ENUMERATED {spCell, sCell}
OPTIONAL, -- Cond SCellOnly
    servingCellMO MeasObjectId
OPTIONAL, -- Cond MeasObject
    ...,
    [[
    Ite-CRS-ToMatchAround SetupRelease
{ RateMatchPatternLTE-CRS } OPTIONAL, -- Need M
    rateMatchPatternToAddModList SEQUENCE (SIZE
(1..maxNrofRateMatchPatterns)) OF RateMatchPattern OPTIONAL, -- Need N
    rateMatchPatternToReleaseList SEQUENCE (SIZE
(1..maxNrofRateMatchPatterns)) OF RateMatchPatternId OPTIONAL, -- Need N
    downlinkChannelBW-PerSCS-List SEQUENCE (SIZE (1..maxSCSs)) OF SCS-
SpecificCarrier OPTIONAL -- Need S
    ]],
    [[
    supplementaryUplinkRelease ENUMERATED {true}
OPTIONAL, -- Need N
    tdd-UL-DL-ConfigurationDedicated-IAB-MT-r16 TDD-UL-DL-ConfigDedicated-IAB-
MT-r16 OPTIONAL, -- Cond TDD_IAB
    dormantBWP-Config-r16 SetupRelease { DormantBWP-
Config-r16 } OPTIONAL, -- Need M
    ca-SlotOffset-r16 CHOICE {
        refSCS15kHz INTEGER (−2..2),
        refSCS30KHz INTEGER (−5..5),
        refSCS60KHz INTEGER (−10..10),
        refSCS120KHz INTEGER (−20..20)
    }
OPTIONAL, -- Cond AsyncCA
    channelAccessConfig-r16 SetupRelease
{ ChannelAccessConfig-r16 } OPTIONAL, -- Need M
    intraCellGuardBandsDL-List-r16 SEQUENCE (SIZE (1..maxSCSs)) OF
IntraCellGuardBandsPerSCS-r16 OPTIONAL, -- Need S
    intraCellGuardBandsUL-List-r16 SEQUENCE (SIZE (1..maxSCSs)) OF
IntraCellGuardBandsPerSCS-r16 OPTIONAL, -- Need S
    csi-RS-ValidationWith-DCI-r16 ENUMERATED {enabled}
OPTIONAL, -- Need R
    lte-CRS-PatternList1-r16 SetupRelease { LTE-CRS-
PatternList-r16 } OPTIONAL, -- Need M
    lte-CRS-PatternList2-r16 SetupRelease { LTE-CRS-
PatternList-r16 } OPTIONAL, -- Need M
    crs-RateMatch-PerCORESETPoolIndex-r16 ENUMERATED {enabled}
OPTIONAL, -- Need R
    enableTwoDefaultTCI-States-r16 ENUMERATED {enabled}
OPTIONAL, -- Need R
    enableDefaultTCI-StatePerCoresetPoolIndex-r16 ENUMERATED {enabled}
OPTIONAL, -- Need R
    enableBeamSwitchTiming-r16 ENUMERATED {true}
OPTIONAL, -- Need R
    cbg-TxDiffTBsProcessingTypel-r16 ENUMERATED {enabled}
OPTIONAL, -- Need R
    cbg-TxDiffTBsProcessingType2-r16 ENUMERATED {enabled}
OPTIONAL -- Need R
    ]]
}
```

TABLE 18

```
        - RateMatchPatternLTE-CRS
The IE RateMatchPatternLTE-CRS is used to configure a pattern to rate match around LTE
CRS. See TS 38.214 [19], clause 5.1.4.2.
                        RateMatchPatternLTE-CRS information element
-- ASNISTART
-- TAG-RATEMATCHPATTERNLTE-CRS-START
RateMatchPatternLTE-CRS ::= SEQUENCE {
    carrierFreqDL INTEGER (0..16383),
    carrierBandwidthDL ENUMERATED {n6, n15, n25, n50,
n75, n100, spare2, spare1},
    mbsfn-SubframeConfigList EUTRA-MBSFN-SubframeConfigList
OPTIONAL, -- Need M
    nrofCRS-Ports ENUMERATED {n1, n2, n4},
    v-Shift ENUMERATED {n0, n1,
n2, n3, n4, n5}
}
LTE-CRS-PatternList-r16 ::= SEQUENCE (SIZE (1..maxLTE-CRS-Patterns-
r16)) OF RateMatchPatternLTE-CRS
-- TAG-RATEMATCHPATTERNLTE-CRS-STOP
-- ASN1STOP
                      RateMatch PatternLTE-CRS field descriptions
carrierBandwidthDL
BW of the LTE carrier in number of PRBs (see TS 38.214 [19], clause 5.1.4.2).
carrierFreqDL
Center of the LTE carrier (see TS 38.214 [19], clause 5.1.4.2).
mbsfn-SubframeConfigList
LTE MBSFN subframe configuration (see TS 38.214 [19], clause 5.1.4.2).
nrofCRS-Ports
Number of LTE CRS antenna port to rate-match around (see TS 38.214 [19], clause 5.1.4.2).
v-Shift
Shifting value v-shift in LTE to rate match around LTE CRS (see TS 38.214 [19], clause 5.1.4.2).
```

### [PDSCH: Regarding Frequency Resource Allocation]

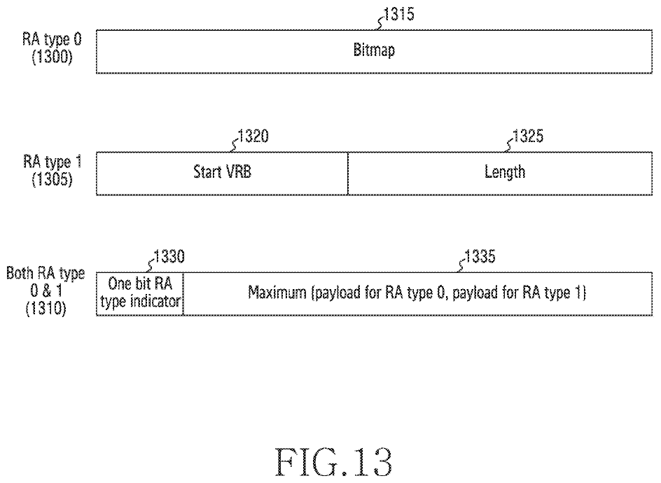

FIG. 13 illustrates frequency domain resource allocation with regard to a PDSCH in a wireless communication system according to an embodiment of the disclosure. More specifically. FIG. 13 illustrates an example of frequency domain resource allocation with regard to a PDSCH in a wireless communication system according to an embodiment of the disclosure.

Referring to FIG. 13. FIG. 13 illustrates three frequency domain resource allocation methods of type 0 1300, type 1 1305, and dynamic switch 1310 which can be configured through an upper layer in an NR wireless communication system.

Referring to FIG. 13, in the case 1300 in which a UE is configured to use only resource type 0 through upper layer signaling, partial downlink control information (DCI) for allocating a PDSCH to the UE include a bitmap including N_{RBG} bits. N_{RBG} may refer to the number of resource block groups (RBGs) determined according to the BWP size allocated by a BWP indicator and upper layer parameter rbg-Size, as in Table 19 below. Data may be transmitted in RBGs indicated as “I” by the bitmap.

TABLE 19

| Bandwidth Part Size | Configuration 1 | Configuration 2 |
|---|---|---|
| 1-36 | 3 | 4 |
| 37-72 | 4 | 8 |
| 73-144 | 8 | 16 |
| 145-275 | 16 | 16 |

In the case 1305 in which the UE is configured to use only resource type 1 through upper layer signaling, partial DCI includes frequency domain resource allocation information including [log₂(N_{RB}^{DL,BWP}(N_{RB}^{DL,BWP}+1)/2] bits. The base station may thereby configure a starting VRB 1320 and the length 1325 of a frequency domain resource allocated continuously therefrom.

In the case 1310 in which the UE is configured to use both resource type 0 and resource type 1 through upper layer signaling, partial DCI for allocating a PDSCH to the corresponding UE may include frequency domain resource allocation information including as many bits as the larger value 1335 between the payload 1315 for configuring resource type 0 and the payload 1320 and 1325 for configuring resource type 1. One bit may be added to the foremost part (MSB) of the frequency domain resource allocation information inside the DCI. If the bit has the value of “0”, use of resource type 0 may be indicated, and if the bit has the value of “1”, use of resource type 1 may be indicated.

### [PDSCH/PUSCH: Regarding Time Resource Allocation]

Hereinafter, a time domain resource allocation method regarding a data channel in a next-generation mobile communication system (5G or NR system) will be described.

A base station may configure a table for time domain resource allocation information regarding a physical downlink shared channel (PDSCH) and a physical uplink shared channel (PUSCH) for a UE through upper layer signaling (for example, RRC signaling). A table including a maximum of maxNrofDL-Allocations=16 entries may be configured for the PDSCH, and a table including a maximum of maxNrofUL-Allocations=16 entries may be configured for the PUSCH. In an embodiment, the time domain resource allocation information may include PDCCH-to-PDSCH slot timing (for example, corresponding to a slot-unit time interval between a timepoint at which a PDCCH is received and a timepoint at which a PDSCH scheduled by the received PDCCH is transmitted, labeled K0), PDCCH-to-PUSCH slot timing (for example, corresponding to a slot-unit time interval between a timepoint at which a PDCCH is received and a timepoint at which a PUSCH scheduled by the received PDCCH is transmitted; hereinafter, labeled K2), information regarding the location and length of the start symbol by which a PDSCH or PUSCH is scheduled inside a slot, the mapping type of a PDSCH or PUSCH, and the like. For example, information such as in Table 20 or Table 21 below may be transmitted from the base station to the UE. However, according to an embodiment of the disclosure, information included in the time domain resource allocation information is not limited to the above examples.

TABLE 20

```
                PDSCH-TimeDomainResourceAllocationList information element
PDSCH-TimeDomainResourceAllocationList ::=  SEQUENCE (SIZE(1..maxNrofDL-Allocations))
OF
PDSCH-TimeDomainResourceAllocation
PDSCH-TimeDomainResourceAllocation ::= SEQUENCE {
        k0
INTEGER(0..32)
  OPTIONAL, -- Need S
      (PDCCH-to-PDSCH timing, slot unit)
mappingType ENUMERATED {typeA, typeB},
      (PDSCH mapping type)
startSymbolAndLength INTEGER (0..127)
(start symbol and length of PDSCH)
}
```

TABLE 21

```
                PUSCH-TimeDomainResourceAllocationList information element
PUSCH-TimeDomainResourceAllocationList ::= SEQUENCE (SIZE(1..maxNrofUL-Allocations))
OF
PUSCH-TimeDomainResourceAllocation
PUSCH-TimeDomainResourceAllocation ::= SEQUENCE {
      k2
INTEGER(0..32) OPTIONAL, -- Need S
(PDCCH-to-PUSCH timing, slot unit) ENUMERATED {typeA,
        mappingType
typeB},
          (PUSCH mapping type)
  startSymbolAndLength INTEGER (0..127)
          (start symbol and length of PUSCH)
}
```

The base station may notify the UF of one of the entries of the table regarding time domain resource allocation information described above through L1 signaling (for example, DCI) (for example, “time domain resource allocation” field in DCI may indicate the same). The UE may acquire time domain resource allocation information regarding a PDSCH or PUSCH, based on the DCI acquired from the base station.

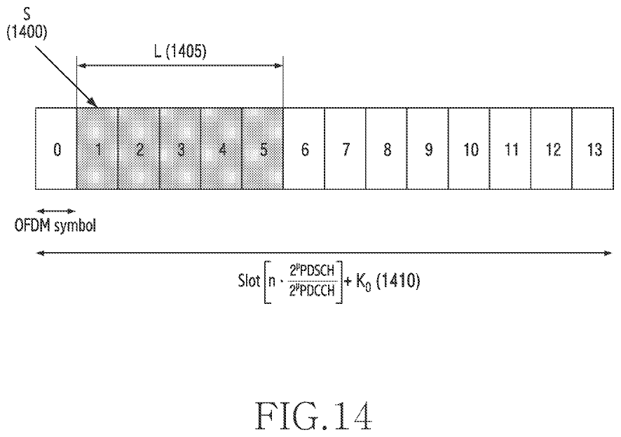

FIG. 14 illustrates time domain resource allocation with regard to a PDSCH in a wireless communication system according to an embodiment of the disclosure. More specifically. FIG. 14 illustrates an example of time domain resource allocation with regard to a PDSCH in a wireless communication system according to an embodiment of the disclosure.

Referring to FIG. 14, the base station may indicate the time domain location of a PDSCH resource according to the subcarrier spacing (SCS)(μ_{PDSCH}, μ_{PDCCH}) of a data channel and a control channel configured by using an upper layer, the scheduling offset (K0) value, and the OFDM symbol start location 1400 and length 1405 within one slot dynamically indicated through DCI.

### [PDSCH: T State Activation MAC-CE]

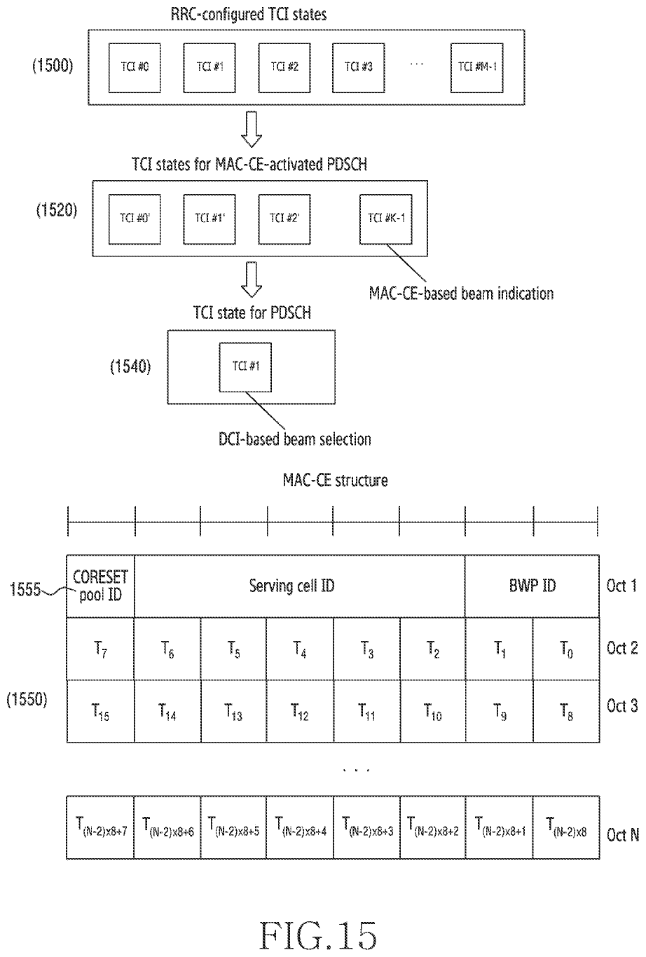

Hereinafter, a method for beam configuration with regard to a PDSCH will be described. FIG. 15 illustrates a process for beam configuration and activation with regard to a PDSCH.

A list of TCI states regarding a PDSCH may be indicated through an upper layer list such as RRC (1500). The list of T states may be indicated by tci-StatesToAddModList and/or tci-StatesToReleaseList inside a BWP-specific PDSCH-Config E, for example. A part of the list of TCI states may be activated through a MAC-CE (1520). The maximum number of activated T states may be determined by the capability reported by the UE. Referring to FIG. 15, an example of MAC-CE structure for PDSCH T e state activation/deactivation is illustrated (1550).

The meaning of respective fields inside the MAC CE and values configurable for respective fields are as follows.

```
- Serving Cell ID: This field indicates the identity of
    the Serving Cell for which the MAC
    CE applies. The length of the field is 5 bits. If the
    indicated Serving Cell is configured as
    part of a simultaneousTCI-UpdateList1 or
    simultaneousTCI-UpdateList2 as specified in
    TS 38.331 [5], this MAC CE applies to all
    the Serving Cells configured in the set
    simultaneousTCI-UpdateList1 or
    simultaneousTCI-UpdateList2, respectively;
- BWP ID: This field indicates a DL BWP for
    which the MAC CE applies as the codepoint
    of the DCI bandwidth part indicator field as
    specified in TS 38.212 [9]. The length of the
    BWP ID field is 2 bits. This field is ignored
    if this MAC CE applies to a set of Serving
    Cells;
- Tᵢ (TCI state ID): If there is a TCI state with
    TCI-StateId i as specified in TS 38.331 [5],
    this field indicates the activation/deactivation
    status of the TCI state with TCI-StateId i,
    otherwise MAC entity shall ignore the Ti field.
    The Ti field is set to 1 to indicate that the
    TCI state with TCI-StateId i shall be activated
    and mapped to the codepoint of the DCI
    Transmission Configuration Indication field, as
    specified in TS 38.214 [7]. The Ti field is
    set to 0 to indicate that the TCI state with
    TCI-StateId i shall be deactivated and is not
    mapped to the codepoint of the DCI Transmission
    Configuration Indication field. The
    codepoint to which the TCI State is mapped is
    determined by its ordinal position among
    all the TCI States with Ti field set to 1, i.e.
    the first TCI State with Ti field set to 1 shall
    be mapped to the codepoint value 0, second
    TCI State with Ti field set to 1 shall be mapped
    to the codepoint value 1 and so on. The maximum
    number of activated TCI states is 8;
- CORESET Pool ID: This field indicates that
    mapping between the activated TCI states
    and the codepoint of the DCI Transmission
    Configuration Indication set by field Ti is
    specific to the ControlResourceSetId configured
    with CORESET Pool ID as specified in
    TS 38.331 [5]. This field set to 1 indicates that
    this MAC CE shall be applied for the DL
    transmission scheduled by CORESET with the
    CORESET pool ID equal to 1, otherwise,
    this MAC CE shall be applied for the DL
    transmission scheduled by CORESET pool ID
    equal to 0. If the coresetPoolIndex is not configured
    for any CORESET, MAC entity shall
    ignore the CORESET Pool ID field in this MAC
    CE when receiving the MAC CE. If the
    Serving Cell in the MAC CE is configured in a cell
    list that contains more than one Serving
    Cell, the CORESET Pool ID field shall be
    ignored when receiving the MAC CE.
```

### [PUCCH: Relating to Transmission]

In an NR system, a UE may transmit uplink control information (UCI) to a base station via a PUCCH. The control information may include at least one of HARQ-ACK indicating a success or a failure of demodulation/decoding for a transport block (TB) received by the UE via a PDSCH, a scheduling request (SR) for requesting resource allocation from the PUSCH base station by the UE for uplink data transmission, or channel state information (CSI) that is information for channel state reporting of the UE.

PUCCH resources may be mainly divided into a long PUCCH and a short PUCCH according to a length of an assigned symbol. In the NR system, a long PUCCH may have a length of 4 symbols or more in a slot, and a short PUCCH may have a length of 2 symbols or fewer in a slot.

To elaborate more on the long PUCCH, the long PUCCH may be used for the purpose of improving uplink cell coverage. Therefore, the long PUCCH may be transmitted in a DFT-S-OFDM scheme, which is single-carrier transmission, rather than OFDM transmission. The long PUCCH may support transmission formats, such as PUCCH format 1, PUCCH format 3, or PUCCH format 4, depending on the number of supportable control information bits and whether UE multiplexing is supported via Pre-DFT OCC support at the front end of IFFT.

First, PUCCH format 1 is a DFT-S-OFDM-based long PUCCH format capable of supporting control information of up to 2 bits, and may use a frequency resource of 1 RB. The control information may include each of or a combination of HARQ-ACK and SR. In PUCCH format 1, an OFDM symbol including a demodulation reference signal (DMRS) that is a demodulation reference signal (or reference signal) and an OFDM symbol including UCI may be configured in a repetitive manner.

For example, if the number of transmission symbols of PUCCH format 1 is 8 symbols, starting from a first start symbol of the 8 symbols, a DMRS symbol, a UCI symbol, a DMRS symbol, a UCI symbol, a DMRS symbol, a UCI symbol, a DMRS symbol, and a UCI symbol may be included in sequence. The DMRS symbols may be spread, using an orthogonal code (or orthogonal sequence or spreading code, wᵢ(m)), on the time axis in a sequence corresponding to a length of 1 RB on the frequency axis within one OFDM symbol. The DMRS symbols may be transmitted after performing IFFT.

The UE may generate d(0) by BPSK modulating 1-bit control information and QPSK modulating 2-bit control information. The UE may perform scrambling by multiplying the generated d(0) by a sequence corresponding to a length of 1 RB on the frequency axis. The UE may spread the UCI symbols by using the orthogonal code (or orthogonal sequence or spreading code, wᵢ(m)) on the time axis in the scrambled sequence. The UE may transmit the UCI symbols after performing IFFT.

The UE may generate a sequence based on a configured ID and a group hopping or sequence hopping configuration received via higher-layer signaling from the base station. The UE may cyclically shift the generated sequence by using an initial cyclic shift (CS) value configured via a higher signal so as to generate a sequence corresponding to the length of 1 RB.

wᵢ(m) may be determined as in

$${W}_{i} ( m ) = {e}^{\frac{j 2 π∅ ( m )}{{N}_{SF}}}$$

when a spreading code length (NSF) is given, and may be specifically shown as in [Table 22] below. i denotes an index of the spreading code itself, and m denotes indexes of elements of the spreading code. Here, numbers within [ ] in [Table 22] refer to spreading codes, for example, if a length of a spreading code is 2 and an index of the configured spreading code satisfies i=0 spreading code wᵢ(m) becomes Wᵢ(0)=e^{j2π·0/N}^{_{SF}}=1 and Wᵢ(1)=e^{j2π·0/N}^{_{SF}}=1 so, that wᵢ(m)=[1 1],

TABLE 22
Spreading codes for PUCCH format 1

| | φ(m) | | | | | | |
|---|---|---|---|---|---|---|---|
| N_{SF} | i = 0 | i = 1 | i = 2 | i = 3 | i = 4 | i = 5 | i = 6 |
| 1 | [0] | — | — | — | — | — | — |
| 2 | [0 0] | [0 1] | — | — | — | — | — |
| 3 | [0 0 0] | [0 1 2] | [0 2 1] | — | — | — | — |
| 4 | [0 0 0 0] | [0 2 0 2] | [0 0 2 2] | [0 2 2 0] | — | — | — |
| 5 | [0 0 0 0 0] | [0 1 2 3 4] | [0 2 4 1 3] | [0 3 1 4 2] | [0 4 3 2 1] | — | — |
| 6 | [0 0 0 0 0 0] | [0 1 2 3 4 5] | [0 2 4 0 2 4] | [0 3 0 3 0 3] | [0 4 2 0 4 2] | [0 5 4 3 2 1] | — |
| 7 | [0 0 0 0 0 0 0] | [0 1 2 3 4 5 6] | [0 2 4 6 1 3 5] | [0 3 5 2 5 1 4] | [0 4 1 5 2 6 3] | [0 5 3 1 6 4 2] | [0 6 5 4 3 2 1] |

PUCCH format 3 is a DFT-S-OFDM-based long PUCCH format capable of supporting control information exceeding 2 bits, and the number of used RBs may be configured via a higher layer. The control information may include each of or a combination of HARQ-ACK, SR, and CSI. In PUCCH format 3. DMRS symbol positions may be as shown in [Table 23] below, depending on according to whether an additional DMRS symbol is configured and whether frequency bopping is configured within a slot. However, according to embodiments of the disclosure, the DMRS symbol positions m not be limited to the examples disclosed in Table 23.

TABLE 23

| Trans- | DMRS position within PUCCH format 3/4 transmission | | | |
|---|---|---|---|---|
| mission | No additional | | Additional | |
| length of | DMRS configured | | DMRS configured | |
| PUCCH | No frequency | Frequency | No frequency | Frequency |
| format | hopping | hopping | hopping | hopping |
| 3/4 | configured | configured | configured | configured |
| 4 | 1 | 0, 2 | 1 | 0, 2 |

| | | |
|---|---|---|
| 5 | 0, 3 | 0, 3 |
| 6 | 1, 4 | 1, 4 |
| 7 | 1, 4 | 1, 4 |
| 8 | 1, 5 | 1, 5 |
| 9 | 1, 6 | 1, 6 |
| 10 | 2, 7 | 1, 3, 6, 8 |
| 11 | 2, 7 | 1, 3, 6, 9 |
| 12 | 2, 8 | 1, 4, 7, 10 |
| 13 | 2, 9 | 1, 4, 7, 11 |
| 14 | 3, 10 | 1, 5, 8, 12 |

If the number of transmission symbols of PUCCH format 3 is 8 symbols, starting with a first start symbol being 0 among the 8 symbols, DMRSs may be transmitted via first and fifth symbols. [Table 23] may be applied in the same way to DMRS symbol positions of PUCCH format 4.

PUCCH format 4 is a DFT-S-OFDM-based long PUCCH format capable of supporting control information exceeding 2 bits, and a frequency resource of 1 RB may be used. The control information may include each of or a combination of HARQ-ACK, SR, and CSI. The difference between PUCCH format 4 and PUCCH format 3 is that, for PUCCH format 4, PUCCH format 4 of multiple UEs may be multiplexed within one RB. Multiplexing of PUCCH format 4 of multiple UEs is possible via application of Pre-DFT orthogonal cover code (OCC) to control information at the front end of IFFT. However, the number of transmittable control information symbols of one UE may be decreased according to the number of UEs to be multiplexed. The number of UEs which can be multiplexed, (e.g., the number of different available OCCs) may be 2 or 4, and the number of OCCs and OCC indexes to be applied may be configured via a higher layer.

Hereinafter, a description for a short PUCCH will be provided. A short PUCCH may be transmitted in both a downlink centric slot and an uplink centric slot. The short PUCCH may be generally transmitted in a last symbol of a slot or an OFDM symbol (e.g., a last OFDM symbol, a second OFDM symbol from the last, or last 2 OFDM symbols) at a rear part. The short PUCCH may be transmitted at any position within a slot. The short PUCCH may be transmitted using one OFDM symbol or two OFDM symbols. The short PUCCH may be used to shorten a delay time compared to a long PUCCH in a situation where uplink cell coverage is good, and may be transmitted in a CP-OFDM scheme.

The short PUCCH may support transmission formats, such as PUCCH format 0 and PUCCH format 2, according to the number of supportable control information bits. PUCCH format 0 is a short PUCCH format capable of supporting control information of up to 2 bits, and a frequency resource of 1 RB may be used. The control information may include each of or a combination of HARQ-ACK and SR. PUCCH format 0 may have a structure of transmitting only a sequence mapped to 12 subcarriers on the frequency axis within one OFDM symbol, without transmitting a DMRS. The UE may generate a sequence based on a configured ID and a group hopping or sequence hopping configuration received via a higher layer from the base station. The UE may cyclically shift the generated sequence by using a final cyclic shift (CS) value obtained by adding an initial CS value indicated in the generated sequence and a different CS value depending on ACK or NACK. The UE may map the sequence generated using the final CS value to 12 subcarriers so as to transmit the same.

For example, when HARQ-ACK is 1 bit, as in [Table 24], if ACK, the UE may generate the final CS by adding 6 to the initial CS value, and if NACK, the UE may generate the final CS by adding 0 to the initial CS. The CS value of 0 for NACK and the CS value of 6 for ACK may be defined in the standard, and the UE may generate PUCCH format 0 according to the values defined in the standard so as to transmit 1-bit HARQ-ACK.

TABLE 24

| 1-bit HARQ-ACK | NACK | ACK |
|---|---|---|
| Final CS | (Initial CS + 0) mod | (Initial CS + 6) mod 12 |
| | 12 = Initial CS | |

For example, if HARQ-ACK is 2 bits, as in [Table 25], the UE may add 0 to the initial CS value for (NACK. NACK), add 3 to the initial CS value for (NACK. ACK), add 6 to the initial CS value for (ACK, ACK), and add 9 to the initial CS value for (ACK, NACK). The CS value of 0 for (NACK, NACK), the CS value of 3 for (NACK, ACK), the CS value of 6 for (ACK, ACK), and the CS value of 9 for (ACK, NACK) may be defined in the standard. The UE may generate PUCCH format 0 according to the values defined in the standard so as to transmit 2-bit HARQ-ACK. If the final CS value exceeds 12 due to the CS value added to the initial CS value depending on ACK or NACK, since a sequence length is 12, modulo 12 may be applied to the final CS value.

TABLE 25

| 2-bit HARQ- | NACK, | NACK, | ACK, | ACK, |
|---|---|---|---|---|
| ACK | NACK | ACK | ACK | NACK |
| Final CS | (Initial | (Initial | (Initial | (Initial |
| | CS + 0) | CS + 3) | CS + 6) | CS + 9) |
| | mod 12 = | mod 12 | mod 12 | mod 12 |
| | Initial CS | | | |

PUCCH format 2 is a short PUCCH format supporting control information exceeding 2 bits, and the number of RBs used may be configured via a higher layer. The control information may include each of or a combination of HARQ-ACK, SR, and CSI. When an index of a first subcarrier is #0, in PUCCH format 2, positions of subcarriers in which DMRSs are transmitted may be fixed to subcarriers having indexes of #1, #4, #7, and #10 within one OFDM symbol. The control information may be mapped, via modulation after channel coding, to subcarriers remaining after excluding the subcarriers in which the DMRSs are positioned.

Values configurable for the respective PUCCH formats and ranges of the values described above may be shown as in [Table 26]. In [Table 26], a case where no value needs to be configured may be indicated as N.A.

| | | PUCCH | PUCCH | PUCCH | PUCCH | PUCCH |
|---|---|---|---|---|---|---|
| | | Format 0 | Format 1 | Format 2 | Format 3 | Format 4 |
| Starting symbol | Configurability | [symbol] | [symbol] | [symbol] | [symbol] | [symbol] |
| | Value range | [symbol] | [symbol] | [symbol] | [symbol] | [symbol] |
| Number of | Configurability | [symbol] | [symbol] | [symbol] | [symbol] | [symbol] |
| [symbol] | Value range | [symbol] | [symbol] | [symbol] | [symbol] | [symbol] |
| [symbol] | Configurability | [symbol] | [symbol] | [symbol] | [symbol] | [symbol] |
| [symbol] | Value range | [symbol] | [symbol] | [symbol] | [symbol] | [symbol] |
| [symbol] | | | | | | |
| Number of PRBs | Configurability | [symbol] | [symbol] | [symbol] | [symbol] | [symbol] |
| | Value range | [symbol] | [symbol] | [symbol] | [symbol] | N.A. |
| | | | | | | [symbol] |
| Enabling | Configurability | [symbol] | [symbol] | [symbol] | [symbol] | [symbol] |
| frequency | Value range | [symbol] | On-Off | [symbol] | On-Off | On-Off |
| [symbol] | | [symbol] | | [symbol] | | |
| [symbol] | | | | | | |
| [symbol] | Configurability | [symbol] | [symbol] | [symbol] | [symbol] | [symbol] |
| [symbol] | Value range | [symbol] | [symbol] | [symbol] | [symbol] | [symbol] |
| [symbol] | | | | | | |
| [symbol] | | | | | | |
| [symbol] | | | | | | |
| [symbol] | | | | | | |
| Index of initial | Configurability | [symbol] | [symbol] | N.A. | N.A. | N.A. |
| [symbol] | Value range | [symbol] | [symbol] | N.A. | N.A. | N.A. |
| [symbol] | Configurability | N.A. | [symbol] | N.A. | N.A. | N.A. |
| [symbol] | Value range | N.A. | [symbol] | N.A. | N.A. | N.A. |
| OCC | | | | | | |
| [symbol] | Configurability | N.A. | N.A. | N.A. | N.A. | [symbol] |
| [symbol] | Value range | N.A. | N.A. | N.A. | N.A. | [symbol] |
| [symbol] | Configurability | N.A. | N.A. | N.A. | N.A. | [symbol] |
| OCC | Value range | N.A. | N.A. | N.A. | N.A. | [symbol] |

[symbol]

indicates data missing or illegible when filed

In order to improve uplink coverage, multi-slot repetition may be supported for PUCCH formats 1, 3, and 4. PUCCH repetition may be configured for each PUCCH format. The UE may repeatedly transmit a PUCCH including UCI as many times as the number of slots configured via nrofSlots that is higher-layer signaling. For the repeated PUCCH transmission, PUCCH transmission in each slot may be performed using the same number of consecutive symbols, and the number of the consecutive symbols may be configured via higher-layer signaling nrofSymbols in PUCCH-format 1, PUCCH-format 3, or PUCCH-format 4. For the repeated PUCCH transmission, PUCCH transmission in each slot may be performed using the same start symbol, and the start symbol may be configured via higher-layer signaling startingSymbolIndex in PUCCH-format 1, PUCCH-format 3, or PUCCH-format 4. For the repeated PUCCH transmission, single PUCCH-spatialRelationInfo may be configured for a single PUCCH resource. For the repeated PUCCH transmission, when the UE is configured to perform frequency hopping in PUCCH transmission in different slots, the UE may perform frequency hopping in units of slots. When the UE is configured to perform frequency hopping in PUCCH transmission in different slots, the UE may start, in an even-numbered slot, the PUCCH transmission from a first PRB index configured via startingPRB that is higher-layer signaling, and the UE may start, in an odd-numbered slot, the PUCCH transmission from a second PRB index configured via secondHopPRB that is higher-layer signaling. When the UE is configured to perform frequency hopping in PUCCH transmission in different slots, an index of a slot indicated to the UE for first PUCCH transmission may be 0, and during the configured total number of repeated PUCCH transmissions, a value of the number of repeated PUCCH transmissions may be increased in each slot regardless of performing the PUCCH transmission. When the UE is configured to perform frequency hopping in PUCCH transmission in different slots, the UE may not expect configuration of frequency hopping within a slot during the PUCCH transmission. When the UE is not configured to perform frequency hopping in PUCCH transmission in different slots, but is configured with frequency hopping within a slot, first and second PRB indexes may be applied equally within the slot. If the number of uplink symbols available for PUCCH transmission is less than nrofSymbols configured via higher-layer signaling, the UE may not perform PUCCH transmission. If the UE fails to perform PUCCH transmission for some reason in a certain slot during repeated PUCCH transmission, the UE may increase the number of repeated PUCCH transmissions.

### [PUCCH: PUCCH Resource Configuration]

Hereinafter, descriptions will be provided for a PUCCH resource configuration of a base station or a UE. A base station may configure, for a specific UE, a PUCCH resource for each BWP via a higher layer. The PUCCH resource configuration may be as shown in [Table 27].

TABLE 27

```
PUCCH-Config ::= SEQUENCE {
    resourceSetToAddModList SEQUENCE (SIZE (1..maxNrofPUCCH-
ResourceSets)) OF PUCCH-ResourceSet OPTIONAL, -- Need N
    resourceSetToReleaseList SEQUENCE (SIZE (1..maxNrofPUCCH-
ResourceSets)) OF PUCCH-ResourceSetId OPTIONAL, -- Need N
    resourceToAddModList SEQUENCE (SIZE (1..maxNrofPUCCH-
Resources)) OF PUCCH-Resource OPTIONAL, -- Need N
    resourceToReleaseList SEQUENCE (SIZE (1. maxNrofPUCCH-Resources))
OF PUCCH-ResourceId OPTIONAL, -- Need N
    format1 SetupRelease { PUCCH-FormatConfig }
OPTIONAL, -- Need M
    format2 SetupRelease { PUCCH-FormatConfig }
OPTIONAL, -- Need M
    format3 SetupRelease { PUCCH-FormatConfig }
OPTIONAL, -- Need M
    format4 SetupRelease { PUCCH-FormatConfig }
OPTIONAL, -- Need M
    schedulingRequestResourceToAddModList SEQUENCE (SIZE (1..maxNrofSR-Resources)) OF
SchedulingRequestResourceConfig
OPTIONAL, -- Need N
    schedulingRequestResourceToReleaseList SEQUENCE (SIZE (1..maxNrofSR-Resources)) OF
SchedulingRequestResourceId
OPTIONAL, -- Need N
    multi-CSI-PUCCH-ResourceList SEQUENCE (SIZE (1..2)) OF PUCCH-ResourceId
OPTIONAL, -- Need M
    dl-DataToUL-ACK SEQUENCE (SIZE (1..8)) OF INTEGER (0..15)
OPTIONAL, -- Need M
    spatialRelationInfoToAddModList SEQUENCE (SIZE (1..maxNrofSpatialRelationInfos))
OF PUCCH-SpatialRelationInfo
OPTIONAL, -- Need N
    spatialRelationInfoToReleaseList SEQUENCE (SIZE (1..maxNrofSpatialRelationInfos)) OF
PUCCH-SpatialRelationInfoId
OPTIONAL, -- Need N
    pucch-PowerControl PUCCH-PowerControl
OPTIONAL, -- Need M
    ...,
    [[
    resourceToAddModListExt-r16 SEQUENCE (SIZE (1..maxNrofPUCCH-Resources))
OF PUCCH-ResourceExt-r16 OPTIONAL, -- Need N
    dl-DataToUL-ACK-r16 SetupRelease { DL-DataToUL-ACK-r16 }
OPTIONAL, -- Need M
    ul-AccessConfigListDCI-1-1-r16 SetupRelease { UL-AccessConfigListDCI-1-1-r16 }
OPTIONAL, -- Need M
    subslotLengthForPUCCH-r16 CHOICE {
            normalCP-r16 ENUMERATED {n2,n7},
            extendedCP-r16 ENUMERATED {n2,n6}
    }
OPTIONAL, -- Need R
    dl-DataToUL-ACK-DCI-1-2-r16 SetupRelease { DL-DataToUL-ACK-DCI-1-2-r16}
OPTIONAL, -- Need M
    numberOfBitsForPUCCH-ResourceIndicatorDCI-1-2-r16 INTEGER (0..3)
OPTIONAL, -- Need R
    dmrs-UplinkTransformPrecodingPUCCH-r16 ENUMERATED {enabled}
OPTIONAL, -- Cond PI2-BPSK
    spatialRelationInfoToAddModListSizeExt-v1610 SEQUENCE (SIZE
(1..maxNrofSpatialRelationInfosDiff-r16)) OF PUCCH-SpatialRelationInfo
OPTIONAL, -- Need N
    spatialRelationInfoToReleaseListSizeExt-v1610 SEQUENCE (SIZE
(1..maxNrofSpatialRelationInfosDiff-r16)) OF PUCCH-SpatialRelationInfoId
OPTIONAL, -- Need N
    spatialRelationInfoToAddModListExt-v1610 SEQUENCE (SIZE (1..maxNrofSpatialRelationInfos-
r16)) OF PUCCH-SpatialRelationInfoExt-r16
OPTIONAL, -- Need N
    spatialRelationInfoToReleaseListExt-v1610 SEQUENCE (SIZE
(1..maxNrofSpatialRelationInfos-r16)) OF
                                                                          PUCCH-
SpatialRelationInfoId-r16 OPTIONAL, -- Need N
    resourceGroupToAddModList-r16 SEQUENCE (SIZE (1..maxNrofPUCCH-
ResourceGroups-r16)) OF PUCCH-ResourceGroup-r16
OPTIONAL, -- Need N
    resourceGroupToReleaseList-r16 SEQUENCE (SIZE (1..maxNrofPUCCH-
ResourceGroups-r16)) OF PUCCH-ResourceGroupId-r16
OPTIONAL, -- Need N
    sps-PUCCH-AN-List-r16 SetupRelease { SPS-PUCCH-AN-List-r16 }
OPTIONAL,-- Need M
    schedulingRequestResourceToAddModListExt-v1610 SEQUENCE (SIZE (1..maxNrofSR-
Resources)) OF SchedulingRequestResourceConfigExt-v1610
OPTIONAL -- Need N
    ]]
}
```

According to [Table 27], one or multiple PUCCH resource sets in a PUCCH resource configuration for a specific BWP may be configured. A maximum payload value for UCI transmission may be configured in some of the PUCCH resource sets. Each PUCCH resource set may include one or multiple PUCCH resources. Each PUCCH resource may belong to one of the PUCCH formats described above.

With respect to the PUCCH resource sets, a maximum payload value of the first PUCCH resource set may be fixed to 2 bits. Accordingly, the value may not be separately configured via a higher layer or the like. When the remaining PUCCH resource sets are configured, indexes of the PUCCH resource sets may be configured in ascending order according to the maximum payload values, and a maximum payload value may not be configured for the last PUCCH resource set. A higher-layer configuration for the PUCCH resource sets may be as shown in [Table 28] below.

TABLE 28

```
PUCCH-ResourceSet ::= SEQUENCE {
    pucch-ResourceSetId PUCCH-ResourceSetId,
    resourceList SEQUENCE (SIZE (1..maxNrofPUCCH-
ResourcesPerSet)) OF PUCCH-ResourceId,
    maxPayloadSize INTEGER (4..256)
OPTIONAL -- Need R
}
```

Parameter resourceList in [Table 28] may include IDs of PUCCH resources belonging to the PUCCH resource set.

During initial access or if no PUCCH resource set is configured, a PUCCH resource set (e.g., [Table 29]) which includes multiple cell-specific PUCCH resources in an initial BWP may be used. A PUCCH resource to be used for initial access in the PUCCH resource set may be indicated via SIB1.

TABLE 29

| | | | | | Set of |
|---|---|---|---|---|---|
| | | | | | initial |
| | PUCCH | First | Number | PRB offset | CS |
| Index | format | symbol | of symbols | [symbol] | indexes |
| 0 | 0 | 12 | 2 | 0 | [0, 3] |
| 1 | 0 | 12 | 2 | 0 | [0, 4, 8] |
| 2 | 0 | 12 | 2 | 3 | [0, 4, 8] |
| 3 | 1 | 10 | 4 | 0 | [0, 6] |
| 4 | 1 | 10 | 4 | 0 | [0, 3, 6, 9] |
| 5 | 1 | 10 | 4 | 2 | [0, 3, 6, 9] |
| 6 | 1 | 10 | 4 | 4 | [0, 3, 6, 9] |
| 7 | 1 | 4 | 10 | 0 | [0, 6] |
| 8 | 1 | 4 | 10 | 0 | [0, 3, 6, 9] |
| 9 | 1 | 4 | 10 | 2 | [0, 3, 6, 9] |
| 10 | 1 | 4 | 10 | 4 | [0, 3, 6, 9] |
| 11 | 1 | 0 | 14 | 0 | [0, 6] |
| 12 | 1 | 0 | 14 | 0 | [0, 3, 6, 9] |
| 13 | 1 | 0 | 14 | 2 | [0, 3, 6, 9] |
| 14 | 1 | 0 | 14 | 4 | [0, 3, 6, 9] |
| 15 | 1 | 0 | 14 | └N [symbol] /4┘ | [0, 3, 6, 9] |

[symbol]

indicates data missing or illegible when filed

The maximum payload of each PUCCH resource included in the PUCCH resource set may be 2 bits for PUCCH format 0 or 1. For the remaining formats, the maximum payloads may be determined according to a symbol length, the number of PRBs, and a maximum code rate. The symbol length and the number of PRBs may be configured for each PUCCH resource, and the maximum code rate may be configured for each PUCCH format.

Hereinafter, PUCCH resource selection for UCI transmission will be described. For SR transmission, a PUCCH resource for an SR corresponding to schedulingRequestID may be configured via a higher layer, as shown in [Table 30]. The PUCCH resource may be a resource belonging to PUCCH format 0 or PUCCH format 1.

TABLE 30

```
SchedulingRequestResourceConfig ::= SEQUENCE {
    schedulingRequestResourceId SchedulingRequestResourceId,
    schedulingRequestID SchedulingRequestId,
    periodicityAndOffset CHOICE {
        sym2 NULL,
        sym6or7 NULL,
        sl1 NULL, -- Recurs in
every slot
        sl2 INTEGER (0..1),
        sl4 INTEGER (0..3),
        sl5 INTEGER (0..4),
        sl8 INTEGER (0..7),
        sl10 INTEGER (0..9),
        sl16 INTEGER (0..15),
        sl20 INTEGER (0..19),
        sl40 INTEGER (0..39),
        sl80 INTEGER (0..79),
        sl160 INTEGER (0..159),
        sl320 INTEGER (0..319),
        sl640 INTEGER (0..639)
    }
OPTIONAL, -- Need M
    resource PUCCH-ResourceId
OPTIONAL -- Need M
}
```

For the configured PUCCH resource, a transmission period and an offset may be configured via parameter periodicity AndOffset of [Table 30]. When there is uplink data to be transmitted by the UE at a time point corresponding to the configured period and offset, the corresponding PUCCH resource may be transmitted, otherwise, the corresponding PUCCH resource may not be transmitted.

For CSI transmission, a PUCCH resource for transmission of a periodic or semi-persistent CSI report via a PUCCH may be configured in parameter pucch-CSI-ResourceList as shown in [Table 31]. Parameter pucch-CSI-ResourceList may include a list of PUCCH resources specific to each BWP fora cell or CC in which a corresponding CS report is to be transmitted. The PUCCH resource may be a resource belonging to PUCCH format 2, PUCCH format 3, or PUCCH format 4. For the PUCCH resource, a transmission period and an offset may be configured via reportSlotConfig of [Table 31].

TABLE 31

```
CSI-ReportConfig ::= SEQUENCE {
    reportConfigId CSI-ReportConfigId,
    carrier ServCellIndex OPTIONAL,
-- Need S
    ...
    reportConfigType CHOICE {
        periodic SEQUENCE {
            reportSlotConfig CSI-ReportPeriodicityAndOffset,
            pucch-CSI-ResourceList SEQUENCE (SIZE (1..maxNrofBWPs)) OF
PUCCH-CSI-Resource
        },
        semiPersistentOnPUCCH SEQUENCE {
            reportSlotConfig CSI-ReportPeriodicityAndOffset,
            pucch-CSI-ResourceList SEQUENCE (SIZE (1..maxNrofBWPs)) OF
PUCCH-CSI-Resource
        },
        semiPersistentOnPUSCH SEQUENCE {
            reportSlotConfig ENUMERATED {sl5, sl10, sl20, sl40, sl80,
sl160, sl320},
            reportSlotOffsetList SEQUENCE (SIZE (1..maxNrofUL-Allocations))
OF INTEGER(0.32),
            p0alpha P0-PUSCH-AlphaSetId
        }
        aperiodic SEQUENCE {
            reportSlotOffsetList SEQUENCE (SIZE (1..maxNrofUL-Allocations))
OF INTEGER(0..32)
        }
    },
    ...
}
```

For HARQ-ACK transmission, a resource set of PUCCH resources for transmission may be first selected according to a payload of UCI including corresponding HARQ-ACK. For example, a PUCCH resource set having a minimum payload that is not smaller than the UCI payload may be selected. Next, a PUCCH resource in the PUCCH resource set may be selected via a PUCCH resource indicator (PRI) in DCI for scheduling of a TB corresponding to the HARQ-ACK, and the PRI may be the PUCCH resource indicator specified in [Table 6] or [Table 7]. A relationship between the PRI and the PUCCH resource selected from the PUCCH resource set may be as shown in [Table 32].

TABLE 32

| PUCCH resource indicator | PUCCH resource |
|---|---|
| ‘000’ | 1^{st} PUCCH resource provided by |
| | pucch-ResourceID obtained from the |
| | 1^{st} value of resourceList |
| ‘001’ | 2^{nd} PUCCH resource provided by |
| | pucch-ResourceID obtained from the |
| | 2^{nd} value of resourceList |
| ‘010’ | 3^{rd} PUCCH resource provided by |
| | pucch-ResourceID obtained from the |
| | 3^{rd} value of resourceList |
| ‘011’ | 4^{th} PUCCH resource provided by |
| | pucch-ResourceID obtained from the |
| | 4^{th} value of resourceList |
| ‘100’ | 5^{th} PUCCH resource provided by |
| | pucch-ResourceID obtained from the |
| | 5^{th} value of resourceList |
| ‘101’ | 6^{th} PUCCH resource provided by |
| | pucch-ResourceID obtained from the |
| | 6^{th} value of resourceList |
| ‘110’ | 7^{th} PUCCH resource provided by |
| | pucch-ResourceID obtained from the |
| | 7^{th} value of resourceList |
| ‘111’ | 8^{th} PUCCH resource provided by |
| | pucch-ResourceID obtained from the |
| | 8^{th} value of resourceList |

If the number of selected PUCCH resources in the PUCCH resource set is greater than 8, the PUCCH resources may be selected by the equation below.

$${r}_{PUCCH} = \qquad [ Equation 3 ]$$

$$\{ \begin{matrix}⌊ \frac{{n}_{CCE , p} \cdot ⌈ {R}_{PUCCH / 8} ⌉}{{N}_{CCE , p}} ⌋ + {Δ}_{PRI} \cdot ⌈ \frac{{R}_{PUCCH}}{8} ⌉ & if {Δ}_{PRI} < {R}_{PUCCH} mod 8 \\ \begin{matrix}⌊ \frac{{n}_{CCE , p} \cdot ⌊ {R}_{PUCCH} / 8 ⌋}{{N}_{CCE , p}} ⌋ + {Δ}_{PRI} \cdot ⌊ \frac{{R}_{PUCCH}}{8} ⌋ + \\ {R}_{PUCCH} mod 8\end{matrix} & if {Δ}_{PRI} \geq {R}_{PUCCH} mod 8\end{matrix} \}$$

In [Equation 3], r_{PUCCH} denotes an index of a selected PUCCH resource in the PUCCH resource set. R_{PUCCH} denotes the number of PUCCH resources belonging to the PUCCH resource set. Δ_{PRI} denotes a PRI value, N_{CCE,p} denotes the total number of CCEs of CORESET p to which received DCI belongs, and n_{CCE,p} denotes a first CCE index for the received DCI.

A point in time at which a corresponding PUCCH resource is transmitted may be after K₁ slots from TB transmission which corresponds to corresponding HARQ-ACK. A candidate of value K₁ is configured via a higher layer, and more specifically, may be configured in parameter dl-DataToUL-ACK in PUCCH-Config specified in [Table 27]. One K₁ value among the candidates may be selected by a PDSCH-to-HARQ feedback timing indicator in the DCI for scheduling of the TB, and this value may be a value specified in [Table 5] or [Table 6]. A unit of the K₁ value may be units of slots or units of subslots. Here, a subslot is a unit of a length smaller than that of a slot, and one or multiple symbols may constitute one subslot.

Hereinafter, a case where two or more PUCCH resources are located in one slot will be described. The UE may transmit UCI via one or two PUCCH resources in one slot or subslot. When the UCI is transmitted via two PUCCH resources in one slot/subslot, i) the respective PUCCH resources may not overlap in units of symbols, and ii) at least one PUCCH resource may be a short PUCCH. The UE may not expect to transmit multiple PUCCH resources for HARQ-ACK transmission in one slot.

### [PUCCH: Relating to Transmission Beam]

Hereinafter, an uplink transmission beam configuration to be used for PUCCH transmission will be described. When the UE does not have a UE-specific configuration for a PUCCH resource configuration (dedicated PUCCH resource configuration), the PUCCH resource set may be provided via pucch-ResourceCommon that is higher-layer signaling. A beam configuration for PUCCH transmission may conform to a beam configuration used for PUSCH transmission scheduled via a random-access response (RAR) UL grant. If the UE has a UE-specific configuration for a PUCCH resource configuration (dedicated PUCCH resource configuration), the beam configuration for PUCCH transmission may be provided via pucch-spatialRelationInfoId that is higher signaling included in [Table 27]. When the UE is configured with one pucch-spatialRelationInfoId, the beam configuration for PUCCH transmission of the UE may be provided via one pucch-spatialRelationInfoId. When the UE is configured with multiple pucch-spatialRelationInfoIDs, the UE may be indicated to activate one of the multiple pucch-spatialRelationInfoIDs via a MAC control element (CE). The UE may be configured with up to eight pucch-spatialRelationInfoIDs via higher signaling, and may be indicated to activate only one pucch-spatialRelationInfoID thereof. When the UE is indicated to activate any pucch-spatialRelationInfoID via the MAC CE, the UE may apply pucch-spatialRelationInfoID activation via the MAC CE from a slot that appears first after 3Nₛₗₒₜ^{subframe,μ} slots from a slot for HARQ-ACK transmission with respect to a PDSCH for transmission of the MAC CE including activation information of pucch-spatialRelationInfoID. μ is neurology applied to PUCCH transmission, and Nₛₗₒₜ^{subframe,μ} may refer to the number of slots per subframe in the given neurology. A higher-layer configuration for pucch-spatialRelationInfo may be as shown in [Table 33].

TABLE 33

```
PUCCH-SpatialRelationInfo ::= SEQUENCE {
    pucch-SpatialRelationInfoId PUCCH-SpatialRelationInfoId,
    servingCellId ServCellIndex
OPTIONAL, -- Need S
    referenceSignal CHOICE {
        ssb-Index SSB-Index,
        csi-RS-Index NZP-CSI-RS-ResourceId,
        srs PUCCH-SRS
    },
    pucch-PathlossReferenceRS-Id PUCCH-PathlossReferenceRS-Id,
    p0-PUCCH-Id P0-PUCCH-Id,
    closedLoopIndex ENUMERATED { i0, i1 }
}
PUCCH-SpatialRelationInfoId ::= INTEGER (1..maxNrofSpatialRelationInfos)
```

According [Table 33], one referenceSignal configuration may exist in a specific pucch-spatialRelationInfo configuration. The referenceSignal may be ssb-Index indicating a specific SS/PBCH, may be csi-RS-Index indicating a specific CSI-RS, or may be srs indicating a specific SRS. When referenceSignal is configured as ssb-Index, the UE may configure as a beam for PUCCH transmission, a beam used for receiving an SS/PBCH corresponding to ssb_Index among SSs/PBCHs in the same serving cell. When servingCellId is provided, the UE may configure, as a beam for PUCCH transmission, a beam used for receiving an SS/PBCH corresponding to ssb_Index among SSs/PBCHs in a cell indicated by servingCellId. When referenceSignal is configured as csi-RS-Index, the UE may configure, as a beam for PUCCH transmission, a beam used for receiving a CSI-RS corresponding to csi-RS-Index among CSI-RSs in the same serving cell. If servingCellId is provided, the UE may configure, as a beam for PUCCH transmission, a beam used for receiving a CSI-RS corresponding to csi-RS-Index among CSI-RSs in a cell indicated by servingCellId. If referenceSignal is configured as srs, the UE may configure, as a beam for PUCCH transmission, a transmission beam used when transmitting an SRS corresponding to a resource index provided via a higher signaling resource in the same serving cell and/or an activated uplink BWP. If servingCellID and/or uplinkBWP are/is provided, the UE may configure, as a beam for PUCCH transmission, a transmission beam used when transmitting an SRS corresponding to a resource index provided via a higher signaling resource in an uplink BWP and/or a cell indicated by servingCellID and/or uplinkBWP. One pucch-PathlossReferenceRS-Id configuration may exist in a specific pucch-spatialRelationInfo configuration. PUCCH-PathlossReferenceRS of [Table 34] may be mapped with pucch-PathlossReferenceRS-Id of [Table 33], and up to 4 configurations are possible via pathlossReferenceRSs in higher signaling of PUCCH-PowerControl of [Table 34]. PUCCH-PathlossReferenceRS may be configured with ssb-Index if connected to the SS/PBCH via higher signaling of referenceSignal, and may be configured with csi-RS-Index if connected to the CSI-RS.

TABLE 34

```
PUCCH-PowerControl ::= SEQUENCE {
    deltaF-PUCCH-f0 INTEGER (−16..15)
OPTIONAL, -- Need R
    deltaF-PUCCH-f1 INTEGER (−16..15)
OPTIONAL, -- Need R
    deltaF-PUCCH-f2 INTEGER (−16.15)
OPTIONAL, -- Need R
    deltaF-PUCCH-f3 INTEGER (−16..15)
OPTIONAL, -- Need R
    deltaF-PUCCH-f4 INTEGER (−16..15)
OPTIONAL, -- Need R
    p0-Set SEQUENCE (SIZE (1..maxNrofPUCCH-P0-PerSet)) OF
P0-PUCCH OPTIONAL, -- Need M
    pathlossReferenceRSs SEQUENCE (SIZE (1..maxNrofPUCCH-
PathlossReferenceRSs)) OF PUCCH-PathlossReferenceRS
OPTIONAL, -- Need M
    twoPUCCH-PC-AdjustmentStates ENUMERATED {twoStates}
OPTIONAL, -- Need S
    ...,
    [[
    pathlossReferenceRSs-v1610 SetupRelease { PathlossReferenceRSs-v1610 }
OPTIONAL -- Need M
    ]]
}
P0-PUCCH ::= SEQUENCE {
    p0-PUCCH-Id P0-PUCCH-Id,
    p0-PUCCH-Value INTEGER (−16..15)
}
P0-PUCCH-Id ::= INTEGER (1..8)
PathlossReferenceRSs-v1610 ::= SEQUENCE (SIZE (1..maxNrofPUCCH-
PathlossReferenceRSsDiff-r16)) OF PUCCH-PathlossReferenceRS-r16
PUCCH-PathlossReferenceRS ::= SEQUENCE {
    pucch-PathlossReferenceRS-Id PUCCH-PathlossReferenceRS-Id,
    referenceSignal CHOICE {
        ssb-Index SSB-Index,
        csi-RS-Index NZP-CSI-RS-ResourceId
    }
}
PUCCH-PathlossReferenceRS-r16 ::= SEQUENCE {
    pucch-PathlossReferenceRS-Id-r16 PUCCH-PathlossReferenceRS-Id-v1610,
    referenceSignal-r16 CHOICE {
        ssb-Index-r16 SSB-Index,
        csi-RS-Index-r16 NZP-CSI-RS-ResourceId
    }
}
```

### [PUCCH: Group-Based Spatial Relation Activation]

In Rel-15, when multiple pucch-spatialRelationInfoIDs are configured, the UE may receive a MAC CE for activation of a spatial relation for each PUCCH resource, thereby determining a spatial relation of a corresponding PUCCH resource. However, such a method has a disadvantage of requiring a lot of signaling overheads to activate spatial relations of multiple PUCCH resources. Therefore, in Rel-16, a new MAC CE for adding a PUCCH resource group and activating a spatial relation in units of PUCCH resource groups has been introduced. The PUCCH resource group may configure up to four PUCCH resource groups via resourceGroupToAddModList in [Table 27]. For each PUCCH resource group, multiple PUCCH resource IDs in one PUCCH resource group may be configured as a list, as shown in Table 35 below.

TABLE 35

```
PUCCH-ResourceGroup-r16 ::= SEQUENCE {
    pucch-ResourceGroupId-r16 PUCCH-ResourceGroupId-r16,
    resourcePerGroupList-r16 SEQUENCE (SIZE (1..maxNrofPUCCH-
ResourcesPerGroup-r16)) OF PUCCH-ResourceId
}
PUCCH-ResourceGroupId-r16 ::= INTEGER (0. maxNrofPUCCH-ResourceGroups-1-
r16)
```

In Rel-16, the base station may configure each PUCCH resource group for the UE via resourceGroupToAddModList in [Table 27] and the higher-layer configuration of [Table 35], and may configure a MAC CE for simultaneous activation of spatial relations of all PUCCH resources in one PUCCH resource group.

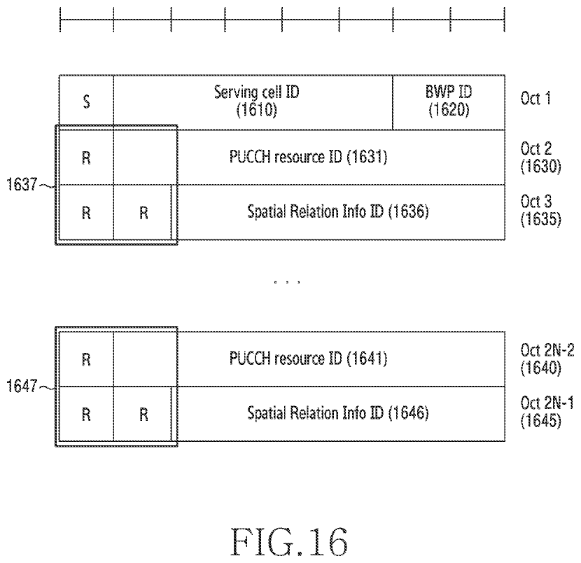

FIG. 16 illustrates an example of a MAC CE for PUCCH resource group-based spatial relation activation in the wireless communication system according to an embodiment of the disclosure.

Referring to FIG. 16, a supported cell ID 1610 and a bandwidth part ID 1620 configured with PUCCH resources, to which a corresponding MAC CE is to be applied, may be indicated by Oct 1600. PUCCH resource IDs 1631 and 1641 may indicate IDs of the PUCCH resources. If the indicated PUCCH resources are included in a PUCCH resource group according to resourceGroupToAddModList, different PUCCH resource IDs in the same PUCCH resource group are not indicated in the same MAC CE, and all PUCCH resources in the same PUCCH resource group may be activated with the same spatial relation info IDs 1636 and 1646. In this case, the spatial relation info IDs 1636 and 1646 may include a value corresponding to PUCCH-SpatialRelationInfoId−1 to be applied to the PUCCH resource group of [Table 33].

### [Regarding SRS]

Hereinafter, an uplink channel estimation method using sounding reference signal (SRS) transmission of a UE will be described. The base station may configure at least one SRS configuration with regard to each uplink BWP in order to transfer configuration information for SRS transmission to the UE. The base station may configure as least one SRS resource set with regard to each SRS configuration. According to an embodiment, the base station and the UE may exchange upper signaling information as follows, in order to transfer information regarding the SRS resource set.
srs-ResourceSetId: SRS resource set index
srs-ResourceIdList: a set of SRS resource indices referred to by SRS resource sets
resourceType: time domain transmission configuration of SRS resources referred to by SRS resource sets, and may be configured as one of “periodic”, “semi-persistent”, and “aperiodic”. If configured as “periodic” or “semi-persistent”, associated CSI-RS information may be provided according to the place of use of SRS resource sets. If configured as “aperiodic”, an aperiodic SRS resource trigger list/slot offset information may be provided, and associated CSI-RS information may be provided according to the place of use of SRS resource sets.
usage: a configuration regarding the place of use of SRS resources referred to by SRS resource sets, and may be configured as one of “beamManagement”, “codebook”, “nonCodebook”, and “antennaSwitching”.
alpha, p0, pathlossReferenceRS, srs-PowerControlAdjustmentStates: provides a parameter configuration for adjusting the transmission power of SRS resources referred to by SRS resource sets.

The UE may understand that an SRS resource included in a set of SRS resource indices referred to by an SRS resource set follows the information configured for the SRS resource set.

The base station and the UE may transmit/receive upper layer signaling information in order to transfer individual configuration information regarding SRS resources. According to an embodiment, the individual configuration information regarding SRS resources may include time-frequency domain mapping information inside slots of the SRS resources. The individual configuration information regarding SRS resources may include information regarding intra-slot or inter-slot frequency hopping of the SRS resources. The individual configuration information regarding SRS resources may include time domain transmission configuration of SRS resources, and may be configured as one of “periodic”, “semi-persistent”, and “aperiodic”. The individual configuration information regarding SRS resources may be limited to have the same time domain transmission configuration as the SRS resource set including the SRS resources. If the time domain transmission configuration of SRS resources is configured as “periodic” or “semi-persistent”, the time domain transmission configuration may further include an SRS resource transmission cycle and a slot offset (for example, periodicityAndOffset).

The base station may activate or deactivate SRS transmission by the UE through upper layer signaling including RRC signaling or MAC CE signaling, or L1 signaling (for example, DCI). For example, the base station may activate or deactivate periodic SRS transmission by the UE through upper layer signaling. The base station may indicate activation of an SRS resource set having resourceType configured as “periodic” through upper layer signaling. The UE may transmit the SRS resource referred to by the activated SRS resource set. Intra-slot time-frequency domain resource mapping of the transmitted SRS resource follows resource mapping information configured for the SRS resource. Slot mapping, including the transmission cycle and slot offset, follows periodicityAndOffset configured for the SRS resource. The spatial domain transmission filter applied to the transmitted SRS resource may refer to spatial relation info configured for the SRS resource, or may refer to associated CSI-RS configured for the SRS resource set including the SRS resource. The UE may transmit the SRS resource inside the uplink BWP activated with regard to the periodic SRS resource activated through upper layer signaling.

The base station may activate or deactivate semi-persistent SRS transmission by the UE through upper layer signaling. The base station may indicate activation of an SRS resource set through MAC CE signaling. The UE may transmit the SRS resource referred to by the activated SRS resource set. The SRS resource set activated through MAC CE signaling may be limited to an SRS resource set having resourceType configured as “semi-persistent”. Intra-slot time-frequency domain resource mapping of the transmitted SRS resource may follow resource mapping information configured for the SRS resource. Slot mapping, including the transmission cycle and slot offset, follows periodicityAndOffset configured for the SRS resource. The spatial domain transmission filter applied to the transmitted SRS resource may refer to spatial relation info configured for the SRS resource, or may refer to associated CSI-RS configured for the SRS resource set including the SRS resource. If the SRS resource has spatial relation info configured therefor, the spatial domain transmission filter may be determined, without following the same, by referring to configuration information regarding spatial relation info transferred through MAC CE signaling that activates semi-persistent SRS transmission. The UE may transmit the SRS resource inside the uplink BWP activated with regard to the semi-persistent SRS resource activated through upper layer signaling.

The base station may trigger aperiodic SRS transmission by the UE through DCI. The base station may indicate one of aperiodic SRS triggers (aperiodicSRS-ResourceTrigger) through the SRS request field of DCI. The UE may understand that the SRS resource set including the aperiodic SRS resource trigger indicated through DCI in the aperiodic SRS resource trigger list, among configuration information of the SRS resource set, has been triggered. The UE may transmit the SRS resource referred to by the triggered SRS resource set. Intra-slot time-frequency domain resource mapping of the transmitted SRS resource may follow resource mapping information configured for the SRS resource. Slot mapping of the transmitted SRS resource may be determined by the slot offset between the SRS resource and a PDCCH including DCI, and this may refer to value(s) included in the slot offset set configured for the SRS resource set. Specifically, as the slot offset between the SRS resource and the PDCCH including DCI, a value indicated in the time domain resource assignment field of DCI, among offset value(s) included in the slot offset set configured for the SRS resource set, may be applied. The spatial domain transmission filter applied to the transmitted SRS resource may refer to spatial relation info configured for the SRS resource, or may refer to associated CSI-RS configured for the SRS resource set including the SRS resource. The UE may transmit the SRS resource inside the uplink BWP activated with regard to the aperiodic SRS resource triggered through DCI.

When the base station triggers aperiodic SRS transmission by the UE through DCI, a minimum time interval may be necessary between the transmitted SRS and the PDCCH including the DCI that triggers aperiodic SRS transmission, in order for the UE to transmit the SRS by applying configuration information regarding the SRS resource. The time interval for SRS transmission by the UE may be defined as the number of symbols between the last symbol of the PDCCH including the DCI that triggers aperiodic SRS transmission and the first symbol mapped to the first transmitted SRS resource among transmitted SRS resource(s). The minimum time interval may be determined with reference to the PUSCH preparation procedure time needed by the UE to prepare PUSCH transmission. The minimum time interval may have a different value depending on the place of use of the SRS resource set including the transmitted SRS resource. For example, the minimum time interval may be determined as N2 symbols defined in view of UE processing capability that follows the UE's capability with reference to the UE's PUSCH preparation procedure time. If the place of use of the SRS resource set is configured as “codebook” or “antennaSwitching” in view of the place of use of the SRS resource set including the transmitted SRS resource, the minimum time interval may be determined as N2 symbols, and if the place of use of the SRS resource set is configured as “nonCodebook” or “beamManagement” the minimum time interval may be determined as N2+14 symbols. The UE may transmit an aperiodic SRS if the time interval for aperiodic SRS transmission is larger than or equal to the minimum time interval, and may ignore the DCI that triggers the aperiodic SRS if the time interval for aperiodic SRS transmission is smaller than the minimum time interval.

TABLE 36

```
SRS-Resource ::= SEQUENCE {
    srs-ResourceId SRS-ResourceId,
    nrofSRS-Ports ENUMERATED {port1, ports2, ports4},
    ptrs-PortIndex ENUMERATED {n0, n1 }
OPTIONAL, -- Need R
    transmissionComb CHOICE {
        n2 SEQUENCE {
            combOffset-n2 INTEGER (0..1).
            cyclicShift-n2 INTEGER (0..7)
        },
        n4 SEQUENCE {
            combOffset-n4 INTEGER (0..3),
            cyclicShift-n4 INTEGER (0..11)
        }
    },
    resourceMapping SEQUENCE {
        startPosition INTEGER (0..5),
        nrofSymbols ENUMERATED {n1, n2, n4},
        repetitionFactor ENUMERATED {n1, n2, n4}
    },
    freqDomainPosition INTEGER (0..67),
    freqDomainShift INTEGER (0..268),
    freqHopping SEQUENCE {
        c-SRS INTEGER (0..63),
        b-SRS INTEGER (0..3),
        b-hop INTEGER (0..3)
    },
    groupOrSequenceHopping ENUMERATED { neither, groupHopping,
quenceHopping },
    resourceType CHOICE {
        aperiodic SEQUENCE {
            ...
        },
        semi-persistent SEQUENCE {
            periodicityAndOffset-sp SRS-PeriodicityAndOffset,
            ...
        },
        periodic SEQUENCE {
            periodicityAndOffset-p SRS-PeriodicityAndOffset,
            ...
        }
    },
    sequenceId INTEGER (0..1023),
    spatialRelationInfo SRS-SpatialRelationInfo
OPTIONAL, -- Need R
      ...
}
```

Configuration information spatialRelationInfo in Table 36 above may be applied, with reference to one reference signal, to a beam used for SRS transmission corresponding to beam information of the corresponding reference signal. For example, configuration of spatialRelationInfo may include information as in Table 37 below.

TABLE 37

```
SRS-SpatialRelationInfo ::= SEQUENCE {
    servingCellId ServCellIndex
OPTIONAL, -- Need S
    referenceSignal CHOICE {
          ssb-Index SSB-
Index,
          csi-RS-Index NZP-CSI-RS-
ResourceId,
          srs
SEQUENCE {
                  resourceId
SRS-ResourceId,
                  uplinkBWP
BWP-Id
        }
    }
}
```

Referring to the above-described spatialRelationInfo configuration, an SS/PBCH block index, CSI-RS index, or SRS index may be configured as the index of a reference signal to be referred to in order to use beam information of a specific reference signal. Upper signaling referenceSignal may correspond to configuration information indicating which reference signal's beam information is to be referred to for corresponding SRS transmission. ssb-Index may refer to the index of an SS/PBCH block, csi-RS-Index may refer to the index of a CSI-RS, and srs may refer to the index of an SRS. If upper signaling referenceSignal has a configured value of “ssb-Index”, the UE may apply the reception beam which was used to receive the SS/PBCH block corresponding to ssb-Index as the transmission beam for the corresponding SRS transmission. If upper signaling referenceSignal has a configured value of “csi-RS-Index”, the UE may apply the reception beam which was used to receive the CSI-RS corresponding to csi-RS-Index as the transmission beam for the corresponding SRS transmission. If upper signaling referenceSignal has a configured value of “srs”, the UE may apply the reception beam which was used to transmit the SRS corresponding to srs as the transmission beam for the corresponding SRS transmission.

### [PUSCH: Regarding Transmission Scheme]

Hereinafter, a PUSCH transmission scheduling scheme will be described. PUSCH transmission may be dynamically scheduled by a UL grant inside DCI, or operated by means of configured grant Type 1 or Type 2. Dynamic scheduling indication regarding PUSCH transmission may be made by DCI format 0_0 or 0_1.

Configured grant Type 1 PUSCH transmission may be configured semi-statically by receiving configuredGrantConfig including rrc-ConfiguredUplinkGrant in Table 38 through upper signaling, without receiving a UL grant inside DCI. Configured grant Type 2 PUSCH transmission may be scheduled semi-persistently by a UL grant inside DCI after receiving configuredGrantConfig not including rrc-ConfiguredUplinkGrant in Table 38 through upper signaling. If PUSCH transmission is operated by a configured grant, parameters applied to the PUSCH transmission are applied through configuredGrantConfig (upper signaling) in Table 38 except for dataScramblingIdentityPUSCH, txConfig, codebookSubset, maxRank and scaling of UCI-OnPUSCH, which are provided by pusch-Config (upper signaling) in Table 39. If provided with transformPrecoder inside configuredGrantConfig (upper signaling) in Table 38, the UE applies tp-pi2BPSK inside pusch-Config in Table 39 to PUSCH transmission operated by a configured grant.

```
TABLE 38
ConfiguredGrantConfig ::= SEQUENCE {
    frequencyHopping ENUMERATED {intraSlot, interSlot}
OPTIONAL, -- Need S,
    cg-DMRS-Configuration DMRS-UplinkConfig,
    mcs-Table ENUMERATED {qam256, qam64LowSE}
OPTIONAL, -- Need S
    mcs-TableTransformPrecoder ENUMERATED {qam256, qam64LowSE}
OPTIONAL, --Need S
    uci-OnPUSCH SetupRelease { CG-UCI-OnPUSCH }
OPTIONAL, -- Need M
    resourceAllocation ENUMERATED { resource AllocationType0,
resourceAllocationType1, dynamicSwitch },
    rbg-Size ENUMERATED {config2}
OPTIONAL, -- Need S
    powerControlLoopToUse ENUMERATED {n0, n1},
    p0-PUSCH-Alpha P0-PUSCH-AlphaSetId,
    transformPrecoder ENUMERATED {enabled, disabled}
OPTIONAL, -- Need S
    nrofHARQ-Processes INTEGER(1..16),
    repK ENUMERATED {n1, n2, n4,
n8},
    repK-RV ENUMERATED {s1-0231, s2-
0303, s3-0000} OPTIONAL, -- Need R
    periodicity ENUMERATED {
                                                              sym2, sym7, sym1x14,
sym2x14, sym4x14, sym5x14, sym8x14, sym10x14, sym16x14, sym20x14,
                                                              sym32x14, sym40x14,
sym64x14, sym80x14, sym128x14, sym160x14, sym256x14, sym320x14, sym512x14,
                                                              sym640x14,
sym1024x14, sym1280x14, sym2560x14, sym5120x14,
                                                              sym6, sym1x12,
sym2x12, sym4x12, sym5x12, sym8x12, sym10x12, sym16x12, sym20x12, sym32x12,
                                                              sym40x12, sym1x12,
sym80x12, sym128x12, sym160x12, sym256x12, sym320x12, sym512x12, sym640x12,
                                                              sym1280x12, sym2560x12
    }
    configuredGrantTimer INTEGER (1..64)
OPTIONAL, -- Need R
    rrc-ConfiguredUplinkGrant SEQUENCE {
        timeDomainOffset INTEGER (0..5119),
        timeDomainAllocation INTEGER (0..15),
        frequencyDomainAllocation BIT STRING (SIZE(18)),
        antennaPort INTEGER (0..31),
        dmrs-SegInitialization INTEGER (0..1)
OPTIONAL, -- Need R
    precodingAndNumberOfLayers INTEGER (0..63),
    srs-ResourceIndicator INTEGER (0..15)
OPTIONAL, -- Need R
    mcsAndTBS INTEGER
(0..31),
        frequencyHoppingOffset INTEGER (1..
maxNrofPhysicalResourceBlocks-1) OPTIONAL, -- Need R
        pathlossReferenceIndex INTEGER
(0..maxNrofPUSCH-PathlossReferenceRSs-1),
        ...
    }
OPTIONAL, -- Need R
    ...
}
```

Hereinafter, a PUSCH transmission method will be described. The DMRS antenna port for PUSCH transmission is identical to an antenna port for SRS transmission. PUSCH transmission may follow a codebook-based transmission method and a non-codebook-based transmission method according to whether the value of txConfig inside pusch-Config in Table 39, which is upper signaling, is “codebook” or “nonCodebook”.

As described above, PUSCH transmission may be dynamically scheduled through DCI format 0_0 or 0_1, and may be operated semi-statically configured by a configured grant. Upon receiving indication of scheduling regarding PUSCH transmission through DCI format 0_0, the UE may perform beam configuration for PUSCH transmission by using pucch-spatialRelationInfoID corresponding to a UE-specific PUCCH resource corresponding to the minimum ID inside an activated uplink BWP inside a serving cell. The PUSCH transmission is based on a single antenna port. The UE may not expect scheduling regarding PUSCH transmission through DCI format 0_0 inside a BWP having no configured PUCCH resource including pucch-spatialRelationInfo. If the UE has no configured txConfig inside pusch-Config in Table 39, the UE may not expect scheduling through DCI format 0_1.

TABLE 39

```
PUSCH-Config ::= SEQUENCE {
    dataScramblingIdentityPUSCH INTEGER (0..1023)
OPTIONAL, -- Need S
    txConfig ENUMERATED
{codebook, nonCodebook} OPTIONAL, --Need S
    dmrs-UplinkForPUSCH-MappingTypeA SetupRelease { DMRS-UplinkConfig }
OPTIONAL, -- Need M
    dmrs-UplinkForPUSCH-MappingTypeB SetupRelease { DMRS-UplinkConfig }
OPTIONAL, -- Need M
    pusch-PowerControl PUSCH-PowerControl
OPTIONAL, -- Need M
    frequencyHopping ENUMERATED {intraSlot,
interSlot} OPTIONAL, -- Need S
    frequencyHoppingOffsetLists SEQUENCE (SIZE (1..4)) OF INTEGER
(1..maxNrofPhysicalResourceBlocks-1)
OPTIONAL, -- Need M
    resourceAllocation ENUMERATED
{ resourceAllocationType0, resourceAllocationType1, dynamicSwitch},
    pusch-TimeDomainAllocationList SetupRelease { PUSCH-
TimeDomainResourceAllocationList } OPTIONAL, -- Need M
    pusch-AggregationFactor ENUMERATED { n2, n4, n8 }
OPTIONAL, -- Need S
    mcs-Table ENUMERATED {qam256,
qam64LowSE} OPTIONAL, --Need S
    mcs-TableTransformPrecoder ENUMERATED {qam256, qam64LowSE}
OPTIONAL, -- Need S
    transformPrecoder ENUMERATED {enabled,
disabled} OPTIONAL, -- Need S
    codebookSubset ENUMERATED
{fullyAndPartialAndNonCoherent, partialAndNonCoherent,nonCoherent}
OPTIONAL, -- Cond codebookBased
    maxRank INTEGER (1..4)
OPTIONAL, -- Cond codebookBased
    rbg-Size ENUMERATED
{ config2} OPTIONAL, -- Need S
    uci-OnPUSCH SetupRelease { UCI-
OnPUSCH} OPTIONAL, -- Need M
    tp-pi2BPSK ENUMERATED {enabled}
OPTIONAL, -- Need S
    ...
}
```

Hereinafter, codebook-based PUSCH transmission will be described. The codebook-based PUSCH transmission may be dynamically scheduled through DCI format 0_0 or 0_1, and may be operated semi-statically by a configured grant. If a codebook-based PUSCH is dynamically scheduled through DCI format 0_1 or configured semi-statically by a configured grant, the UE may determine a precoder for PUSCH transmission, based on an SRS resource indicator (SRI), a transmission precoding matrix indicator (TPMI), and a transmission rank (the number of PUSCH transmission layers).

The SRI may be given through the SRS resource indicator (a field inside DCI) or configured through srs-ResourceIndicator (upper signaling). During codebook-based PUSCH transmission, the UE has at least one SRS resource configured therefor, and may have a maximum of two SRS resources configured therefor. If the UE is provided with an SRI through DCI, the SRS resource indicated by the SRI may refer to the SRS resource corresponding to the SRI among SRS resources transmitted prior to the PDCCH including the SRI. The TPMI and the transmission rank may be given through “precoding information and number of layers” (a field inside DCI) or configured through precodingAndNumberOfLayers (upper signaling). The TPMI may be used to indicate a precoder applied to PUSCH transmission. If one SRS resource is configured for the UE, the TPMI may be used to indicate a precoder to be applied in the configured SRS resource. If one SRS resource is configured for the UE, the TPMI may be used to indicate a precoder to be applied in the configured SRS resource.

The precoder to be used for PUSCH transmission may be selected from an uplink codebook having the same number of antenna ports as the value of nrofSRS-Ports inside SRS-Config (upper signaling). In connection with codebook-based PUSCH transmission, the UE may determine a codebook subset, based on codebookSubset inside pusch-Config (upper signaling) and TPMI. The codebookSubset inside pusch-Config (upper signaling) may be configured to be one of “fullyAndPartialAndNonCoherent”, “partialAndNonCoherent”, or “noncoherent”, based on UE capability reported by the UE to the base station. If the UE reported “partialAndNonCoherent” as UE capability, the UE may not expect that the value of codebookSubset (upper signaling) will be configured as “fullyAndPartialAndNonCoherent”. If the UE reported “nonCoherent” as UE capability, UE may not expect that the value of codebookSubset (upper signaling) will be configured as “fullyAndPartialAndNonCoherent” or “partialAndNonCoherent”. If nrofSRS-Ports inside SRS-ResourceSet (upper signaling) indicates two SRS antenna ports, the UE does not expect that the value of codebookSubset (upper signaling) will be configured as “partialAndNonCoherent”.

The UE may have one SRS resource set configured therefor, wherein the value of usage inside SRS-ResourceSet (upper signaling) is “codebook”. One SRS resource may be indicated through an SRI inside the corresponding SRS resource set. If multiple SRS resources are configured inside the SRS resource set wherein the value of usage inside SRS-ResourceSet (upper signaling) is “codebook”, the UE may expect that the value of nrofSRS-Ports inside SRS-Resource (upper signaling) is identical with regard to all SRS resources.

The UE may transmit, to the base station, one or multiple SRS resources included in the SRS resource set wherein the value of usage is configured as “codebook” according to upper signaling. The base station may select one from the SRS resources transmitted by the UE and indicate the UE to be able to transmit a PUSCH by using transmission beam information of the corresponding SRS resource. In connection with the codebook-based PUSCH transmission, the SRI may be used as information for selecting the index of one SRS resource, and may be included in DCI. Additionally, the base station may add information indicating the rank and TPMI to be used by the UE for PUSCH transmission to the DCI. Using the SRS resource indicated by the SRI, the UE may apply, in performing PUSCH transmission, the precoder indicated by the rank and TPMI indicated based on the transmission beam of the corresponding SRS resource, thereby performing PUSCH transmission.

Hereinafter, non-codebook-based PUSCH transmission will be described. The non-codebook-based PUSCH transmission may be dynamically scheduled through DCI format 0_0 or 0_1, and may be operated semi-statically configured by a configured grant. If at least one SRS resource is configured inside an SRS resource set wherein the value of usage inside SRS-ResourceSet (upper signaling) is “nonCodebook”, non-codebook-based PUSCH transmission may be scheduled for the UE through DCI format 0_1.

With regard to the SRS resource set wherein the value of usage inside SRS-ResourceSet (upper signaling) is “nonCodebook”, one connected NZP CSI-RS resource (non-zero power CSI-RS) may be configured for the UE. The UE may calculate a precoder for SRS transmission by measuring the NZP CSI-RS resource connected to the SRS resource set. If the difference between the last received symbol of an aperiodic NZP CSI-RS resource connected to the SRS resource set and the first symbol of aperiodic SRS transmission in the UE is less than 42 symbols, the UE may not expect that information regarding the precoder for SRS transmission will be updated.

If the configured value of resourceType inside SRS-ResourceSet (upper signaling) is “aperiodic”, the connected NZP CSI-RS may be indicated by an SRS request which is a field inside DCI format 0_1 or 1_1. If the connected NZP CSI-RS resource is an aperiodic NZP CSI-RS resource, the existence of the connected NZP CSI-RS may be indicated with regard to the case in which the value of SRS request (a field inside DCI format 0_1 or 1_1) is not “00”. The corresponding DCI may not indicate cross carrier or cross BWP scheduling. If the value of SRS request indicates the existence of a NZP CSI-RS, the NZP CSI-RS may be positioned in the slot used to transmit the PDCCH including the SRS request field. In this case, TCI states configured for the scheduled subcarrier may not be configured as QCL-TypeD.

If there is a periodic or semi-persistent SRS resource set configured, the connected NZP CSI-RS may be indicated through associatedCSI-RS inside SRS-ResourceSet (upper signaling). With regard to non-codebook-based transmission, the UE may not expect that spatialRelationInfo which is upper signaling regarding the SRS resource and associatedCSI-RS inside SRS-ResourceSet (upper signaling) will be configured together.

If multiple SRS resources are configured for the UE, the UE may determine a precoder to be applied to PUSCH transmission and the transmission rank, based on an SRI indicated by the base station. The SRI may be indicated through the SRS resource indicator (a field inside DCI) or configured through srs-ResourceIndicator (upper signaling). Similarly to the above-described codebook-based PUSCH transmission, if the UE is provided with the SRI through DCI, the SRS resource indicated by the corresponding SRI may refer to the SRS resource corresponding to the SRI, among SRS resources transmitted prior to the PDCCH including the corresponding SRI. The UE may use one or multiple SRS resources for SRS transmission. The maximum number of SRS resources that can be transmitted simultaneously in the same symbol inside one SRS resource set and the maximum number of SRS resources may be determined by UE capability reported to the base station by the UE. SRS resources simultaneously transmitted by the UE may occupy the same RB. The UE may configure one SRS port for each SRS resource. There may be only one configured SRS resource set wherein the value of usage inside SRS-ResourceSet (upper signaling) is “nonCodebook”, and a maximum of four SRS resources may be configured for non-codebook-based PUSCH transmission.

The base station may transmit one NZP-CSI-RS connected to the SRS resource set to the UE. The UE may calculate the precoder to be used when transmitting one or multiple SRS resources inside the corresponding SRS resource set, based on the result of measurement when the corresponding NZP-CSI-RS is received. The UE may apply the calculated precoder when transmitting, to the base station, one or multiple SRS resources inside the SRS resource set wherein the configured usage is “nonCodebook”. The base station may select one or multiple SRS resources from the received one or multiple SRS resources. In connection with the non-codebook-based PUSCH transmission, the SRI may indicate an index that may express one SRS resource or a combination of multiple SRS resources. The SRI may be included in DCI. The number of SRS resources indicated by the SRI transmitted by the base station may be the number of transmission layers of the PUSCH. The UE may transmit the PUSCH by applying the precoder applied to SRS resource transmission to each layer.

### [PUSCH: Preparation Procedure Time]

Hereinafter, a PUSCH preparation procedure time will be described. If a base station schedules a UE so as to transmit a PUSCH by using DCI format 0_0, 0_1, or 0_2, the UE may require a PUSCH preparation procedure time such that a PUSCH is transmitted by applying a transmission method (SRS resource transmission precoding method, the number of transmission layers, spatial domain transmission filter) indicated through DCI. The PUSCH preparation procedure time is defined in NR in consideration thereof. The PUSCH preparation procedure time of the UE may follow Equation 4 given below.

$${T}_{proc , 2} = max ( ( {N}_{2} + {d}_{2 , 1} + {d}_{2} ) ( 2048 + 144 ) κ {2}^{- μ} {T}_{c} + {T}_{ext} + {T}_{switch} , {d}_{2 , 2} ) \qquad [ Equation 4 ]$$

Each parameter in T_{proc,2} described above in Equation 4 may have the following meaning.
N₂: the number of symbols determined according to UE processing capability 1 or 2, based on the UE's capability, and numerology μ. N₂ may have a value in Table 40 if UE processing capability 1 is reported according to the UE's capability report, and may have a value in Table 41 if UE processing capability 2 is reported, and if availability of UF processing capability 2 is configured through upper layer signaling.

TABLE 40

| μ | PUSCH preparation time N₂ [symbols] |
|---|---|
| 0 | 10 |
| 1 | 12 |
| 2 | 23 |
| 3 | 36 |

TABLE 41

| μ | PUSCH preparation time N₂ [symbols] |
|---|---|
| 0 | 5 |
| 1 | 5.5 |
| 2 | 11 for frequency range 1 |

d_{2,1}: the number of symbols determined to be 0 if all resource elements of the first OFDM symbol of PUSCH transmission include DM-RSs, and to be 1 otherwise.
κ: 64
μ: follows a value, among μ_{DL} and μ_{UL}, which makes T_{proc,2} larger. μ_{DL} refers to the numerology of a downlink used to transmit a PDCCH including DCI that schedules a PUSCH, and μ_{UL} refers to the numerology of an uplink used to transmit a PUSCH.
T_{c}: has 1/(Δfₘₐₓ·N_{f}), Δfₘₐₓ=480·10³ Hz, N_{f}=4096.
d_{2,2}: follows a BWP switching time if DCI that schedules a PUSCH indicates BWP switching, and has 0 otherwise.
d₂: if OFDM symbols overlap temporally between a PUSCH having a high priority index and a PUCCH having a low priority index, the d₂ value of the PUSCH having a high priority index is used. Otherwise, d₂ is 0.
Tₑₓₜ: if the UE uses a shared spectrum channel access scheme, the UE may calculate Tₑₓₜ and apply the same to a PUSCH preparation procedure time. Otherwise, Tₑₓₜ is assumed to be 0.
T_{switch}: if an uplink switching spacing has been triggered, T_{switch} is assumed to be the switching spacing time. Otherwise, T_{switch} is assumed to be 0.

The base station and the UE may determine that the PUSCH preparation procedure time is insufficient if the first symbol of a PUSCH starts earlier than the first uplink symbol in which a CP starts after Tproc,2 from the last symbol of a PDCCH including DCI that schedules the PUSCH, in view of the influence of timing advance between the uplink and the downlink and time domain resource mapping information of the PUSCH scheduled through the DCI. Otherwise, the base station and the UE may determine that the PUSCH preparation procedure time is sufficient. The UE may transmit the PUSCH only if the PUSCH preparation procedure time is sufficient. The UE may ignore the DCI that schedules the PUSCH if the PUSCH preparation procedure time is insufficient.

### [PUSCH: Regarding Repeated Transmission]

Hereinafter, repeated transmission of an uplink data channel in a 5G system will be described in detail. A 5G system may support two types of methods for repeatedly transmitting an uplink data channel, PUSCH repeated transmission type A and PUSCH repeated transmission type B. One of PUSCH repeated transmission type A and type B may be configured for a UE through upper layer signaling.

### PUSCH Repeated Transmission Type A

As described above, the symbol length of an uplink data channel and the location of the start symbol may be determined by a time domain resource allocation method in one slot, and a base station may notify, a UE of the number of repeated transmissions through upper layer signaling (for example, RRC signaling) or L1 signaling (for example, DCI).

Based on the number of repeated transmissions received from the base station, the UE may repeatedly transmit an uplink data channel having the same length and start symbol as the configured uplink data channel, in a continuous slot. If the base station configured a slot as a downlink for the UE, or if at least one of symbols of the uplink data channel configured for the UE is configured as a downlink, the UE may omit uplink data channel transmission, but may count the number of repeated transmissions of the uplink data channel.

### PUSCH Repeated Transmission Type B

As described above, the symbol length of an uplink data channel and the location of the start symbol may be determined by a time domain resource allocation method in one slot, and a base station may notify a UE of the number of repeated transmissions through upper layer signaling (for example, RRC signaling) or L1 signaling (for example, DCI).

The nominal repetition of the uplink data channel may be determined as follows, based on the previously configured start symbol and length of the uplink data channel. The slot in which the n^{th} nominal repetition starts is given by

$${K}_{s} + ⌊ \frac{S + n \cdot L}{{N}_{symb}^{slot}} ⌋ ,$$

and the symbol starting in that slot is given by mod(S+n·L, N_{symb}^{slot}). The slot in which the n^{th} nominal repetition ends is given by

$${K}_{s} + ⌊ \frac{S + ( n + 1 ) \cdot L - 1}{{N}_{symb}^{slot}} ⌋ ,$$

and the symbol ending in that slot is given by mod(S+(n+1)·L−1, N_{symb}^{slot}). In this regard, n=0, . . . , numberofrepetitions−1, S may refer to the start symbol of the configured uplink data channel, and L may refer to the symbol length of the configured uplink data channel. In this regard, n=0, . . . , numberofrepetitions−1, S refers to the start symbol of the configured uplink data channel, and L refers to the symbol length of the configured uplink data channel.

The UE may determine an invalid symbol for PUSCH repeated transmission type B. A symbol configured as a downlink by tdd-UL-DL-ConfigurationCommon or tdd-UL-DL-ConfigurationDedicated may be determined as the invalid symbol for PUSCH repeated transmission type B. Additionally, the invalid symbol may be configured in an upper layer parameter (for example, InvalidSymbolPattern). The upper layer parameter (for example, InvalidSymbolPattern) may provide a symbol level bitmap across one or two slots, thereby configuring the invalid symbol. In the bitmap, 1 may represent the invalid symbol. Additionally, the cycle and pattern of the bitmap may be configured through the upper layer parameter (for example, InvalidSymbolPattern). If an upper laver parameter (for example, InvalidSymbolPattern) is configured, and if parameter InvalidSvmbolPatternIndicator-ForDCIFormat0_1 or InvalidSymbolPatternIndicator-ForDCIFormat0_2 indicates 1, the UE may apply an invalid symbol pattern, and if the above parameter indicates 0, the UE may not apply the invalid symbol pattern. If an upper layer parameter (for example, InvalidSymbolPattern) is configured, and if parameter InvalidSymbolPatternIndicator-ForDCIFormat0_1 or InvalidSymbolPatternIndicator-ForDCIFormat0_2 is not configured, the UE may apply the invalid symbol pattern.

After an invalid symbol is determined, the UE may consider, with regard to each nominal repetition, that symbols other than the invalid symbol are valid symbols. If one or more valid symbols are included in each nominal repetition, the nominal repetition may include one or more actual repetitions. Each actual repetition may include a set of consecutive valid symbols available for PUSCH repeated transmission type B in one slot.

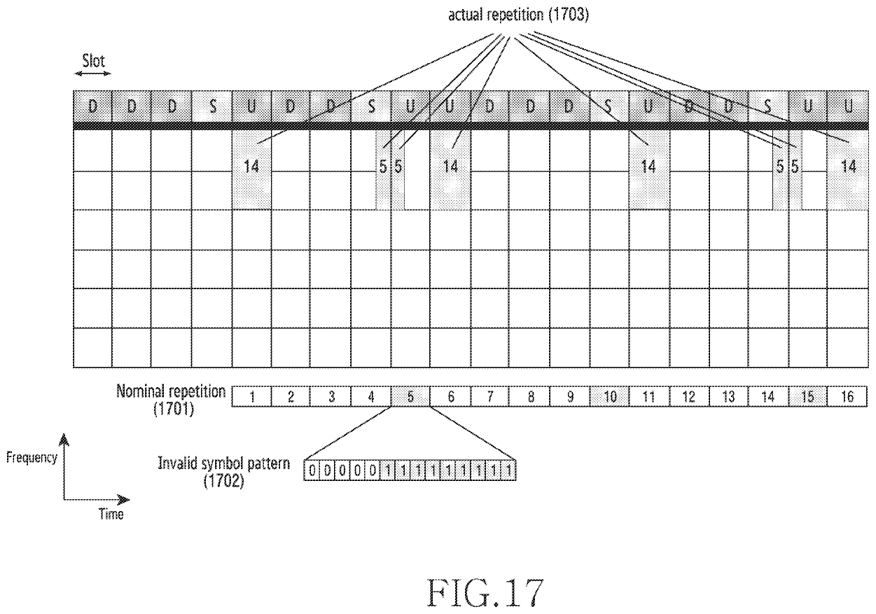

FIG. 17 illustrates an example of PUSCH repeated transmission type B in a wireless communication system according to an embodiment of the disclosure.

Referring to FIG. 17, the UE may receive the following configurations: the start symbol S of an uplink data channel is 0, the length L of the uplink data channel is 14, and the number of repeated transmissions is 16. Referring to FIG. 17, nominal repetitions may appear in 16 consecutive slots (1701). Thereafter, the UE may determine that the symbol configured as a downlink symbol in each nominal repetition 1701 is an invalid symbol. The UE may determine that symbols configured as 1 in the invalid symbol pattern 1702 are invalid symbols. If valid symbols other than invalid symbols in respective nominal repetitions constitute one or more consecutive symbols in one slot, they may be configured and transmitted as actual repetitions (1703).

With regard to PUSCH repeated transmission, additional methods may be defined in NR Release 16 with regard to UL grant-based PUSCH transmission and configured grant-based PUSCH transmission, across slot boundaries, as follows:
Method 1 (mini-slot level repetition): through one UL grant, two or more PUSCH repeated transmissions are scheduled inside one slot or across the boundary of consecutive slots. In connection with method 1, time domain resource allocation information inside DCI may indicate resources of the first repeated transmission. Time domain resource information of remaining repeated transmissions may be determined according to time domain resource information of the first repeated transmission, and the uplink or downlink direction determined with regard to each symbol of each slot. Each repeated transmission may occupy consecutive symbols.
Method 2 (multi-segment transmission): through one UL grant, two or more PUSCH repeated transmissions may be scheduled in consecutive slots. Transmission no. 1 may be designated with regard to each slot, and the start point or repetition length may differ between respective transmission. In method 2, time domain resource allocation information inside DCI may indicate the start point and repetition length of all repeated transmissions. When performing repeated transmissions inside a single slot through method 2, if there are multiple bundles of consecutive uplink symbols in the corresponding slot, respective repeated transmissions may be performed with regard to respective uplink symbol bundles. If there is a single bundle of consecutive uplink symbols in the corresponding slot, PUSCH repeated transmission may be performed once according to the method of NR Release 15.
Method 3: two or more PUSCH repeated transmissions may be scheduled in consecutive slots through two or more UL grants. Transmission no. 1 may be designated with regard to each slot, and the nth UL grant may be received before PUSCH transmission scheduled by the (n−1)th UL grant is over.
Method 4: through one UL grant or one configured grant, one or multiple PUSCH repeated transmissions inside a single slot, or two or more PUSCH repeated transmissions across the boundary of consecutive slots may be supported. The number of repetitions indicated to the UE by the base station is only a nominal value, and the UE may actually perform a larger number of PUSCH repeated transmissions than the nominal number of repetitions. Time domain resource allocation information inside DCI or configured grant may refer to resources of the first repeated transmission indicated by the base station. Time domain resource information of remaining repeated transmissions may be determined with reference to resource information of the first repeated transmission and the uplink or downlink direction of symbols. If time domain resource information of a repeated transmission indicated by the base station spans a slot boundary or includes an uplink/downlink switching point, the corresponding repeated transmission may be divided into multiple repeated transmissions. One repeated transmission may be included in one slot with regard to each uplink period.

### [PUSCH: Frequency Hopping Process]

Hereinafter, frequency hopping of a physical uplink shared channel in a 5G system will be described in detail.

5G may support two kinds of PUSCH frequency hopping methods with regard to each PUSCH repeated transmission type. PUSCH repeated transmission type A may support intra-slot frequency hopping and inter-slot frequency hopping. PUSCH repeated transmission type B may support inter-repetition frequency hopping and inter-slot frequency hopping.

The intra-slot frequency hopping method supported in PUSCH repeated transmission type A may include a method in which a UE transmits allocated resources in the frequency domain, after changing the same by a configured frequency offset, by two hops in one slot. The start RB of each hop in connection with intra-slot frequency hopping may be expressed by Equation 5 below.

$${RB}_{start} = \{ \begin{matrix}{RB}_{start} & i = 0 \\ ( {RB}_{start} + {RB}_{offset} ) mod {N}_{BWP}^{size} & i = 1\end{matrix} \qquad [ Equation 5 ]$$

In Equation 5, i=0 an i=1 may denote the first and second hops, respectively, and RBₛₜₐᵣₜ may denote the start RB in a UL BWP and may be calculated from a frequency resource allocation method. RB_{offset} denotes a frequency offset between two hops through an upper layer parameter. The number of symbols of the first hop may be represented by └N_{symb}^{PUSCH,s}/2┘, and number of symbols of the second hop may be represented by N_{symb}^{PUSCH,s}−└N_{symb}^{PUSCH,s}/2┘. N_{symb}^{PUSCH,s} is the length of PUSCH transmission in one slot and is expressed by the number of OFDM symbols.

The inter-slot frequency hopping method supported in PUSCH repeated transmission types A and B may be a method in which the UE transmits allocated resources in the frequency domain, after changing the same by a configured frequency offset, in each slot. The start RB during nₛ^{μ} slots in connection with inter-slot frequency hopping may be expressed by Equation 6 below.

$${RB}_{start} ( {n}_{s}^{μ} ) = \{ \begin{matrix}{RB}_{start} & {n}_{s}^{μ} mod 2 = 0 \\ ( {RB}_{start} + {RB}_{offset} ) mod {N}_{BWP}^{size} & {n}_{s}^{μ} mod 2 = 1\end{matrix} \qquad [ Equation 6 ]$$

In Equation 6, nₛ^{μ} denotes the current slot number during multi-slot PUSCH transmission, and RBₛₜₐᵣₜ denotes the start RB inside a UL BWP and may be calculated from a frequency resource allocation method. RB_{offset} may denote a frequency offset between two hops through an upper layer parameter.

The inter-repetition frequency hopping method supported in PUSCH repeated transmission type B may be a method in which resources allocated in the frequency domain regarding one or multiple actual repetitions in each nominal repetition are moved by a configured frequency offset and then transmitted. The index RBₛₜₐᵣₜ(n) of the start RB in the frequency domain regarding one or multiple actual repetitions in the nth nominal repetition may follow Equation 7 below.

$${RB}_{start} ( n ) = \{ \begin{matrix}{RB}_{start} & n mod 2 = 0 \\ ( {RB}_{start} + {RB}_{offset} ) mod {N}_{BWP}^{size} & n mod 2 = 1\end{matrix} \qquad [ Equation 7 ]$$

In Equation 7, n denotes the index of nominal repetition, and RB_{offset} denotes an RB offset between two hops through an upper layer parameter.

### [Regarding UE Capability Report]

In LTE and NR, a UE may perform a procedure in which, while being connected to a serving base station, the UE reports capability supported by the UE to the corresponding base station. In the following description, the above-described procedure will be referred to as a UE capability report.

The base station may transfer a UE capability enquiry message to the UE in a connected state so as to request a capability report. The message may include a UE capability request with regard to each radio access technology (RAT) type of the base station. The RAT type-specific request may include supported frequency band combination information and the like. In the case of the UE capability enquiry message, UE capability with regard to multiple RAT types may be requested through one RRC message container transmitted by the base station. The base station may transfer a UE capability enquiry message including multiple UE capability requests with regard to respective RAT types. For example, a capability enquiry may be repeated multiple times in one message, and the UE may configure a UE capability information message corresponding thereto and report the same multiple times. In next-generation mobile communication systems, a UE capability request may be made regarding multi-RAT dual connectivity (MR-DC), such as NR, LTE, E-UTRA-NR dual connectivity (EN-DC). The UE capability enquiry message may be transmitted initially after the UE is connected to the base station, in general, but may be requested in any condition if needed by the base station.

Upon receiving the UE capability report request from the base station in the above step, the UE may configure UE capability according to band information and RAT type requested by the base station. Hereinafter, the method in which the UE configures UE capability in an NR system will be described.
1. If the UE receives a list regarding LTE and/or NR bands from the base station at a UE capability request, the UE may construct band combinations (BCs) regarding EN-DC and NR standalone (SA). For example, the UE may configure a candidate list of BCs regarding EN-DC and NR SA, based on bands received from the base station at a request through FreqBandList. Bands may have priority in the order described in FreqBandList.
2. If the base station has set “eutra-nr-only” flag or “eutra” flag and requested a UE capability report, the UE may remove everything related to NR SA BCs from the configured BC candidate list. The above operation may occur only if an LTE base station (eNB) requests “eutra” capability.
3. The UE may then remove fallback BCs from the BC candidate list configured in the above step. A fallback BC may refer to a BC that can be obtained by removing a band corresponding to at least one SCell from a specific BC. Since a BC before removal of the band corresponding to at least one SCell can already cover a fallback BC, the same can be omitted. The above step may be applied in MR-DC as well. The above step may also be applied to LTE bands. BCs remaining after the above step may constitute the final “candidate BC list”
4. The UE may select BCs appropriate for the requested RAT type from the final “candidate BC list” and select BCs to report. In this step, the UE may configure supportedBandCombinationList in a determined order. For example, the UE may configure BCs and UE capability to report according to a preconfigured rat-Type order (nr->eutra-nr->eutra). The UE may configure featureSetCombination regarding the configured supportedBandCombinationList. The UE may configure a list of “candidate feature set combinations” from a candidate BC list from which a list regarding fallback BCs (including capability of the same or lower step) is removed. The “candidate feature set combinations” may include all feature set combinations regarding NR and EUTRA-NR BCs, and may be provided from feature set combinations of containers of UE-NR-Capabilities and UE-MRDC-Capabilities.
5. If the requested RAT type is eutra-nr and has an influence, featureSetCombinations may be included on both containers of UE-MRDC-Capabilities and UE-NR-Capabilities. However, the feature set of NR may be included only in UE-NR-Capabilities.

After the UE capability is configured, the UE may transfer a UE capability information message including the UE capability to the base station. The base stations may perform scheduling and transmission/reception management appropriate for the UE, based on the UE capability received from the UE.

### [Regarding CA/DC]

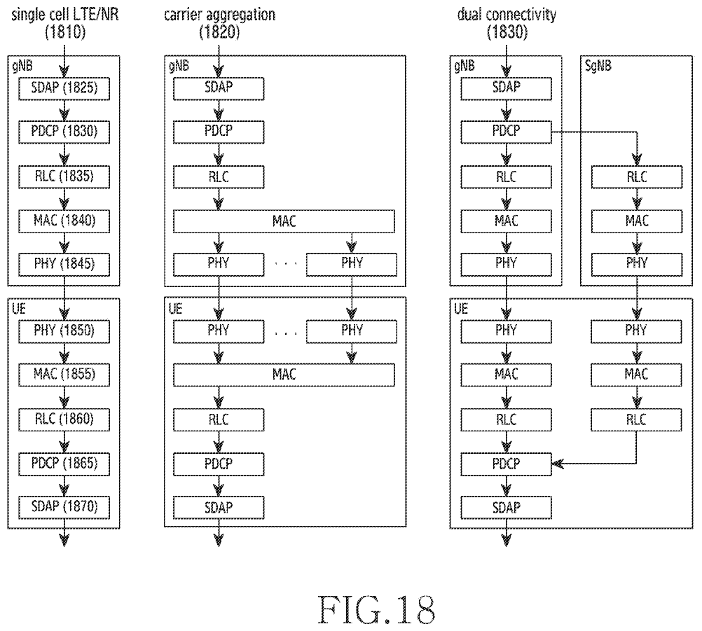

FIG. 18 illustrates radio protocol structures of a base station and a UE in single cell, carrier aggregation, and dual connectivity situations according to an embodiment of the disclosure.

Referring to FIG. 18, the radio protocol of a next-generation mobile communication system includes an NR service data adaptation protocol (SDAP) 1825 or 1870, an NR packet data convergence protocol (PDCP) 1830 or 1865, an NR radio link control (RLC) 1835 or 1860, and an NR medium access controls (MAC) 1840 or 1855, on each of UE and NR base station sides.

The main functions of the NR SDAP 1025 or 1070 may include some of functions below.
Transfer of user plane data
Mapping between a QoS flow and a DRB for both DL and UL
Marking QoS flow ID in both DL and UL packets
Reflective QoS flow to DRB mapping for the UL SDAP PDUs

With regard to the SDAP layer device 1825 or 1875, the UE may be configured, through an RRC message, whether to use the header of the SDAP layer device with regard to each PDCP layer device or with regard to each bearer or with regard to each logical channel, or whether to use functions of the SDAP layer device. If an SDAP header is configured, the NAS QoS reflection configuration 1-bit indicator (NAS reflective QoS) of the SDAP header and the AS QoS reflection configuration 1-bit indicator (AS reflective QoS) thereof may be indicated by the base station, so that the UE can update or reconfigure mapping information regarding the QoS flow and data bearer of the uplink and downlink. The SDAP header may include QoS flow ID information indicating the QoS. The QoS information may be used as data processing priority, scheduling information, etc. for smoothly supporting services.

The main functions of the NR PDCP 1830 or 1865 may include some of functions below.
Header compression and decompression: ROHC only
Transfer of user data
In-sequence delivery of upper layer PDUs
Out-of-sequence delivery of upper layer PDUs
PDCP PDU reordering for reception
Duplicate detection of lower layer SDUs
Retransmission of PDCP SDUs
Ciphering and deciphering
Timer-based SDU discard in uplink

The above-mentioned reordering of the NR PDCP device may refer to a function of reordering PDCP PDU received from a lower layer in an order based on PDCP sequence numbers (SNs). The reordering may include a function of transferring data to an upper layer in the reordered sequence. The reordering of the NR PDCP device may include a function of instantly transferring data without considering the order, and may include a function of recording PDCP PDUs lost as a result of reordering. The reordering may include a function of reporting the state of the lost PDCP PDUs to the transmitting side, and may include a function of requesting retransmission of the lost PDCP PDUs.

The main functions of the NR RLC 1835 or 1860 may include some of functions below.
Transfer of upper layer PDUs
In-sequence delivery of upper layer PDUs
Out-of-sequence delivery of upper layer PDUs
Error Correction through ARQ
Concatenation, segmentation and reassembly of RLC SDUs
Re-segmentation of RLC data PDUs
Reordering of RLC data PDUs
Duplicate detection
Protocol error detection
RLC SDU discard
RLC re-establishment

The above-mentioned in-sequence delivery of the NR RLC device may refer to a function of successively delivering RLC SDUs received from the lower layer to the upper layer. The in-sequence delivery of the NR RLC device may include a function of reassembling and delivering multiple RLC SDUs received, into which one original RLC SDU has been segmented. The in-sequence delivery of the NR RLC device may include a function of reordering the received RLC PDUs with reference to the RLC sequence number (SN) or PDCP sequence number (SN) and a function of recording RLC PDUs lost as a result of reordering. The in-sequence delivery of the NR RLC device may include a function of reporting the state of the lost RLC PDUs to the transmitting side and a function of requesting retransmission of the lost RLC PDUs. The in-sequence delivery function of the NR RLC device may include a function of, if there is a lost RLC SDU, successively delivering only RLC SDUs before the lost RLC SDU to the upper layer. The in-sequence delivery function of the NR RLC device may include a function of, if a predetermined timer has expired although there is a lost RLC SDU, successively delivering all RLC SDUs received before the timer was started to the upper layer. Alternatively, the in-sequence delivery of the NR RLC device may include a function of, if a predetermined timer has expired although there is a lost RLC SDU, successively delivering all currently received RLC SDUs to the upper layer. In addition, the in-sequence delivery function of the NR RLC device may process RLC PDUs in the received order (regardless of the sequence number order, in the order of arrival) and deliver same to the PDCP device regardless of the order (out-of-sequence delivery) The in-sequence delivery function of the NR RLC device may, in the case of segments, receive segments which are stored in a buffer or which are to be received later, reconfigure same into one complete RLC PDU, processing, and deliver same to the PDCP device. The NR RLC layer may include no concatenation function, which may be performed in the NR MAC layer or replaced with a multiplexing function of the NR MAC layer.

The out-of-sequence delivery of the NR RLC device may refer to a function of instantly delivering RLC SDUs received from the lower layer to the upper layer regardless of the order. The out-of-sequence delivery of the NR RLC device may include a function of reassembling and delivering multiple RLC SDUs received, into which one original RLC SDU has been segmented, and may include a function of storing the RLC SN or PDCP SN of received RLC PDUs, and recording RLC PDUs lost as a result of reordering.

The NR MAC 1840 or 1855 may be connected to multiple NR RLC layer devices configured in one UE, and the main functions of the NR MAC may include some of functions below.
Mapping between logical channels and transport channels
Multiplexing/demultiplexing of MAC SDUs
Scheduling information reporting
Error correction through HARQ
Priority handling between logical channels of one UE
Priority handling between UEs by means of dynamic scheduling
MBMS service identification
Transport format selection
Padding

The NR PHY layer 1845 or 1850 may perform operations of channel-coding and modulating upper layer data, thereby obtaining OFDM symbols, and delivering the same through a radio channel. The NR PHY layer may perform operations of demodulating OFDM symbols received through the radio channel, channel-decoding the same, and delivering the same to the upper layer.

The detailed structure of the radio protocol structure may be variously changed according to the carrier (or cell) operating scheme. According to an embodiment, assuming that the base station transmits data to the UE based on a single carrier (or cell), the base station and the UE may use a protocol structure having a single structure with regard to each layer (1810). Assuming that the base station transmits data to the UE based on carrier aggregation (CA) which uses multiple carriers in a single TRP, the base station and the UE may use a protocol structure which has a single structure up to the RLC, but multiplexes the PHY layer through a MAC layer (1820). According to another embodiment, assuming that the base station transmits data to the UE based on dual connectivity (DC) which uses multiple carriers in multiple TRPs, the base station and the UE use a protocol structure which has a single structure up to the RLC, but multiplexes the PHY layer through a MAC layer (1820).

### [Related to NC-JT]

According to an embodiment of the disclosure, non-coherent joint transmission (NC-JT) may be used for a UE to receive PDSCHs from multiple TRPs.

Unlike the conventional system, the 5G wireless communication system may support not only a service requiring a high transmission rate, but also a service having a very short transmission delay and a service requiring a high connection density. In a wireless communication network including multiple cells, transmission and reception points (TRPs), or beams, cooperative communication (coordinated transmission) between respective cells, TRPs, or/and beams may satisfy various service requirements by enhancing the strength of a signal received by a UE or efficiently performing interference control between the respective cells, TRPs, or/and beams.

Joint transmission (JT) is a representative transmission technique for the aforementioned cooperative communication, and may refer to a technique that increases the strength or throughput of a signal received by a UE, by transmitting the signal to one UE via multiple different cells, TRPs, and/or beams. Channels between a UE and respective cells. TRPs, or/and beams may have significantly different characteristics. Non-coherent joint transmission (NC-JT) supporting non-coherent precoding between the respective cells, TRPs, and/or beams may require individual precoding, MCS, resource allocation, TCI indication, etc. according to channel characteristics for each link between the UE and the respective cells, TRPs, and/or beams.

The NC-JT transmission described above may be applied to at least one channel among a downlink data channel, a downlink control channel, an uplink data channel, and an uplink control channel. During PDSCH transmission, transmission information, such as precoding, MCS, resource allocation, and TCI, may be indicated via DL DCI, and for NC-JT transmission, the transmission information may be independently indicated for each cell, TRP, and/or beam. The operation described above is a major factor that increases a payload required for DL DCI transmission, and may adversely affect reception performance of a PDCCH transmitting the DCI. Therefore, in order to support JT of PDSCH, it is necessary to efficiently design tradeoff between the amount of DCI information and reception performance of control information.

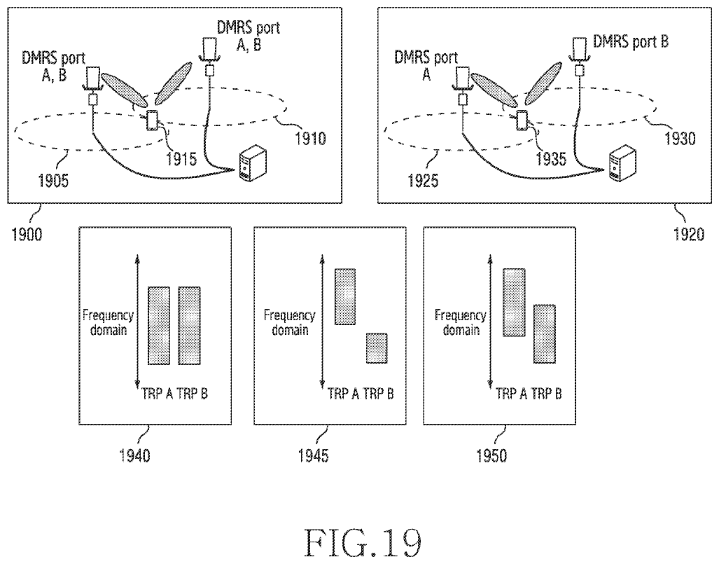

FIG. 19 illustrates an example of resource allocation and antenna port configurations for PUSCH transmission using cooperative communication in the wireless communication system according to an embodiment of the disclosure.

Referring to FIG. 19, examples for PDSCH transmission are described for each joint transmission technique, and examples for allocating radio resources for each TRP are illustrated.

Referring to FIG. 19, an example of coherent joint transmission (C-JT) supporting coherent precoding between respective cells. TRPs or/and beams is illustrated.

For C-JT, TRP A 1905 and TRP B 1910 may transmit single data (PDSCH) to a UE 1915, and joint precoding may be performed in multiple TRPs. This may indicate that DMRSs are transmitted via identical DMRS ports in order for TRP A 1905 and TRP B 1910 to transmit the same PDSCH. For example, TRP A 1905 and TRP B 1910 may transmit DRMSs to the UE via DMRS port A and DMRS port B, respectively. In this case, the UE may receive one piece of DC for reception of one PDSCH demodulated based on the DMRSs transmitted via DMRS port A and DMRS port B.

Referring to FIG. 19, according to an embodiment, an example 1920 of non-coherent joint transmission (NC-JT) that supports non-coherent precoding between respective cells, TRPs, and/or beams for PDSCH transmission is illustrated.

For NC-JT, a PDSCH may be transmitted to a UE 1935 for each cell, TRP, or/and beam, and individual precoding may be applied to each PDSCH. Each cell, TRP, and/or beam may transmit a different PDSCH or a different PDSCH layer to the UE, thereby improving a throughput compared to single-cell, TRP, and/or beam transmission. Each cell, TRP, and/or beam may repeatedly transmit the same PDSCH to the UE, thereby improving reliability compared to single-cell, TRP, and/or beam transmission. Hereinafter, for the convenience of description, a cell, a TRP, and/or a beam is collectively referred to as a TRP.

Hereinafter, various radio resource allocations may be considered, such as a case 1940 where frequency and time resources used in multiple TRPs for PDSCH transmission are all identical, a case 1945 where frequency and time resources used in multiple TRPs do not overlap at all, and a case 1950 where some of frequency and time resources used in multiple TRPs overlap.

For NC-JT support, DCI of various types, structures, and relations may be considered to assign multiple PDSCHs simultaneously to a single UE.

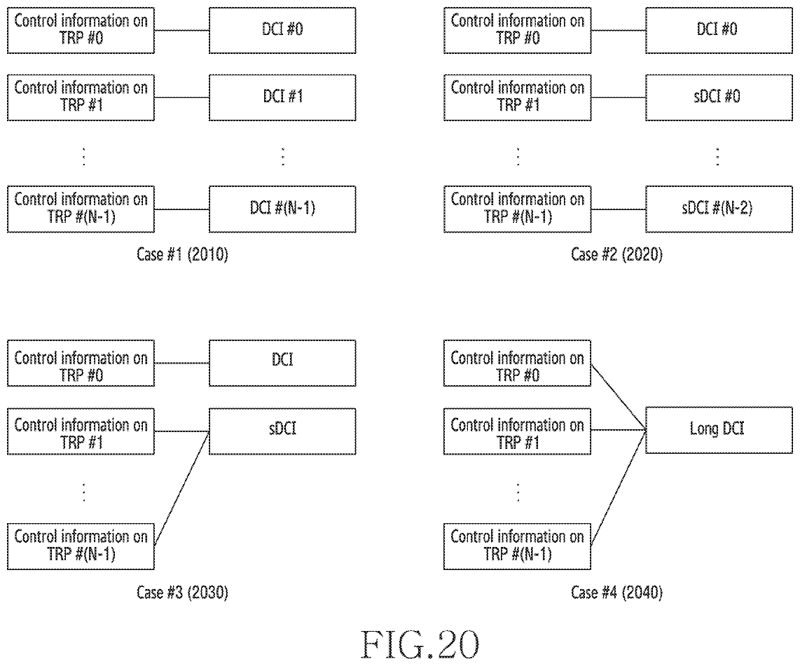

FIG. 20 illustrates an example of a configuration of downlink control information (DCI) for NC-JT in which respective TRPs transmit different PDSCHs or different PDSCH layers to a UE in the wireless communication system according to an embodiment of the disclosure.

Referring to FIG. 20, case #1 2010 illustrates an example in which, in a situation where different (N−1) PDSCHs are transmitted from (N−1) additional TRPs (e.g., TRP #1 to TRP #(N−1)) in addition to a serving TRP (TRP #0) used during single PDSCH transmission, control information on PDSCHs transmitted in the (N−1) additional TRPs is transmitted independently of control information on a PDSCH transmitted in the serving TRP. That is, the UE may acquire control information on PDSCHs transmitted from different TRPs (e.g., TRP #0 to TRP #(N−1)) via independent pieces of DCI (e.g., DCI #0 to DCI #(N−1)). Formats between the independent pieces of DCI may be identical to or different from each other, and payloads between the DCI may also be identical to or different from each other. In aforementioned case #1, each PDSCH control or allocation freedom may be completely guaranteed, but when respective pieces of DCI are transmitted from different TRPs, a coverage difference per DCI may occur and thus reception performance may be deteriorated.

Referring to FIG. 20, case #2 2020 illustrates an example dependent on control information on a PDSCH, in which, in a situation where (N−1) different PDSCHs are transmitted from (N−1) additional TRPs (e.g., TRP #1 to TRP #(N−1)) in addition to a serving TRP (TRP #0) used during single PDSCH transmission, control information (DCI) for each of PDSCHs of the additional (N−1) TRPs is transmitted, and each piece of the DCI is transmitted from the serving TRP. DCI #0 which is control information on a PDSCH transmitted from the serving TRP (TRP #0) may include all information elements of DCI format 1_0, DCI format 1_1, and DCI format 1_2. Shortened DCI (hereinafter, sDCI) (e.g., sDCI #0 to sDCI #(N−2)) which is control information on PDSCHs transmitted from cooperative TRPs (TRP #1 to TRP #(N−1)) may include only some of the information elements of DCI format 1_0. DCI format 11, and DCI format 1_2. sDCI for transmission of the control information on the PDSCHs transmitted from the cooperative TRPs has a smaller payload compared to normal DCI (nDCI) for transmission of the control information related to the PDSCH transmitted from the serving TRP, and may thus include reserved bits unlike nDCI. In aforementioned case #2, each PDSCH control or allocation freedom may be restricted according to content of an information element included in sDCI, but since reception performance of sDCI is superior to that of nDCI, a probability that a coverage difference occurs per DCI may be lowered.

Referring to FIG. 20, case #3 2030 illustrates an example dependent on control information on a PDSCH, in which, in a situation where (N−1) different PDSCHs are transmitted from (N−1) additional TRPs (e.g., TRP #1 to TRP #(N−1)) in addition to a serving TRP (TRP #0) used during single PDSCH transmission, one piece of control information on PDSCHs of the (N−1) additional TRPs is transmitted, and the DCI is transmitted from the serving TRP. DCI #0 which is control information on a PDSCH transmitted from the serving TRP (TRP #0) may include all information elements of DCI format 1_0, DCI format 1_1, and DCI format 1_2. For control information on the PDSCHs transmitted from the cooperative TRPs (e.g., TRP #1 to TRP #(N−1)), only some of the information elements of DCI format 1_0, DCI format 1_1, and DCI format 1_2 may be gathered in one piece of “secondary” DCI (sDCI) so as to be transmitted. sDCI may include at least one piece of HARQ-related information, such as frequency domain resource assignment, time domain resource assignment, and MCS of the cooperative TRPs. Information that is not included in sDCI, such as a bandwidth part (BWP) indicator or a carrier indicator, may conform to the DCI (DCI #0, normal DCI, or nDCI) of the serving TRP. In case #3 2030, each PDSCH control or allocation freedom may be restricted according to content of an information element included in sDCI, but sDCI reception performance may be adjustable, and complexity of DCI blind decoding of the UE may be reduced unlike case #1 2010 or case #2 2020.

Referring to FIG. 20, case #4 2040 illustrates an example in which, in a situation where (N−1) different PDSCHs are transmitted from (N−1) additional TRPs (e.g., TRP #1 to TRP #(N−1)) in addition to a serving TRP (TRP #0) used during single PDSCH transmission, control information on the PDSCHs transmitted from the (N−1) additional TRPs is transmitted in the same DCI (long DCI) as that for control information on the PDSCH transmitted from the serving TRP. The UE may acquire the control information on the PDSCHs transmitted from different TRPs (e.g., TRP #0 to TRP #(N−1)) via single DCI. For case #4 2040, complexity of DCI blind decoding of the UE may not increase, but a PDSCH control or allocation freedom may be low so that the number of the cooperative TRPs is limited according to long DCI payload restrictions.

Hereinafter, in descriptions and various embodiments, sDCI may refer to various auxiliary DCI, such as shortened DCI, secondary DCI, and normal DCI (e.g., DCI formats 1_0 to 1_1) including PDSCH control information transmitted in a cooperative TRP, and if no particular restriction is specified, the descriptions may be similarly applicable to the various auxiliary DCI.

Hereinafter, in descriptions and various embodiments, aforementioned case #1 2010, case #2 2020, and case #3 2030, in which one or more pieces of DCI (PDCCHs) are used for NC-JT support, may be classified as multiple PDCCH-based NC-JT, and aforementioned case #4 2040 in which single DCI (PDCCH) is used for NC-JT support may be classified as single PDCCH-based NC-JT. In the multiple PDCCH-based PDSCH transmission, a CORESET in which DCI of the serving TRP (TRP #0) is scheduled and a CORESET in which DCI of the cooperative TRPs (e.g., TRP #1 to TRP #(N−1)) are scheduled may be distinguished. As a method for distinguishing CORESETs, a method of distinguishment via a higher-layer indicator for each CORESET, a method of distinguishment via a beam configuration for each CORESET, etc. may be used. In the single PDCCH-based NC-JT, single DCI is for scheduling of a single PDSCH having multiple layers, instead of scheduling of multiple PDSCHs, and the aforementioned multiple layers may be transmitted from multiple TRPs. A connection relation between a layer and a TRP for transmission of the layer may be indicated via a transmission configuration indicator (TCI) indication for the layer.

In embodiments of the disclosure, “cooperative TRP” may be replaced with various terms, such as “cooperative panel” or “cooperative beam” when actually applied.

In embodiments of the disclosure, “when NC-JT is applied” can be interpreted in various ways depending on a situation, such as “when a UE receives one or more PDSCHs simultaneously in one BWP”, “when a UE receives PDSCHs based on two or more TCI indications simultaneously in one BWP”, and “when PDSCHs received by a UE are associated with one or more DMRS port groups”, but one expression is used for the convenience of description.

In the disclosure, a radio protocol structure for NC-JT may be used in various ways according to a TRP deployment scenario. According to an embodiment, when there is no backhaul delay or a small backhaul delay between cooperative TRPs, a method (CA-like method) using a structure based on MAC layer multiplexing similar to FIG. 18 is possible. When a backhaul delay between cooperative TRPs is so large that the backhaul delay cannot be ignored (e.g., when a time of 2 ms or longer is required for exchange of information, such as CSI, scheduling, and HARQ-ACK, etc., between the cooperative TRPs), a method (DC-like method) of securing characteristics robust to a delay by using an independent structure for each TRP from an RLC layer may be possible.

The UE supporting C-JT/NC-JT may receive a C-JT/NC-JT-related parameter, setting value, or the like from a higher-layer configuration. The UE may configure an RRC parameter, based on the received value. For the higher-layer configuration, the UE may use a UE capability parameter, for example, tci-StatePDSCH. The UE capability parameter (e.g., tci-StatePDSCH) may define TCI states for the purpose of PDSCH transmission. The number of the TCI states may be configured to be 4, 8, 16, 32, 64, and 128 in FR1 and configured to be 64 and 128 in FR2, and among the configured numbers, up to 8 states that may be indicated by 3 bits of a TCI field in DCI may be configured via a MAC CE message. The maximum value of 128 may refer to a value indicated by maxNumberConfiguredTCIstatesPerCC in parameter tci-StatePDSCH included in capability signaling of the UE. A series of configuration procedures from the higher-layer configuration to the MAC CE configuration may be applied to a beamforming change command or a beamforming indication for at least one PDSCH in one TRP.

### [Multi-DCI Based Multi-TRP]

As an embodiment of the disclosure, a multi-DCI-based multi-TRP transmission method is described. The multi-DCI-based multi-TRP transmission method may include configuring a downlink control channel for NC-JT transmission, based on a multi-PDCCH.

In multiple PDCCH-based NC-JT, when DCI for PDSCH scheduling for each TRP is transmitted, a CORESET or a search space distinguished for each TRP may be provided. The CORESET or search space for each TRP may be configurable as at least one of the following cases.

### Higher-Layer Index Configuration for Each CORESET

CORESET configuration information configured via a higher layer may include an index value. A TRP transmitting a PDCCH in a corresponding CORESET may be distinguished by a configured index value for each CORESET. In a set of CORESETs having the same higher-layer index value, it may be considered that the same TRP transmits PDCCHs, or PDCCHs for PDSCH scheduling for the same TRP are transmitted. The described index for each CORESET may be referred to as CORESETPoolIndex. For CORESETs configured with the same CORESETPoolIndex value, it may be considered that PDCCHs are transmitted from the same TRP. For a CORESET for which no CORESETPoolIndex value has been configured, it may be considered that a default value has been configured for CORESETPoolIndex, where the default value is 0.

According to an embodiment of the disclosure, when there is more than one type of CORESETPoolIndex that each of multiple CORESETs has, the multiple CORESETs being included in PDCCH-Config that is higher-layer signaling (e.g., when each CORESET has a different CORESETPoolIndex), the UE may consider that a base station may use the multi-DCI-based multi-TRP transmission method.

According to an embodiment of the disclosure, when there is one type of CORESETPoolIndex that each of multiple CORESETs has, the multiple CORESETs being included in PDCCH-Config that is higher-layer signaling (e.g., when all CORESETs have the same CORESETPoolIndex of 0 or 1), the UE may consider that the base station performs transmission using a single-TRP without using the multi-DCI-based multi-TRP transmission method.

### Multiple PDCCH-Config Configurations

Multiple PDCCH-Configs in one BWP may be configured, and each PDCCH-Config may include a PDCCH configuration for each TRP. A list of CORESETs for each TRP and/or a list of search spaces for each TRP may be configured in one PDCCH-Config, and one or more CORESETs and one or more search spaces included in one PDCCH-Config may be considered to correspond to a specific TRP.

### CORESET Beam/Beam Group Configuration

A TRP corresponding to a corresponding CORESET may be distinguished via a beam or beam group configured for each CORESET. For example, when the same TCI state is configured for multiple CORESETs, it may be considered that the CORESETs are transmitted via the same TRP, or that PDCCHs for PDSCH scheduling for the same TRP are transmitted in the corresponding CORESETs.

### Search Space Beam/Beam Group Configuration

A beam or a beam group may be configured for each search space, and a TRP for each search space may be distinguished. When the same beam/beam group or TCI state is configured for multiple search spaces, it may be considered that the same TRP transmits PDCCHs in the corresponding search spaces or that PDCCHs for PDSCH scheduling for the same TRP are transmitted in the search spaces.

As described above, by distinguishing the CORESETs or search spaces according to TRPs, it may be possible to classify PDSCH and HARQ-ACK information for each TRP, and based on this, it may be possible to independently generate an HARQ-ACK codebook and independently use a PUCCH resource for each TRP.

The described configurations may be independent for each cell or each BWP. For example, while two different CORESETPoolIndex values are configured for a PCell, a CORESETPoolIndex value may not be configured for a specific SCell. In this case, it may be considered that NC-JT transmission has been configured for the PCell, whereas NC-T transmission has not been configured for the SCell for which no CORESETPoolIndex value has been configured.

A PDSCH TCI state activation/deactivation MAC-CE applicable to the multi-DCI-based multi-TRP transmission method may conform to FIG. 15. When the UE is not configured with CORESETPoolIndex for each of all CORESETs in higher-layer signaling PDCCH-Config, the UE may disregard a CORESET pool ID field 1555 in the corresponding MAC-CE 1550. When the UE is able to support the multi-DC-based multi-TRP transmission method, (e.g., when the UE has CORESETPoolIndex in which respective CORESETs within higher-layer signaling PDCCH-Config are different), the UE may activate a TCI state in DCI included in PDCCHs transmitted in CORESETs having the same CORESETPoolIndex value as the CORESET pool ID field 1555 value in the MAC-CE 1550. According to an embodiment, if the value of the CORESET Pool ID field 1555 in the MAC-CE 1550 is 0, the TCI state in DCI included in the PDCCHs transmitted from the CORESETs having a CORESETPoolIndex value of 0 may conform to activation information of the MAC-CE.

When the UE is configured to use the multi-DCI-based multi-TRP transmission method from the base station (e.g., when there is more than one type of CORESETPoolIndex that each of the multiple CORESETs included in higher-layer signaling PDCCH-Config has, or when each CORESET has different CORESETPoolIndex), the UE may recognize the presence of the following restrictions with respect to PDSCHs scheduled from the PDCCHs in respective CORESETs having two different CORESETPoolIndex values.

When the PDSCHs indicated by the PDCCHs in the respective CORESETs having two different CORESETPoolIndex values entirely or partially overlap, the UE may apply TCI states indicated by the respective PDCCHs to different CDM groups, respectively. For example, two or more TCI states may not be applied to one CDM group.

When the PDSCHs indicated by the PDCCHs in the respective CORESETs having two different CORESETPoolIndex values entirely or partially overlap, the UE may expect that the actual number of front loaded DMRS symbols, the actual number of additional DMRS symbols, actual positions of the DMRS symbols, and DMRS types of the respective PDSCHs may not be different from each other.

The UE may expect that bandwidth parts indicated from the PDCCHs in the respective CORESETs having two different CORESETPoolIndex values are the same, and that subcarrier spacings thereof may also be the same.

The UE may expect the respective PDCCHs to completely include information on the PDSCHs scheduled from the PDCCHs in the respective CORESETs having two different CORESETPoolIndex values.

### [Single-DCI-Based Multi-TRP]

As an embodiment of the disclosure, a single-DCI-based multi-TRP transmission method is described. The single-DCI-based multi-TRP transmission method may include configuring a downlink control channel for NC-JT transmission, based on a single-PDCCH.

In the single-DCI-based multi-TRP transmission method, PDSCHs transmitted by multiple TRPs may be scheduled via one piece of DCI. The number of TCI states may be used as a method for indicating the number of TRPs which transmit the PDSCHs. If the number of TCI states indicated in DCI for PDSCH scheduling is two, single PDCCH-based NC-JT transmission may be considered, and if the number of TCI states is one, single-TRP transmission may be considered. The TCI states indicated by the DCI may correspond to one or two TCI states among TCI states activated via a MAC-CE. When the TCI states of the DCI correspond to two TCI states activated via the MAC-CE, a correspondence may be established between a TCI codepoint indicated in the DCI and the TCI states activated via the MAC-CE. There may be two TCI states activated via the MAC-CE, which correspond to the described TCI codepoint.

As another embodiment, when at least one codepoint among all codepoints of a TCI state field in the DCI indicates two TCI states, the UE may consider that the base station may perform transmission based on the single-DCI-based multi-TRP method. At least one codepoint indicating two TCI states in the TCI state field may be activated via an enhanced PDSCH TCI state activation/deactivation MAC-CE.

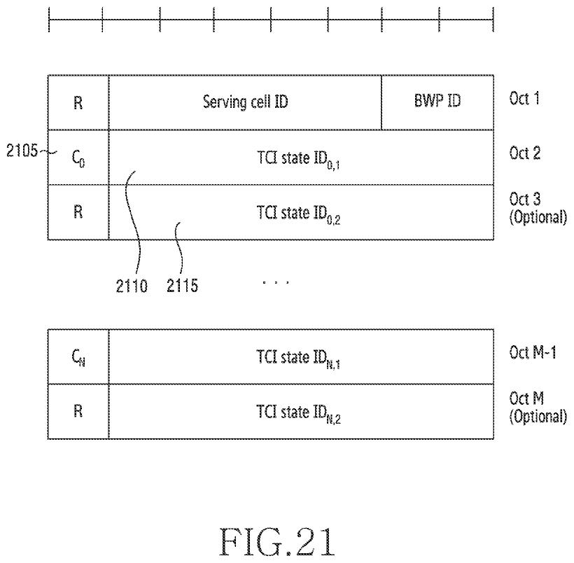

FIG. 21 illustrates an enhanced PDSCH TCI state activation/deactivation MAC-CE structure. Referring to FIG. 21, the meaning of each field in a corresponding MAC CE and a value configurable for each field may be as shown below.

Serving Cell ID: This field indicates the identity of
the Serving Cell for which the MAC CE applies.
The length of the field is 5 bits. If the indicated
Serving Cell is configured as part of a
simultaneous TCI-UpdateList1 or simultaneousTCI-
UpdateList2 as specified in TS 38.331 [5], this
MAC CE applies to all the Serving Cells configured
in the set simultaneousTCI-UpdateListl or
simultaneousTCI-UpdateList2, respectively;
BWP ID: This field indicates a DL BWP for which
the MAC CE applies as the codepoint of the
DCI bandwidth part indicator field as specified in
TS 38.212 [9]. The length of the BWP ID field
is 2 bits;
Cᵢ: This field indicates whether the octet containing
TCI state ID_{i,2} is present. If this field is set to
“1”, the octet containing TCI state ID_{i,2} is present.
If this field is set to “0”, the octet containing
TCI state ID_{i,2} is not present;
TCI state ID_{i,j}: This field indicates the TCI state
identified by TCI-StateId as specified in TS 38.331
[5], where i is the index of the codepoint of the DCI
Transmission configuration indication field as
specified in TS 38.212 [9] and TCI state ID_{i,j}
indicates the j-th TCI state indicated for the i-th
codepoint in the DCI Transmission Configuration
Indication field. The TCI codepoint to which the
TCI States are mapped is determined by its ordinal
position among all the TCI codepoints with sets
of TCI state ID_{i,j} fields, i.e., the first TCI codepoint
with TCI state ID_{0,1} and TCI state ID_{0,2} shall
be mapped to the codepoint value 0, the second
TCI codepoint with TCI state ID_{1,1} and TCI state
ID_{1,2} shall be mapped to the codepoint value 1 and
so on. The TCI state ID_{i,2} is optional based on
the indication of the Ci field. The maximum number
of activated TCI codepoint is 8 and the maximum
number of TCI states mapped to a TCI codepoint is 2.
R: Reserved bit, set to “0”.

Referring to FIG. 21, when a value of a C₀ field 2105 is 1, the MAC-CE may additionally include a TCI state ID_{0,2} field 2115 in addition to a TCI state ID_{0,1} field 2110. The described relationship may indicate that TCI state ID_{0,1} and TCI state ID_{0,2} are activated for a zeroth codepoint of the TCI state field included in the DCI. If a base station indicates the codepoint to a UE, the UE may be indicated with two TCI states. When the value of the C₀ field 2105 is 0, the MAC-CE may not include field TCI state ID_{0,2} 2115, and this indicates that one TCI state corresponding to TCI state ID_{0,1} is activated for the zeroth codepoint of the TCI state field included in the DCI.

The described configuration may be independent for each cell or each BWP. For example, a PCell may have up to two activated TCI states corresponding to one TCI codepoint, where as a specific SCell may have up to one activated TCI state corresponding to one TCI codepoint. In this case, it may be considered that NC-JT transmission has been configured for the PCell, whereas NC-JT transmission has not been configured for the described SCell.

[Method for Distinguishing Single-DC i-Based Multi-TRP Repeated PDSCH Transmission Scheme (TDM/FDM/SDM)]

Hereinafter, a method for distinguishing a single-DCI-based multi-TRP repeated PDSCH transmission scheme will be described. The UE may be indicated with different single-DCI-based multi-TRP repeated PDSCH transmission schemes (e.g., TDM, FDM, and SDM) according to a higher-layer signaling configuration and a value indicated via a DCI field from the base station. Table 42 shows a method of distinguishing between a single-TRP-based scheme and a multi-TRP-based scheme indicated to the UE according to a specific DCI field value and higher-layer signaling configuration.

TABLE 42

| | | | repetitionNumber | | |
|---|---|---|---|---|---|
| | Number | Number of | configuration and | Relating to | |
| Com- | of TCI | CDM | indication | repetitionScheme | Transmission scheme |
| bination | state | group | condition | configuration | indicated to terminal |
| 1 | 1 | ≥1 | Condition 2 | Not Configured | Single-TRP |
| 2 | 1 | ≥1 | Condition 2 | Configured | Single-TRP |
| 3 | 1 | | Condition 3 | Configured | Single-TRP |
| 4 | 1 | 1 | Condition 1 | Configured or not | Single-TRP TDM scheme B |
| | | | | Configured | |
| 5 | 2 | 2 | Condition 2 | Not Configured | Multi-TRP SDM |
| 6 | 2 | 2 | Condition 3 | Not Configured | Multi-TRP SDM |
| 7 | 2 | 2 | Condition 3 | Configured | Multi-TRP SDM |
| 8 | 2 | 2 | Condition 3 | Configured | Multi-TRP SDM scheme |
| | | | | | A/FDM scheme B/TDM |
| | | | | | scheme A |
| 9 | 2 | 2 | Condition 1 | Not Configured | Multi-TRP SDM scheme B |

In Table 42, respective columns may be described as follows.
Number of TCI states (column 2): This may refer to the number of TCI states indicated via a TCI state field in DCI. The number of TCI states may be 1 or 2.
Number of CDM groups (column 3): This may refer to the number of different CDM groups of DMRS ports indicated via an antenna port field in DCI. The number of CDM groups may be 1, 2 or 3.
repetitionNumber configuration and indication condition (column 4): There may be three conditions depending on whether repetitionNumber for all TDRA entries which may be indicated via a time domain resource allocation field in DCI is configured, and whether an actually indicated TDRA entry has a configuration of repetitionNumber.
Condition 1: A case where at least one of all TDRA entries that may be indicated by the time domain resource allocation field includes a configuration for repetitionNumber, and a TDRA entry indicated by the time domain resource allocation field in DCI includes a configuration for repetitionNumber greater than 1
Condition 2: A case where at least one of all TDRA entries which may be indicated by the time domain resource allocation field includes a configuration for repetitionNumber, and a TDRA entry indicated by the time domain resource allocation field in DCI does not include a configuration for repetitionNumber
Condition 3: A case where all TDRA entries which may be indicated by the time domain resource allocation field do not include a configuration for repetitionNumber
Relating to a configuration of repetitionScheme (column 5): This may refer to whether repetitionScheme that is higher-layer signaling is configured. One of “tdmSchemeA”, “fdmSchemeA”, and “fdmSchemeB” may be configured for repetitionScheme that is higher-layer signaling.
Transmission scheme indicated to the UE (column 6): This may refer to single-TRP or multi-TRP schemes indicated according to each combination (column 1) expressed as in Table 42.
Single-TRP: This may refer to single-TRP-based PDSCH transmission. When the UE is configured with pdsch-AggegationFactor in higher-layer signaling PDSCH-config, the UE may be scheduled with the configured number of times of single-TRP-based repeated PDSCH transmissions. Otherwise, the UE may be scheduled with single-TRP-based single PDSCH transmission.
Single-TRP TDM scheme B: This may refer to repeated PDSCH transmission based on time resource division between slots based on a single TRP. According to aforementioned condition 1 relating to repetitionNumber, the UE may perform repeated PDSCH transmission on time resources as many times as repetitionNumber of slots, which is greater than 1 and configured for the TDRA entry indicated via the time domain resource allocation field. The same start symbol and symbol length of the PDSCH indicated by the TDRA entry may be applied to each slot as many times as repetitionNumber, and the same TCI state may be applied to each repeated PDSCH transmission. This scheme may be similar to a slot aggregation scheme in view of performing repeated PDSCH transmission between slots on time resources, but may be different from the slot aggregation in that whether to indicate repeated transmission may be dynamically determined based on the time domain resource allocation field in DCI.
Multi-TRP SDM: This may refer to a multi-TRP-based spatial resource division PDSCH transmission scheme. This scheme is a method of performing reception from each TRP by dividing layers, and is not a repeated transmission scheme. However, in the multi-TRP SDM, a coding rate may be lowered by increasing the number of layers so that the reliability of PDSCH transmission may be increased. The UE may receive PDSCHs by applying two TCI states, which are indicated by the TCI state field in the DCI, to two CDM groups indicated by the base station, respectively.
Multi-TRP FDM scheme A: This may refer to a multi-TRP-based frequency resource division PDSCH transmission scheme. This scheme has one PDSCH transmission position (occasion) and therefore is not repeated transmission like the multi-TRP SDM. However, in multi-TRP FDM scheme A, a coding rate may be lowered by increasing the amount of frequency resources so that transmission may be performed with high reliability. In multi-TRP FDM scheme A, two TCI states indicated via the TCI state field in DCI may be applied to frequency resources that do not overlap each other, respectively. When a PRB bundling size is determined to be wideband, if the number of RBs indicated via the frequency domain resource allocation field is N, the UE may receive first ceil(N/2) RBs by applying a first TCI state and may receive the remaining floor(N/2) RBs by applying a second TCI state. ceil(.) and floor(.) may be operators indicating rounding up and rounding off of a first decimal point. When the PRB bundling size is determined to be 2 or 4, even-numbered PRGs may be received by applying the first TCI state, and odd-numbered PRGs may be received by applying the second TCI state.
Multi-TRP FDM scheme B: This may refer to a multi-TRP-based frequency resource division PDSCH transmission scheme. This scheme has two PDSCH transmission occasions, and may thus perform repeated PDSCH transmission at each occasion. In multi-TRP FDM scheme B, as in multi-TRP FDM scheme A, two TCI states indicated via the TCI state field in DCI may be applied to frequency resources that do not overlap each other, respectively. When a PRB bundling size is determined to be wideband, if the number of RBs indicated via the frequency domain resource allocation field is N, the UE may receive first ceil(N/2) RBs by applying a first TCI state and may receive the remaining floor(N/2) RBs by applying a second TCI state. ceil(.) and floor(.) may be operators indicating rounding up and rounding off of a first decimal point. When the PRB bundling size is determined to be 2 or 4, even-numbered PRGs may be received by applying the first TCI state, and odd-numbered PRGs may be received by applying the second TCI state.
Multi-TRP TDM scheme A: This may refer to a repeated PDSCH transmission scheme in a multi-TRP-based time resource division slot. The UE may have two PDSCH transmission occasions within one slot. A first reception occasion may be determined based on a start symbol and a symbol length of a PDSCH, which are indicated via the time domain resource allocation field in DCI. A start symbol at a second reception occasion of the PDSCH may be a position to which as many symbol offsets as StartingSymbolOffsetK that is higher-layer signaling are applied from a last symbol of a first transmission occasion, and based on this, the transmission occasion may be determined by the indicated symbol length. When StartingSymbolOffsetK that is higher-layer signaling is not configured, the symbol offset may be regarded as 0.
Multi-TRP TDM scheme B: This may refer to a repeated PDSCH transmission scheme between multi-TRP-based time resource division slots. The UE may have one PDSCH transmission occasion within one slot. The UE may receive repeated transmission based on the start symbol and symbol length of the same PDSCH during slots equal to a repetitionNumber number of times indicated via the time domain resource allocation field in DCI. When repetitionNumber is 2, the UE may receive, with respect to repeated PDSCH transmissions in first and second slots, PDSCHs by applying the first and second TCI states, respectively. When repetitionNumber is greater than 2, the UE may use a different TCI state applying scheme depending on a configuration of tciMapping that is higher-layer signaling. When tciMapping is configured to be cyclicMapping, the first and second TCI states may be applied to first and second PDSCH transmission occasions, respectively, and this TCI state applying method may also be equally applied to the remaining PDSCH transmission occasions. When tciMapping is configured to be sequentialMapping, the first TCI state may be applied to the first and second PDSCH transmission occasions, and the second TCI state may be applied to third and fourth PDSCH transmission occasions, wherein this TCI state applying method may be applied to the remaining PDSCH transmission occasions in the same manner.

### [Relating to RLM RS]

Hereinafter, descriptions will be provided for a method of selecting or determining a radio link monitoring reference signal (RLM RS) when the RLM RS is configured or is not configured. The UE may be configured with a set of RLM RSs from the base station via RadioLinkMonitoringRS in RadioLinkMonitoringConfig, which is higher-layer signaling, for each downlink bandwidth part of SPCell. A specific higher-layer signaling structure may conform to Table 43.

TABLE 43

```
RadioLinkMonitoringConfig ::= SEQUENCE {
    failureDetectionResourcesToAddModList SEQUENCE
(SIZE(1..maxNrofFailureDetectionResources)) OF RadioLinkMonitoringRS
OPTIONAL, -- Need N
    failureDetectionResourcesToReleaseList SEQUENCE
(SIZE(1..maxNrofFailureDetectionResources)) OF RadioLinkMonitoringRS-Id
OPTIONAL, -- Need N
    beamFailureInstanceMaxCount ENUMERATED {n1, n2, n3, n4, n5, n6, n8, n10}
OPTIONAL, -- Need R
    beamFailureDetectionTimer ENUMERATED {pbfd1, pbfd2, pbfd3, pbfd4, pbfd5,
pbfd6, pbfd8, pbfd10} OPTIONAL, -- Need R
    ...
}
RadioLinkMonitoringRS ::= SEQUENCE {
    radioLinkMonitoringRS-Id RadioLinkMonitoringRS-Id,
    purpose ENUMERATED {beamFailure, rlf, both},
    detectionResource CHOICE {
        ssb-Index SSB-Index,
        csi-RS-Index NZP-CSI-RS-ResourceId
    },
    ...
}
```

Table 44 may indicate the configurable or selectable number of RLM RSs for each specific use according to a maximum number (Lmax) of SSBs per half frame. As shown in Table 44, according to an Lmax value, NLR-RLM RSs may be used for link recovery or radio link monitoring, and NRLM RSs among NLR-RLM RSs may be used for radio link monitoring.

TABLE 44
N_{LR-RLM} and N_{RLM} as a function of maximum number
Lₘₐₓ of SS/PBCH blocks per half

| Lₘₐₓ | N_{LR-RLM} | N_{RLM} |
|---|---|---|
| 4 | 2 | 2 |
| 8 | 6 | 4 |
| 64 | 8 | 8 |

If the UE has failed to be configured with RadioLinkMonitoringRS that is higher-layer signaling, and has been configured with a TCI state for PDCCH reception in a control resource set, and at least one CSI-RS is included in the TCI state, an RLM RS may be selected according to the following RLM RS selection methods.

### RLM RS Selection Method 1)

If an activated TCI state to be used for PDCCH reception has one reference RS (e.g., when one activated TCI state has only one of QCL-TypeA, B, or C), the UE may select, as an RLM RS, the reference RS of the activated TCI state to be used for PDCCH reception.

### RLM RS Selection Method 2)

If an activated TCI state to be used for PDCCH reception has two reference RSs (i.e., when one activated TCI state has one of QCL-TypeA, B, or C, while additionally having QCL-TypeD), the UE may select a reference RS of QCL-TypeD as an RLM-RS. The UE may not expect two QCL-TypeDs to be configured for one activated TCI state.

### RLM RS Selection Method 3)

The UE may not expect an aperiodic or semi-persistent RS to be selected as an RLM RS.

### RLM RS Selection Method 4)

If Lmax=4, the UE may select NRLM RSs (since Lmax is 4, 2 may be selected). An RLM RS may be selected from among reference RSs of a TCI state configured in a control resource set for PDCCH reception, based on RLM RS selection methods 1 to 3 described above. The UE may determine that a short period of a search space linked to a control resource set has a high priority, so as to select an RLM RS from among reference RSs of a TCI state configured for a control resource set linked to a search space having a shortest period. If there are multiple control resource sets linked to multiple search spaces having the same period, an RLM RS may be selected from reference RSs of a TCI state configured for a high control resource set index.

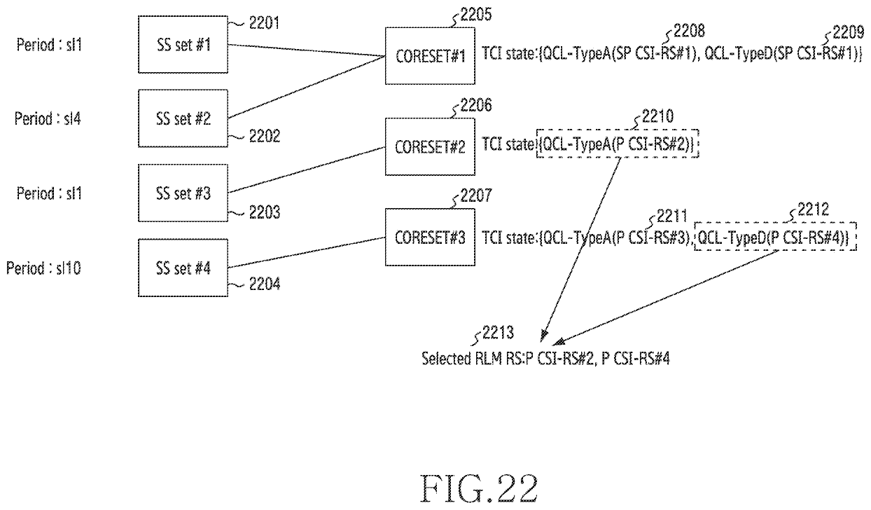

FIG. 22 illustrates an RLM RS selection procedure according to an embodiment of the disclosure. FIG. 22 illustrates control resource set #1 to control resource set #3 2205 to 2207 linked to search space #1 to search space #4 2201 to 2204 having different periods within an activated downlink bandwidth part, and a reference RS of a TCI state configured in each CORESET.

Based on RLM RS selection method 4, RLM RS selection uses a TCI state configured for a control resource set linked to a search space having a shortest period, but since search space #1 2201 and search space #3 2203 have the same period, a reference RS of a TCI state configured for control resource set #2 having a higher index between control resource set #1 2205 and control resource set #2 2206 linked to respective search spaces may be used as a reference RS having a highest priority in the RLM RS selection. Since the TCI state configured for control resource set #2 has only QCL-TypeA, and the reference RS thereof is a periodic RS, P CSI-RS #2 2210 may be first selected as an RLM RS according to RLM RS selection methods 1 and 3. The reference RS of QCL-TypeD may be a selection candidate according to RLM RS selection method 2 from among reference RSs of the TCI state configured for control resource set #1 having subsequent priorities, but the corresponding RS is a semi-persistent RS 2209 and therefore may not be selected as an RLM RS according to aforementioned RLM RS selection method 3. The reference RSs of the TCI state configured for control resource set #3 may be considered to have subsequent priorities, and the reference RS of QCL-TypeD may be a selection candidate according to aforementioned RLM RS selection method 2. Since the reference RS is a periodic RS, P CSI-RS #4 2212 may be selected second as an RLM RS according to RLM RS selection method 3. Therefore, the finally selected RLM RSs 2213 may be P CSI-RS #2 and P CSI-RS #4 in reference numeral 2213.

In the following description of the disclosure, for the convenience of description, a cell, a transmission point, a panel, a beam, a transmission direction, and/or the like, which may be distinguishable via higher layer/L1 parameters, such as TCI state or spatial relation information, or indicators, such as a cell ID, a TRP ID, and a panel ID, may be described as a TRP (e.g., transmission point), a beam, or a TCI state in a unified manner. Therefore, in actual application, a TRP, a beam, or a TCI state may be appropriately replaced with one of the above terms.

Hereinafter, in the disclosure, in determining whether to apply cooperative communication, it is possible for a UE to use various methods, in which a PDCCH(s) assigning a PDSCH to which the cooperative communication is applied has a specific format, a PDCCH(s) assigning a PDSCH to which the cooperative communication is applied includes a specific indicator indicating whether the cooperative communication is applied, a PDCCH(s) assigning a PDSCH to which the cooperative communication is applied is scrambled by a specific RNTI, applying of the cooperative communication in a specific interval indicated by a higher layer is assumed, or the like. Hereinafter, for the convenience of description, a case in which a UE receives a PDSCH to which cooperative communication has been applied based on conditions similar to the above will be referred to as an NC-JT case.

Hereinafter, an embodiment of the disclosure will be described in detail with the accompanying drawings. Hereinafter, a base station is a subject that performs resource allocation to a UE, and may be at least one of a gNode B, a gNB, an eNode B, a Node B, a base station (BS), a radio access unit, a base station controller, or a node on a network. A terminal may include a user equipment (UE), a mobile station (MS), a cellular phone, a smartphone, a computer, or a multimedia system capable of performing a communication function. Hereinafter, an embodiment of the disclosure will be described using the 5G system as an example, but the embodiment of the disclosure may also be applied to other communication systems having a similar technical background or a similar channel type. For example, LTE or LTE-A mobile communication and a mobile communication technology developed after 5G may be included therein. Therefore, an embodiment of the disclosure may be applied to other communication systems via some modifications without departing from the scope of the disclosure, according to determination by those skilled in the art. Contents of the disclosure are applicable in FDD and TDD systems. Hereinafter, in the disclosure, higher signaling (or higher-layer signaling) is a method of transferring a signal from a base station to a UE by using a physical layer downlink data channel or transferring a signal from a UE to a base station by using a physical layer uplink data channel, and may be referred to as RRC signaling, PDCP signaling, or a medium access control (MAC) control element (MAC CE).

In addition, in description of the disclosure, when it is determined that a detailed description of a related function or configuration may unnecessarily obscure the subject matter of the disclosure, the detailed description thereof will be omitted. Terms to be described hereinafter are terms defined in consideration of the functions in the disclosure, and may vary depending on intention or usage of users or operators. Therefore, the definitions should be made based on content throughout the specification.

Hereinafter, in description of the disclosure, higher-layer signaling may be signaling corresponding to at least one of or a combination of one or more of the following signaling types.
Master information block (MIB)
System information block (SIB) or SIB X (X=1, 2, . . . )
Radio resource control (RRC)
Medium access control (MAC) control element (CE)

In addition, L1 signaling may be signaling corresponding to at least one of or a combination of one or more of signaling methods using the following physical layer channels or signaling types.
Physical downlink control channel (PDCCH)
Downlink control information (DCI)
UE-specific DCI
Group common DCI
Common DCI
Scheduling DCI (e.g., DCI used for scheduling downlink or uplink data)
   Non-scheduling DCI (e.g., DCI not for scheduling of downlink or uplink data)
Physical uplink control channel (PUCCH)
Uplink control information (UCI)

Hereinafter, in the disclosure, determination of the priority between A and B may be mentioned in various ways, such as selecting one having a higher priority according to a predetermined priority rule so as to perform an operation corresponding thereto, or omitting or dropping an operation having a lower priority.

Hereinafter, the term “slot” used in the disclosure is a general term that may refer to a specific time unit corresponding to a transmit time interval (TTI), and specifically, a slot may refer to a slot used in a 5G NR system and may also refer to a slot or subframe used in a 4G LTE system.

Hereinafter, in the disclosure, the above examples are described via a plurality of embodiments. However, these are not independent, and one or more embodiments may be applied simultaneously or in combination.

### First Embodiment: Single TCI State Activation and Indication Method Based on a Unified TCI Scheme

As an embodiment of the disclosure, a single TCI state indication and activation method based on a unified TCI scheme is described. The unified TCI scheme may refer to a scheme of unifying and managing a transmission/reception beam management scheme which is distinguished by a spatial relation info scheme used in uplink transmission and a TCI state scheme used in downlink reception by a UE in existing Rel-15 and Rel-16. Therefore, when a UE receives an indication from a base station based on the unified TCI scheme, beam management may be performed using a TCI state even for uplink transmission. When the UE is configured with TCI-State that is higher-layer signaling having tci-stated-r17 that is higher-layer signaling from the base station, the UE may perform an operation based on the unified TCI scheme by using the corresponding TCI-State. TCI-State may exist in two types of a joint TCI state or a separate TCI state.

A first type may be the joint TCI state, and the UE may be indicated, by the base station via one TCI-State, with TCI states to be applied to both uplink transmission and downlink reception. When the UE is indicated with the joint TCI state-based TCI-State, the UE may be indicated with a parameter to be used for downlink channel estimation by using an RS corresponding to qcl-Type1 in the joint TCI state-based TCI-State and with a parameter to be used as a reception filter or a downlink reception beam by using an RS corresponding to qcl-Type2 in the joint TCI state-based TCI-State. When the UE is indicated with joint TCI state-based TCI-State, the UE may be indicated with a parameter to be used as a transmission filter or an uplink transmission beam by using an RS corresponding to qcl-Type2 in the joint DL/UL TCI state-based TCI-State. When the UE is indicated with the joint TCI state, the UE may apply the same beam to both uplink transmission and downlink reception.

A second type is the separate TCI state, and the UE may be individually indicated, by the base station, with UL TCI-State to be applied to uplink transmission and DL TCI-State to be applied to downlink reception. When the UE is indicated with a UL TCI state, the UE may be indicated with a parameter to be used as a transmission filter or an uplink transmission beam by using a reference RS or source RS configured in the UL TCI state. When the UE is indicated with a DL TCI state, the UE may be indicated with a parameter to be used for downlink channel estimation by using an RS corresponding to qcl-Type1 configured in the DL TCI state and with a parameter to be used as a reception filter or a downlink reception beam by using an RS corresponding to qcl-Type2 configured in the DL TCI state.

When the UE is indicated with both a DL TCI state and a UL TCI state, the UE may be indicated with a parameter to be used as a transmission filter or an uplink transmission beam by using a reference RS or a source RS configured in the UL TCI state, and may be indicated with a parameter to be used for downlink channel estimation by using an RS corresponding to qcl-Type1 configured in the DL TCI state and with a parameter to be used as a reception filter or a downlink reception beam by using an RS corresponding to qcl-Type2 configured in the DL TCI state. When the reference RS or source RS configured in the UL TCI state and the DL TCI state which are indicated to the UE are different, the UE may individually apply beams to uplink transmission and downlink reception, based on the indicated UL TCI state and DL TCI state.

The UE may be configured with up to 128 joint TCI states for each specific bandwidth part within a specific cell by the base station via higher-layer signaling. Up to 64 or 128 DL TCI states in separate TCI states may be configured, based on a UE capability report, for each specific bandwidth part in a specific cell via higher-layer signaling. The joint TCI state and the DL TCI state in the separate TCI state may use the same higher-layer signaling structure. According to an embodiment, when 128 joint TCI states are configured, and 64 DL TCI states in the separate TCI states are configured, the 64 DL TCI states may be included in the 128 joint TCI states.

Up to 32 or 64 UL TCI states in the separate TCI states may be configured, based on the UE capability report, for each specific bandwidth part in a specific cell via higher-layer signaling. Like the relationship between the joint TCI states and the DL TCI states in the separate TCI states, the same higher-layer signaling structure may also be used for the joint TCI states and the UL TCI states in the separate TCIs. The UL TCI states in the separate TCIs may use a higher-layer signaling structure different from that for the joint TCI states and for the DL TCI states in the separate TCI states. Using different higher-layer signaling structures or using the same higher-layer signaling structure may be defined in specifications, and may be distinguished via another higher-layer signaling configured by the base station, based on the UE capability report including information on a use scheme supportable by the UE among the two types.

The UE may receive a transmission/reception beam-related indication in the unified TCI scheme by using one scheme among the joint TCI state and the separate TCI state configured by the base station. The UE may be configured with whether to use one of the joint TCI state and the separate TCI state, by the base station via higher-layer signaling.

The UE may receive a transmission/reception beam-related indication by using one scheme selected from among the joint TCI state and the separate TCI state via higher-layer signaling. There may be two methods of indicating a transmission/reception beam that a UE receives from a base station, the methods including a MAC-CE-based indication method and a MAC-CE-based activation and DCI-based indication method.

When the UE is configured, via higher-layer signaling, to receive a transmission/reception beam-related indication by using the joint TCI state scheme, the UE may receive a MAC-CE indicating the joint TCI state from the base station and perform a transmission/reception beam application operation, and the base station may schedule, for the UE via a PDCCH, reception of a PDSCH including the MAC-CE. When there is one joint TCI state included in the MAC-CE, the UE may determine an uplink transmission beam or transmission filter and a downlink reception beam or reception filter by using the indicated joint TCI state from 3 ms after transmission of the PUCCH including HARQ-ACK information indicating the success or failure in reception of the PDSCH including the MAC-CE. When there are two or more joint TCI states included in the MAC-CE, the UE may identify that multiple joint TCI states indicated by the MAC-CE correspond to each codepoint of a TCI state field in DCI format 1_1 or 1_2 and activate the indicated joint TCI states, from 3 ms after transmission of the PUCCH including HARQ-ACK information indicating the success or failure in reception of the PDSCH including the MAC-CE. Then, the UE may receive DCI format 1_1 or 1_2 and apply one joint TCI state indicated via the TCI state field in corresponding DCI to uplink transmission and downlink reception beams. DCI format 1_1 or 1_2 may include downlink data channel scheduling information (e.g., with DL assignment) or may not include downlink data channel scheduling information (e.g., without DL assignment).

When the UE receives a transmission/reception beam-related indication by using the separate TCI state scheme via higher-layer signaling, the UE may receive a MAC-CE indicating the separate TCI state from the base station and perform a transmission/reception beam application operation, and the base station may schedule, for the UE via a PDCCH, reception of a PDSCH including the MAC-CE. When there is one separate TCI state set included in the MAC-CE, the UE may determine an uplink transmission beam or transmission filter and a downlink reception beam or reception filter by using separate TCI states included in the indicated separate TCI state set from 3 ms after transmission of the PUCCH including HARQ-ACK information indicating the success or failure in reception of the PDSCH. The separate TCI state set may refer to a single separate TCI state or multiple separate TCI states that one codepoint in the TCI state field in DCI format 1_1 or 1_2 may have. One separate TCI state set may include one DL TCI state, include one UL TCI state, or include one DL TCI state and one UL TCI state. When there are two or more separate TCI state sets included in the MAC-CE, the UE may identify that multiple separate TCI state sets indicated by the MAC-CE correspond to each codepoint of the TCI state field in DCI format 1_1 or 1_2 and activate the indicated separate TCI state sets, from 3 ms after transmission of the PUCCH including HARQ-ACK information indicating the success or failure in reception of the PDSCH. Each codepoint of the TCI state field in DCI format 1_1 or 12 may indicate one DL TCI state, indicate one UL TCI state, or indicate each of one DL TCI state and one UL TCI state. The UE may receive DCI format 1_1 or 1_2 and apply the separate TCI state set indicated by the TCI state field in corresponding DCI to uplink transmission and downlink reception beams. DCI format 1_1 or 1_2 may include downlink data channel scheduling information (e.g., with DL assignment) or may not include downlink data channel scheduling information (e.g., without DL assignment).

The MAC-CE used to activate or indicate the aforementioned single joint TCI state and separate TCI state may exist separately for each of the joint TCI state scheme and the separate TCI state scheme. Alternatively, a TCI state may be activated or indicated based on one of the joint TCI state scheme and the separate TCI state scheme by using one MAC-CE. According to various embodiments of the disclosure, various MAC-CE structures for activation and indication of the joint or separate TCI state may be considered.

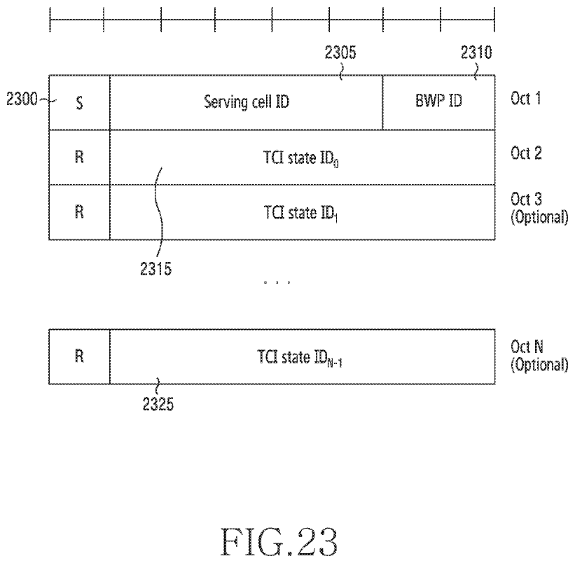

FIG. 23 illustrates an example of a MAC-CE structure for joint TCI state activation and indication in the wireless communication system according to an embodiment of the disclosure. Referring to FIG. 23, when a value of an S field 2300 is 1, a corresponding MAC-CE may indicate one joint TCI state and may have a length of only up to a second octet. If the value of the S field 2300 is 0, the MAC-CE may include two or more pieces of joint TCI state information, and each joint TCI state may be activated in each codepoint of a TCI state field in DCI format 1_1 or 1_2. In addition, up to eight joint TCI states may be activated. TCI states indicated via a TCI state ID₀ field 2315 to a TCI state ID_{N-1} field 2325 may correspond to a zeroth codepoint to an (N−1)th codepoint of the TC state field in DCI format 1_1 or 1_2, respectively. A serving cell ID field 2305 and a BWP ID field 2310 may indicate a serving cell ID and a bandwidth part ID, respectively.

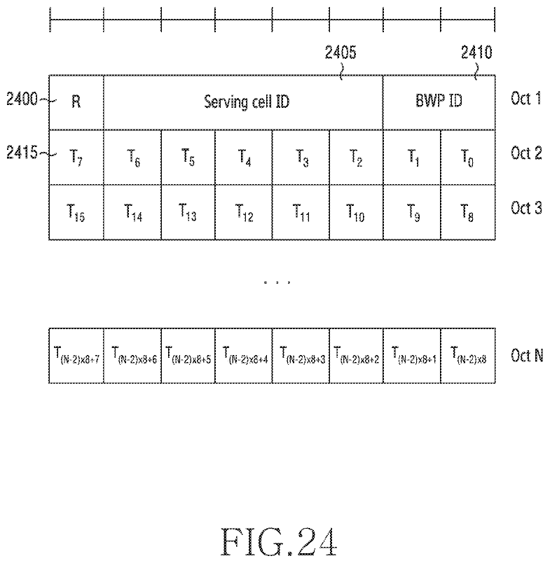

FIG. 24 illustrates an example of a MAC-CE structure for joint TCI state activation and indication in the wireless communication system according to an embodiment of the disclosure. Referring to FIG. 24, a serving cell ID field 2405 and a BWP ID field 2410 may indicate a serving cell ID and a bandwidth part ID, respectively. Field R 2400 may be a 1-bit reserve field that does not include indication information. Each field existing in a second octet to an N-th octet may be a bitmap indicating each joint TCI state configured via higher-layer signaling. According to an embodiment. T₇ 2415 may be a field indicating whether an eighth joint TCI state configured via higher-layer signaling is indicated. Referring to FIG. 24, when there is one joint TCI state transferred via a MAC-CE structure, a UE may apply the joint TCI state indicated via the MAC-CE to uplink transmission and downlink reception beams. When there are two or more joint TCI states transferred via the MAC-CE structure, the UE may identify that each joint TCI state indicated by the MAC-CE corresponds to each codepoint of a TCI state field in DCI format 1_1 or 1_2 and activate each joint TCI state. Starting from a joint TCI state having a lowest index, the indicated joint TCI states may sequentially correspond to codepoints with low indexes of the TCI state field so as to be activated.

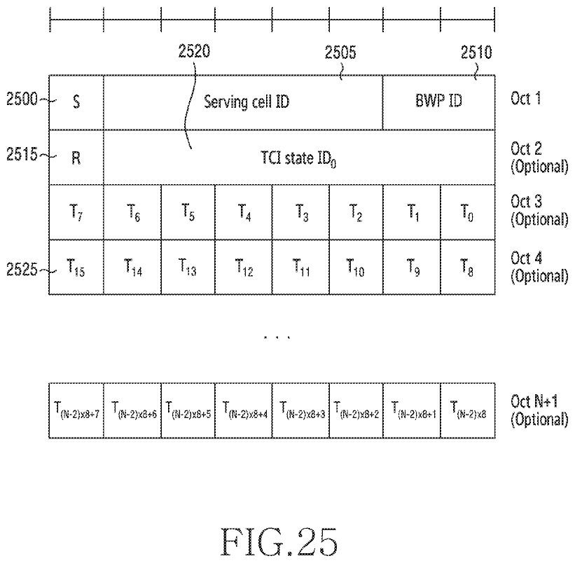

FIG. 25 illustrates an example of a MAC-CE structure for joint TCI state activation and indication in the wireless communication system according to an embodiment of the disclosure. Referring to FIG. 25, a serving cell ID field 2505 and a BWP ID field 2510 may indicate a serving cell ID and a bandwidth part ID, respectively. According to an embodiment, when a value of an S field 2500 is 1, a corresponding MAC-CE may indicate one joint TCI state, and may include only up to a second octet. The joint TCI state may be indicated to a UE via a TCI state ID₀ field 2520.

According to an embodiment, when the value of the S field 2500 is 0, the MAC-CE may include two or more pieces of joint TCI state information. Each codepoint of a TCI state field in DCI format 1_1 or 1_2 may cause activation of each joint TCI state. Up to eight joint TCI states may be activated, and no second octet may exist. Referring to FIG. 25, there may be a first octet and a third octet to an (N+1)th octet in the MAC-CE structure. Respective fields existing in the third octet to the (N+1)th octet may be bitmaps indicating respective joint TCI states configured via higher-layer signaling. According to an embodiment, T₁₅ 2525 may be a field indicating whether a 16th joint TCI state configured via higher-layer signaling is indicated.

When there is one joint TCI state transferred via the MAC-CE structure in FIG. 25, the UE may apply the joint TCI state indicated via the MAC-CE to uplink transmission and downlink reception beams. When there are two or more joint TCI states transferred via the MAC-CE structure, the UE may identify that each joint TCI state indicated by the MAC-CE corresponds to each codepoint of the TCI state field in DCI format 1_1 or 1_2 and activate each joint TCI state. Starting from a joint TCI state having a lowest index, the indicated joint TCI states may sequentially correspond to codepoints with low indexes of the TCI state field so as to be activated.

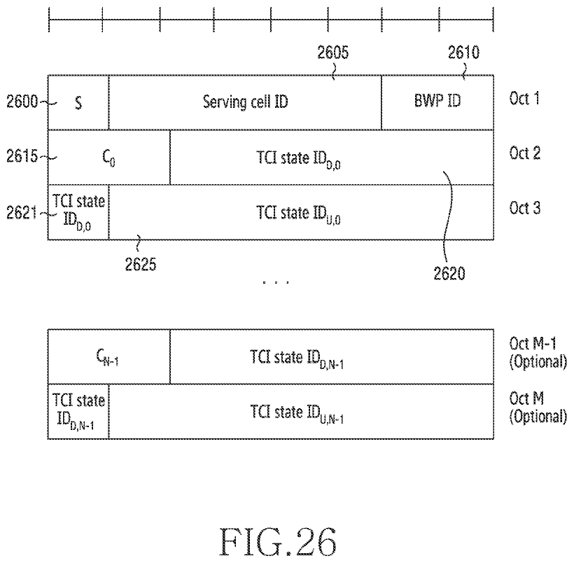

FIG. 26 illustrates an example of a MAC-CE structure for separate TCI state activation and indication in the wireless communication system according to an embodiment of the disclosure. Referring to FIG. 26, a serving cell ID field 2605 and a BWP ID field 2610 may indicate a serving cell ID and a bandwidth part ID, respectively. According to an embodiment, when a value of an S field 2600 is 1, a corresponding MAC-CE may indicate one separate TCI state set, and may include only up to a third octet.

According to an embodiment, when the value of the S field 2600 is 0, the MAC-CE may include two or more pieces of separate TCI state set information. Respective codepoints of a TCI state field in DCI format 1_1 or 1_2 may cause activation of respective separate TCI state sets, and up to 8 separate TCI state sets may be activated. A C₀ field 2615 may be a field indicating separate TCI states included in the indicated separate TCI state set. According to an embodiment, a C₀ field value of “0” may indicate reserve, a C₀ field value of “01” may indicate one DL TCI state, a C₀ field value of “10” may indicate one UL TCI state, and a C₀ field value of “11” may indicate one DL TCI state and one UL TCI state. However, the disclosure is not limited by these specific values. A TC state ID_{D,0} field 2620 and a TCI state ID_{U,0} field 2625 may refer to a DL TCI state and a UL TCI state which may be included in a zeroth separate TCI state set so as to be indicated, respectively. When the C₀ field value is “01”, the TCI state ID_{D,0} field 2620 may indicate a DL TCI state, and the TCI state ID_{U,0} field 2625 may be ignored. When the C₀ field value is “10”, the TCI state ID_{D,0} field 2620 may be ignored, and the TCI state ID_{U,0} field 2625 may indicate a UL TCI state. When the C₀ field value is “11”, the TCI state ID_{D,0} field 2620 may indicate a DL TCI state, and the TCI state ID_{U,0} field 2625 may indicate a UL TCI state.

FIG. 26 may illustrate an example of a MAC CE when a UL TCI state in separate TCI states uses the same higher-layer signaling structure as that for a joint TCI state and for a DL TCI state in the separate TCI states, as described above. Accordingly, lengths of the TCI state ID_{D,0} field 2620 and the TCI state ID_{U,0} field 2625 may be 7 bits to express up to 128 TCI states. Therefore, in order to use 7 bits for the TCI state ID_{D,0} field 2620, 6 bits 2620 may be assigned to a second octet and 1 bit 2621 may be assigned to a third octet. In addition. FIG. 26 may indicate a case in which a UL TCI state in separate TCI states uses a higher-layer signaling structure different from that for a joint TCI state and for a DL TCI state in the separate TCI states, as described above. Accordingly, since the UL TCI state requires 6 bits capable of expressing up to 64 UL TCI states, a first bit of the TCI state ID_{U,0} field 2625 may be fixed to 0 or 1, and actual bits expressing the UL TCI state may correspond to only a total of 6 bits from a second bit to a seventh bit.

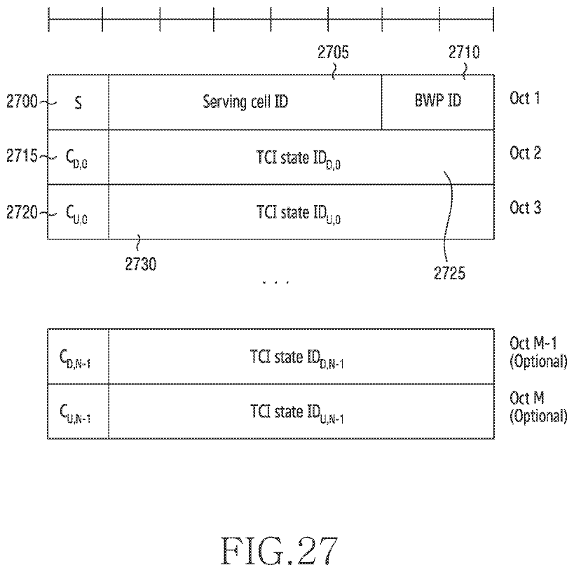

FIG. 27 illustrates an example of a MAC-CE structure for separate TCI state activation and indication in the wireless communication system according to an embodiment of the disclosure. Referring to FIG. 27, a serving cell ID field 2705 and a BWP ID field 2710 may indicate a serving cell ID and a bandwidth part ID, respectively. According to an embodiment, when a value of an S field 2700 is 1, a corresponding MAC-CE may indicate one separate TCI state set, and may include only up to a third octet. According to an embodiment, when the value of the S field 2700 is 0, the MAC-CE may include two or more pieces of separate TCI state set information. Respective codepoints of a TCI state field in DCI format 1_1 or 1_2 may correspond to respective separate TCI state sets so as to cause activation of the respective separate TCI state sets, and up to 8 separate TCI state sets may be activated. A C_{D,0} field 2715 may be a field indicating whether the indicated separate TCI state set includes a DL TCI state. When a value of the C_{D,0} field 2715 is 1, a DL TCI state may be included, and the DL TCI state may be indicated via a TCI state ID_{D,0} field 2725, and when the value of the C_{D,0} field 2715 is 0, no DL TCI state may be included, and the TCI state ID_{D,0} field 2725 may be ignored. Similarly, a C_{U,0} field 2720 may be a field indicating whether the indicated separate TCI state set includes a UL TCI state, wherein, when a value of the C_{U,0} field is 1, a UL TCI state may be included, and the UL TCI state may be indicated via a TCI state ID_{U,0} field 2730, or when the value of the C_{U,0} field is 0, no UL TCI state may be included and the TCI state ID_{U,0} field 2730 may be ignored.

FIG. 27 illustrates an example of a MAC CE when a UL TCI state in separate TCI states uses the same higher-layer signaling structure as that for a joint TCI state and for a DL TCI state in the separate TCI states, as described above. Accordingly, lengths of the TCI state ID_{D,0} field 2725 and the TCI state ID_{U,0} field 2730 may be 7 bits to express up to 128 TCI states. FIG. 27 may illustrate an example of a MAC CE when a UL TCI state in separate TCI states uses a higher-layer signaling structure different from that for a joint TCI state and for a DL TCI state in the separate TCI states, as described above. Accordingly, since the UL TCI state requires 6 bits capable of expressing up to 64 UL TCI states, a first bit of the TCI state ID_{U,0} field 2725 may be fixed to 0 or 1, and actual bits expressing the UL TCI state may correspond to only a total of 6 bits from a second bit to a seventh bit.

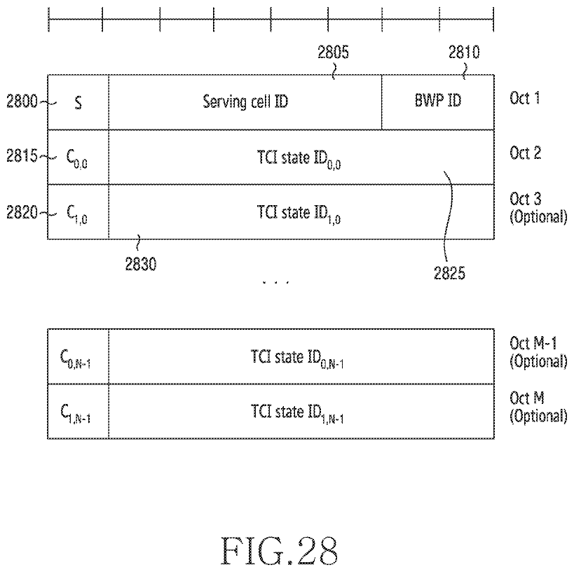

FIG. 28 illustrates an example of a MAC-CE structure for separate TCI state activation and indication in the wireless communication system according to an embodiment of the disclosure. Referring to FIG. 28, a serving cell ID field 2805 and a BWP ID field 2810 may indicate a serving cell ID and a bandwidth part ID, respectively. According to an embodiment, when a value of an S field 2800 is 1, a corresponding MAC-CE may indicate one separate TCI state set, and may include only up to a third octet. Referring to FIG. 28, in a MAC-CE structure, two octets may be used to indicate one separate TCI state set. When the separate TCI state set includes a DL TCI state, a first octet of the two octets may always indicate the DL TCI state, and a second octet may always indicate a UL TCI state. Alternatively, this order may be changed.

According to an embodiment, when the value of the S field 2800 is 0, the MAC-CE may include two or more pieces of separate TCI state set information. Respective codepoints of a TCI state field in DCI format 1_1 or 1_2 may cause activation of respective separate TCI state sets, and up to 8 separate TCI state sets may be activated. A C_{0,0} field 2815 may have a meaning for distinguishing whether a TCI state indicated by a TCI state ID_{0,0} field 2825 is a DL TCI state or a UL TCI state. A C_{0,0} field 2815 value of 1 may indicate a DL TCI state, the DL TCI state may be indicated via the TCI state ID_{0,0} field 2825, and a third octet may exist. In this case, when a value of a C_{1,0} field 2820 is 1, a UL TCI state may be indicated via a TCI state ID_{1,0} field 2830, and when the value of the C_{1,0} field 2820 is 0, the TCI state ID_{1,0} field 2830 may be ignored. If the value of the C_{0,0} field 2815 is 0, a UL TCI state, may be indicated via the TCI state ID_{0,0} field 2825, and no third octet may exist. However, depending on various embodiments, these examples are merely examples.

FIG. 28 may illustrate an example of a MAC CE when a UL TCI state in separate TCI states uses the same higher-layer signaling structure as that for a joint TCI state and for a DL TCI state in the separate TCI states, as described above. Accordingly, lengths of the TCI state ID_{0,0} field 2825 and the TCI state ID_{1,0} field 2830 may be 7 bits to express up to 128 TCI states. FIG. 28 may illustrate an example of a MAC CE when a UL TCI state in separate TCI states uses a higher-layer signaling structure different from that for a joint TCI state and for a DL TCI state in the separate TCI states, as described above. Accordingly, the TCI state ID_{0,0} field 2825 may be 7 bits capable of expressing both 6 bits capable of expressing up to 64 possible UL TCI states and 7 bits capable of expressing up to 128 possible DL TCI states. If the value of the C_{1,0} field 2815 is 1 and thus the TCI state ID_{0,0} field 2825 indicates a UL TCI state, a first bit of the TCI state ID_{0,0} field 2825 may be fixed to 0 or 1, and actual bits expressing the UL TCI state may correspond to only a total of 6 bits from a second bit to a seventh bit.

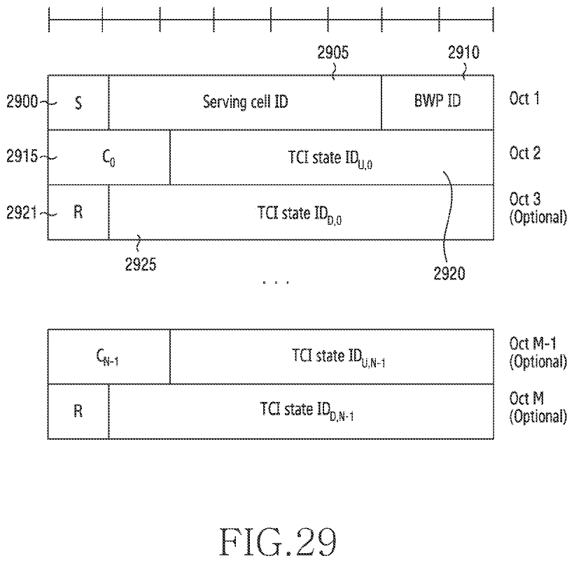

FIG. 29 illustrates an example of a MAC-CE structure for separate TCI state activation and indication in the wireless communication system according to an embodiment of the disclosure. Referring to FIG. 29, a serving cell ID field 2905 and a BWP ID field 2910 may indicate a serving cell ID and a bandwidth part ID, respectively. According to an embodiment, when a value of an S field 2900 is 1, a corresponding MAC-CE may indicate one separate TCI state set, and may include only up to a third octet.

According to an embodiment, when the value of the S field 2900 is 0, the MAC-CE may include two or more pieces of separate TCI state set information. Respective codepoints of a TCI state field in DCI format 1_1 or 1_2 may cause activation of respective separate TCI state sets, and up to 8 separate TCI state sets may be activated. A C₀ field 2915 may be a field indicating separate TCI states included in the indicated separate TCI state set, a C₀ field value of “0” may indicate reserve, a C₀ field value of “01” may indicate one DL TCI state, a C₀ field value of “10” may indicate one UL TCI state, and a C₀ field value of “11” may indicate one DL TCI state and one UL TCI state. However, the disclosure is not limited to the specific values described according to various embodiments. A TCI state ID_{U,0} field 2920 and a TCI state ID_{U,0} field 2925 may refer to a UL TCI state and a DL TCI state which may be included in a zeroth separate TCI state set so as to be indicated, respectively. When the value of the C₀ field 2915 is “01”, the TCI state ID_{D,0} field 2925 may indicate a DL TCI state, and the TCI state ID_{U,0} field 2920 may be ignored. When the value of the C₀ field 2915 is “10”, a third octet may be ignored, and the TCI state ID_{U,0} field 2920 may indicate a UL TCI state. When the value of the C₀ field 2915 is “11”, the TCI state ID_{D,0} field 2925 may indicate a DL TCI state, and the TCI state ID_{U,0} field 2920 may indicate a UL TCI state.

FIG. 29 may illustrate an example of a MAC CE used when a UL TCI state in separate TC states uses a higher-layer signaling structure different from that for a joint TCI state and for a DL TCI state in the separate TCI states, as described above. Accordingly, 7 bits may be used to express up to 128 TCI states for a length of the TCI state ID_{D,0} field 2925, and 6 bits may be used to express up to 64 TCI states for a length of the TCI state ID_{U,0} field 2920.

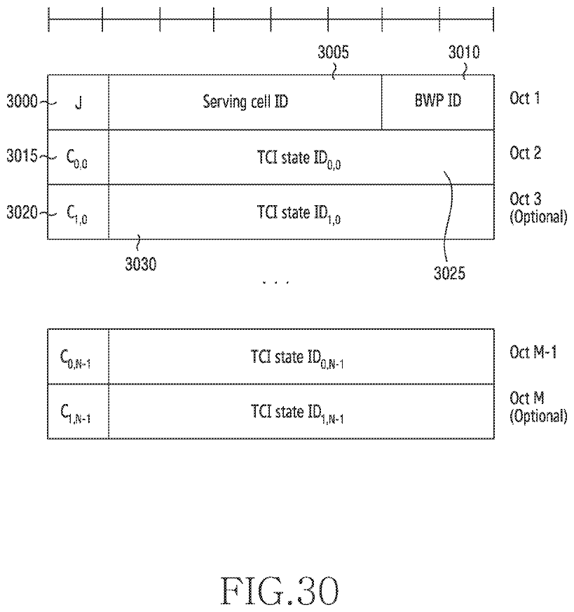

FIG. 30 illustrates an example of a MAC-CE structure for joint and separate TCI state activation and indication in the wireless communication system according to an embodiment of the disclosure. Referring to FIG. 30, a serving cell ID field 3005 and a BWP ID field 3010 may indicate a serving cell ID and a bandwidth part ID, respectively. According to an embodiment, when a value of a J field 3000 is 1, a corresponding MAC-CE may indicate a joint TCI state. When the value of the J field 3000 is 0, the MAC-CE may indicate a separate TCI state set.

When the MAC-CE indicates a joint TCI state, all odd-numbered octets (a third octet, a fifth octet, . . . ) other than a first octet may be ignored. A C_{0,0} field 3015 may indicate whether the MAC-CE indicates one joint TCI state or includes two or more pieces of TCI state information, and may indicate whether each codepoint of a TCI state field in DCI format 1_1 or 1_2 causes activation of each TCI state. When a value of the C_{0,0} field 3015 is 1, the MAC-CE may indicate one joint TCI state, and a third octet and a subsequent octet may not exist. When the value of the C_{0,0} field 3015 is 0, two or more joint TCI states indicated by the MAC-CE may correspond to each codepoint of the TCI state field in DCI format 1_1 or 1_2 and may be activated. A TCI state ID_{0,0} may refer to an indicated first joint TCI state.

When the MAC-CE indicates a separate TCI state set, according to an embodiment, the C_{0,0} field 3015 may have a meaning for distinguishing whether a TCI state indicated by a TCI state ID_{0,0} field 3025 is a DL TCI state or a UL TCI state. When the value of the C_{0,0} field 3015 is 1, this may indicate a DL TCI state, the DL TCI state may be indicated via the TCI state ID_{D,0} field 3025, and a third octet may exist. In this case, when a value of a C_{1,0} field 3020 is 1, a UL TCI state may be indicated via a TCI state ID_{1,0} field 3030, and when the value of the C_{1,0} field 3020 is 0, the TCI state ID_{1,0} field 3030 may be ignored. When the value of the C_{0,0} field 3015 is 0, a UL TCI state may be indicated via the TCI state ID_{0,0} field 3025, and no third octet may exist. FIG. 30 may illustrate an example of a MAC-CE used when a UL TCI state in separate TCI states uses the same higher-layer signaling structure as that for a joint TCI state and for a DL TCI state in the separate TCI states, as described above. Accordingly, lengths of the TCI state ID_{0,0} field 3025 and the TCI state ID_{1,0} field 3030 may be 7 bits to express up to 128 TCI states. In addition, FIG. 30 may illustrate an example of a MAC-CE used when a UL TCI state in separate TCI states uses a higher-layer signaling structure different from that for a joint TCI state and for a DL TCI state in the separate TCI states, as described above. Accordingly, the TCI state ID_{0,0} field 3025 may use 7 bits capable of expressing both 6 bits capable of expressing up to 64 possible UL TCI states and 7 bits capable of expressing up to 128 possible DL TCI states. When the value of the C_{0,0} field 3015 is 1 and thus the TCI state ID_{0,0} field 3025 indicates a UL TCI state, a first bit of the TCI state ID_{0,0} field 3025 may be fixed to 0 or 1, and actual bits expressing the UL TCI state may correspond to only a total of 6 bits from a second bit to a seventh bit.

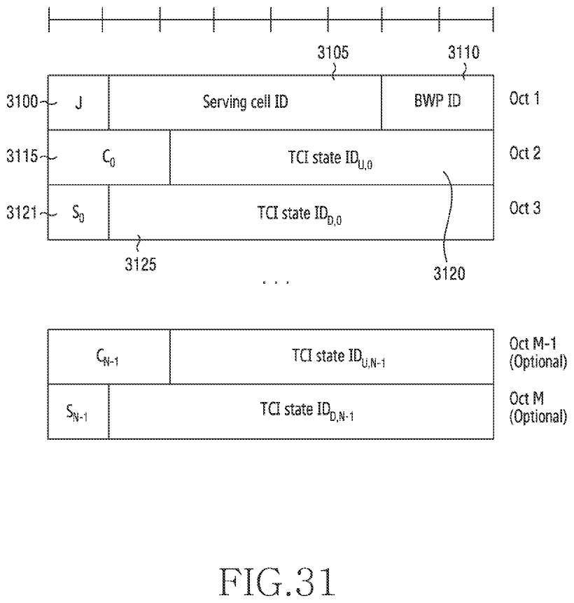

FIG. 31 illustrates an example of another MAC-CE structure for joint and separate TCI state activation and indication in the wireless communication system according to an embodiment of the disclosure. In FIG. 31, a serving cell ID field 3105 and a BWP ID field 3110 may indicate a serving cell ID and a bandwidth part ID, respectively. According to an embodiment, when a value of a J field 3100 is 1, a corresponding MAC-CE may indicate a joint TCI state, and when the value of the J field 3100 is 0, the MAC-CE may indicate a separate TCI state set.

When the MAC-CE indicates a joint TCI state, all even-numbered octets (a second octet, a fourth octet, . . . ) other than a first octet may be ignored. An S₀ field 3121 may indicate whether the MAC-CE indicates one joint TCI state or whether two or more TCI states correspond to each codepoint of a TCI state field in DCI format 1_1 or 1_2 and are activated. When a value of the S₀ field 3121 is 1, the MAC-CE may indicate one joint TCI state, and a third octet and a subsequent octet may not exist. When the value of the S₀ field 3121 is 0, the MAC-CE may include two or more pieces of joint TCI state information, and each codepoint of the TCI state field in DCI format 1_1 or 1_2 may cause activation of each joint TCI state. A TCI state ID_{D,0} may refer to an indicated first joint TCI state.

When the MAC-CE indicates a separate TCI state set, a C₀ field 3115 may be a field indicating separate TCI states included in the indicated separate TCI state set, a C₀ field value of “0” may indicate reserve, a C₀ field value of “01” may indicate one DL TCI state, a C₀ field value of “10” may indicate one UL TCI state, and a C₀ field value of “11” may indicate one DL TCI state and one UL TCI state. These values are merely examples and the disclosure is not limited by these examples. A TCI state ID_{U,0} field 3120 and a TCI state ID_{D,0} field 3125 may refer to a UL TCI state and a DL TCI state which may be included in a zeroth separate TCI state set so as to be indicated, respectively. When the value of the C₀ field 3115 is “01”, the TCI state ID_{D,0} field 3125 may indicate a DL TCI state, and the TCI state ID_{U,0} field 3120 may be ignored. When the value of the C₀ field 3115 is “10”, the TCI state ID_{U,0} field 3120 may indicate a UL TCI state. When the value of the C₀ field 3115 is “11”, the TCI state ID_{D,0} field 3125 may indicate a DL TCI state, and the TCI state ID_{U,0} field 3120 may indicate a UL TCI state. When the value of the S₀ field 3121 is 1, the MAC-CE may indicate one separate TCI state set, and a fourth octet and a subsequent octet may not exist. When the value of the S₀ field 3121 is 0, the MAC-CE may include two or more pieces of separate TCI state set information, each codepoint of the TCI state field in DCI format 1_1 or 1_2 may cause activation of each separate TCI state set, and up to 8 separate TCI state sets may be activated. For example, when the value of the S₀ field 3121 is 0, if values of C₁, . . . , C_{N-1} fields are “10”, this indicates that only UL TCI states are indicated, so that a fifth octet, a seventh octet, . . . , an Mth octet may be ignored. An Sₙ field may indicate whether an octet for a subsequent separate TCI state set exists. According to an embodiment, when a value of the Sₙ field is 1, a subsequent octet may not exist, and when the value of the Sₙ field is 0, subsequent octets including Cₙ₊₁ and TCI state ID_{U,n+1} may exist.

FIG. 31 may illustrate an example of a MAC CE when a UL TCI state in separate TCI states uses a higher-layer signaling structure different from that for a joint TCI state and for a DL TCI state in the separate TCI states, as described above. Accordingly, a length of the TCI state ID_{D,0} field 3125 may be 7 bits to express up to 128 TCI states, and a length of the TCI state ID_{U,0} field 3120 may be 6 bits to express up to 64 TCI states.

When a UE receives a transmission/reception beam-related indication by using the joint TC state scheme or the separate TCI state scheme via higher-layer signaling, the UE may receive a PDSCH including a MAC-CE indicating a joint TCI state or a separate TCI state from a base station so as to perform application to a transmission/reception beam. When there are two or more joint TCI states or separate TCI state sets included in the MAC-CE, as described above, the UE may identify that multiple joint TCI states or separate TCI state sets indicated by the MAC-CE correspond to each codepoint of the TCI state field in DCI format 1_1 or 1_2 and activate the indicated joint TCI states or separate TCI state sets, from 3 ms after transmission of a PUCCH including HARQ-ACK information indicating the success or failure in reception of the PDSCH. Then, the UE may receive DCI format 1_1 or 1_2 and apply one joint TCI state or separate TCI state set indicated by a TCI state field in corresponding DCI to uplink transmission and downlink reception beams. In this case, DCI format 1_1 or 1_2 may include downlink data channel scheduling information (e.g., with DL assignment) or may not include downlink data channel scheduling information (e.g., without DL assignment).

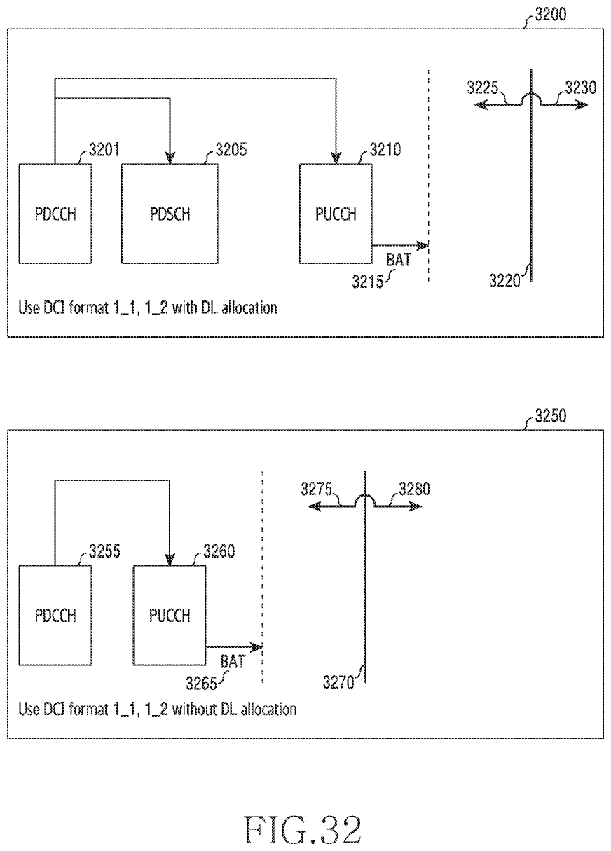

FIG. 32 illustrates a beam application time that may be considered when a unified TCI scheme is used in the wireless communication system according to an embodiment of the disclosure. As described above, a UE may receive DCI format 1_1 or 1_2 which includes downlink data channel scheduling information (with DL assignment) or does not include downlink data channel scheduling information (without DL assignment) from a base station, and apply one joint TCI state or separate TCI state set indicated by a TCI state field in corresponding DCI to uplink transmission and downlink reception beams.

DCI format 1_1 or 1_2 with DL assignment 3200: When the UE receives 3201 DCI format 1_1 or 1_2 including downlink data channel scheduling information from the base station and indicates one joint TCI state or separate TCI state set based on the unified TCI scheme, the UE may receive 3205 a PDSCH scheduled based on the received DCI, and transmit 3210 a PUCCH including HARQ-ACK indicating the success or failure in reception of the PDSCH and the DCI. In this case, the HARQ-ACK may include the success or failure in reception of both the DCI and the PDSCH, the UE may transmit NACK when reception of at least one of the DCI and the PDSCH has failed. The UE may transmit ACK when both the DCI and PDSCH have been successfully received.

DCI format 1_1 or 1_2 without DL assignment 3250: When the UE receives 3255 DCI format 1_1 or 1_2 including no downlink data channel scheduling information from the base station and indicates one joint TCI state or separate TCI state set based on the unified TCI scheme, the UE may assume the following for the DCI.
CRC scrambled using CS-RNTI is included.
Values of all bits assigned to all fields used as a redundancy version (RV) field are 1.
Values of all bits assigned to all fields used as a modulation and coding scheme (MCS) field are 1.
Values of all bits assigned to all fields used as a new data indication (NDI) field are 0.
Values of all bits assigned to a frequency domain resource allocation (FDRA) field are 0 for FDRA type 0, values of all bits assigned to the FDRA field are 1 for FDRA type 1, and values of all bits assigned to the FDRA field are 0 when an FDRA scheme is dynamicSwitch.

The UE may transmit 3260 a PUCCH including HARQ-ACK indicating the success or failure in reception of DCI format 1_1 or 1_2 for which the descriptions above have been assumed.

For both DCI format 1_1 or 1_2 with DL assignment 3200 and without DL assignment 3250, if a new TCI state indicated via the DCI 3201 or 3255 is the same as a TCI state which has already been indicated and applied to uplink transmission and downlink reception beams, the UE may maintain the previously applied TCI state. If the new TCI state is different from the previously indicated TCI state, the UE may determine that a time point of applying the joint TCI state or separate TCI state set, which may be indicated from the TCI state field included in the DCI, is applied (e.g., interval of 3230 or 3280) from a start point 3220 or 3270 of a first slot after a beam application time (BAT) 3215 or 3265 subsequent to PUCCH transmission, and may use the previously indicated TCI-state until an interval 3225 or 3275 before the start point 3220 or 3270 of the slot.

For both DCI format 1_1 or 1_2 with DL assignment 3200 and without DL assignment 3250, the BAT is a specific number of OFDM symbols and may be configured via higher-layer signaling based on UE capability report information. The BAT and a numerology for the first slot after the BAT may be determined based on a smallest numerology among all cells to which the joint TCI state or separate TCI state set indicated via the DCI is applied.

The UE may apply one joint TCI state indicated via the MAC-CE or DCI to reception of control resource sets linked to all UE-specific search spaces, reception of a PDSCH scheduled via a PDCCH transmitted from a corresponding control resource set, transmission of a PUSCH, and transmission of all PUCCH resources.

When one separate TCI state set indicated via the MAC-CE or DCI includes one DL TCI state, the UE may apply the one separate TCI state set to reception of control resource sets linked to all UE-specific search spaces, and reception of a PDSCH scheduled via a PDCCH transmitted from a corresponding control resource set, and the UE may apply the one separate TCI state set to all PUSCH and PUCCH resources, based on a previously indicated UL TCI state.

When one separate TCI state set indicated via the MAC-CE or DCI includes one UL TCI state, the UE may apply the one separate TCI state set to all PUSCH and PUCCH resources, and the UE may apply, based on the previously indicated DL TCI state, the one separate TCI state set to reception of control resource sets linked to all UE-specific search spaces and reception of a PDSCH scheduled via a PDCCH transmitted from a corresponding control resource set.

When one separate TCI state set indicated via the MAC-CE or DCI includes one DL TCI state and one UL TCI state, the UE may apply the DL TCI state to reception of control resource sets linked to all UE-specific search spaces and reception of a PDSCH scheduled via a PDCCH transmitted from a corresponding control resource set, and may apply the UL TCI state to all PUSCH and PUCCH resources.

In the aforementioned examples of the MAC CE in FIG. 23 to FIG. 31, it is possible that at least one of the elements are coupled to each other.

### Second Embodiment: Multi-TCI State Indication and Activation Method Based on the Unified TCI Scheme

As an embodiment of the disclosure, a multi-TCI state indication and activation method based on the unified TCI scheme is described. The multi-TCI state indication and activation method may refer to a case in which the number of indicated joint TCI states is extended to two or more and a case in which each of a DL TCI state and a UL TCI state included in one separate TCI state set is expanded to two or more. When one separate TCI state set includes up to two DL TCI states and up to two UL TCI states, a total of 8 combinations of DL TCI states and UL TCI states, which the one separate TCI state set can have, may be possible ({DL,UL}={0,1}, {0,2}, {1,0}, {1,1}, {1,2}, {2,0}, {2,1}, {2,2} where numbers indicate the number of TCI states).

When a UE is indicated with multiple TCI states based on a MAC-CE by a base station, the UE may receive two or more joint TCI states or one separate TCI state set from the base station via the MAC-CE. The base station may schedule reception of a PDSCH including the MAC-CE for the UE via a PDCCH, and from 3 ms after transmission of a PUCCH including HARQ-ACK information indicating the success or failure in reception of the PDSCH including the MAC-CE, the UE may determine an uplink transmission beam or transmission filter and a downlink reception beam or reception filter, based on the indicated two or more joint TCI states or one separate TCI state set.

When the UE is indicated with multiple TCI states based on DCI format 1_1 or 1_2 from the base station, each codepoint of one TCI state field in DCI format 1_1 or 1_2 may indicate two or more joint TCI states or two or more separate TCI state sets. The UE may receive a MAC-CE from the base station and activate two or more joint TCI states or two or more separate TCI state sets corresponding to each codepoint of one TCI state field in DCI format 1_1 or 1_2. The base station may schedule reception of a PDSCH including the MAC-CE for the UE via a PDCCH, and the UE may activate TCI state information included in the MAC-CE from 3 ms after transmission of a PUCCH including HARQ-ACK information indicating the success or failure in reception of the PDSCH including the MAC-CE.

When the UE is indicated with multiple TCI states based on DCI format 1_1 or 1_2 from the base station, two or more TCI state fields may exist in DCI format 1_1 or 1_2, and one of two or more joint TCI states or two or more separate TCI state sets may be indicated based on each TCI state field. The UE may receive a MAC-CE from the base station and activate joint TCI states or separate TCI state sets corresponding to each codepoint of the two or more TCI state fields in DCI format 1_1 or 1_2. The base station may schedule reception of a PDSCH including the MAC-CE for the UE via a PDCCH. The UE may activate TCI state information included in the MAC-CE from 3 ms after transmission of a PUCCH including HARQ-ACK information indicating the success or failure in reception of the PDSCH including the MAC-CE. The UE may be configured with the presence or absence of one or more additional TCI state fields via higher-layer signaling. A bit length of the additional TCI state field may be the same as that of an existing TCI state field, or may be adjusted based on higher-layer signaling.

The UE may receive a transmission/reception beam-related indication in the unified TCI scheme by using one scheme among the joint TCI state and separate TCI state configured by the base station. Using one of the joint TCI state or the separate TCI state may be configured for the UE by the base station via higher-layer signaling. For the separate TCI state indication, the UE may be configured via higher-layer signaling so that a bit length of the TCI state field in DCI format 1_1 or 1_2 is up to 4.

The MAC-CE used to activate or indicate the multiple joint TCI states and separate TCI states described above may exist for each of the joint and separate TCI state schemes, and TCI states may be activated or indicated based on one of the joint TCI state scheme or the separate TCI state scheme by using one MAC-CE. For the MAC-CE used in the MAC-CE-based indication scheme and the MAC-CE-based activation scheme, one MAC-CE structure may be shared, and individual MAC-CE structures may be used. According to various embodiments of the disclosure, various MAC-CE structures for activation and indication of multiple joint or separate TCI states may be considered. According to embodiments of the disclosure, for the convenience of description, a case in which two TCI states are activated or indicated has been considered, but the disclosure may be applied to a case of three or more TCI states in a similar manner.

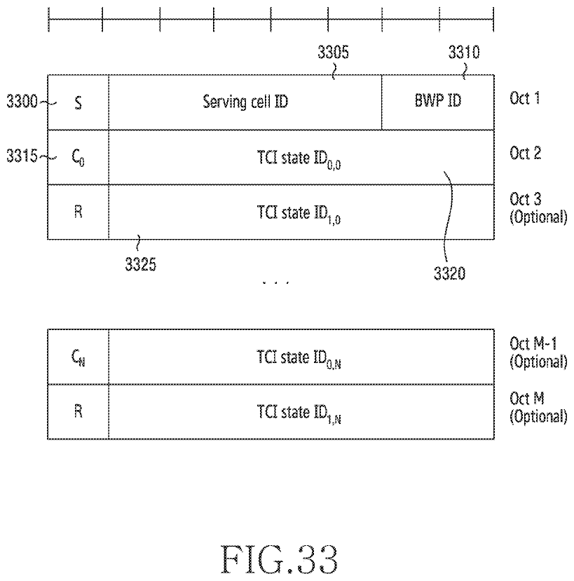

FIG. 33 illustrates an example of a MAC-CE structure for activation and indication of multiple joint TCI states in the wireless communication system according to an embodiment of the disclosure. Referring to FIG. 33, a serving cell ID field 3305 and a BWP ID field 3310 may indicate a serving cell ID and a bandwidth part ID, respectively. According to an embodiment, when a value of an S field 3300 is 1, a corresponding MAC-CE may indicate one or two joint TCI states and may have a length of only up to a third octet. When a value of a C₀ field 3315 is 0, no third octet may exist, and one joint TCI state may be indicated via a TCI state ID_{0,0} field 3320. When a value of the C₀ field 3315 is 0, no third octet may exist, and two joint TCI states may be indicated via the TCI state ID_{0,0} field 3320 and a TCI state ID_{1,0} field 3325, respectively.

According to an embodiment, when the value of the S field 3300 is 0, the MAC-CE may activate one or two joint TCI states corresponding to each codepoint of a TCI state field in DCI format 1_1 or 1_2, or may activate one joint TCI state corresponding to each codepoint of two TCI state fields of DCI format 1_1 or 1_2, and joint TCI states for up to 8 codepoints may be activated. When one or two joint TCI states are activated for one codepoint of one TCI state field, a TCI state ID_{0,Y} field and a TCI state ID_{1,Y} field may refer to first and second joint TCI states among two joint TCI states activated at a Y-th codepoint of the TCI state field, respectively. When one joint TCI state is activated for one codepoint of two TCI state fields, the TCI state ID_{0,Y} field and the TCI state ID_{1,Y} field may refer to respective joint TCI states activated at Y-th codepoints of respective first and second TCI state fields.

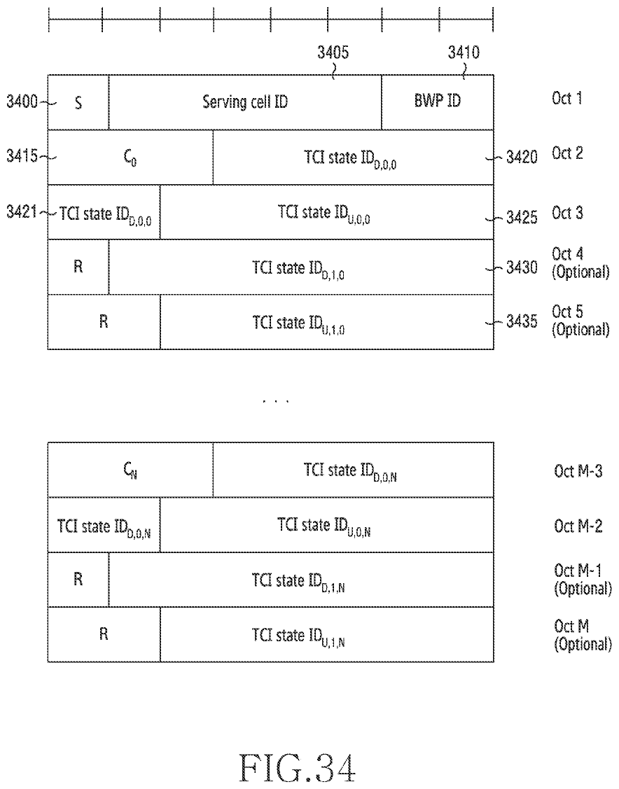

FIG. 34 illustrates an example of a MAC-CE structure for activation and indication of multiple separate TCI states in the wireless communication system according to an embodiment of the disclosure. In FIG. 34, a serving cell ID field 3405 and a BWP ID field 3410 may indicate a serving cell ID and a bandwidth part ID, respectively. When a value of an S field 3400 is 1, a corresponding MAC-CE may indicate one separate TCI state set and may include only up to a fifth octet. When the value of the S field 3400 is 0, the MAC-CE may include information on multiple separate TCI state sets. The MAC-CE may activate one separate TCI state set corresponding to each codepoint of a TCI state field in DCI format 1_1 or 1_2, activate one separate TCI state set corresponding to each codepoint of two TCI state fields in DCI format 1_1 or 1_2, or activate, as described above, separate TCI states for up to 8 or 16 codepoints via higher-layer signaling.

In the MAC-CE structure of FIG. 34, from a second octet, every four octets may correspond to one separate TCI state set. According to an embodiment, a C₀ field 3415 may have a total of 8 values from “000” to “111”, and as described above, the values may respectively correspond to 8 cases that one separate TCI state set may have.

The C₀ field having a value of “00” indicates that one separate TCI state set includes one UL TCI state, TCI state ID_{D,0,0} fields 3420 and 3421 may be ignored, and a TCI state ID_{U,0,0} field 3425 may include one piece of UL TCI state information. In addition, fourth and fifth octets may be ignored.

The C₀ field having a value of “001” indicates that one separate TCI state set includes two UL TCI states, the TCI state ID_{D,0,0} fields 3420 and 3421 may be ignored, and the TCI state ID_{U,0,0} field 3425 may include information on a first UL TCI state among the two UL TCI states. In addition, the fourth octet may be ignored, and a TCI state ID_{D,0,0} field 3435 may include information on a second UL TCI state among the two UL TCI states.

The C₀ field having a value of “010” indicates that one separate TCI state set includes one DL TCI state, the TCI state ID_{D,0,0} fields 3420 and 3421 may include one piece of DL TCI state information, and the TCI state ID_{U,0,0} field 3425 and the fourth and fifth octets may be ignored.

The C₀ field having a value of “011” indicates that one separate TCI state set includes one DL TCI state and one UL TCI state, the TCI state ID_{D,0,0} fields 3420 and 3421 may have one piece of DL TCI state information, and the TCI state ID_{U,0,0} field 3425 may include one piece of UL TC state information. The fourth and fifth octets may be ignored.

The C₀ field having a value of “100” indicates that one separate TCI state set includes one DL TCI state and two UL TCI states, the TCI state ID_{D,0,0} fields 3420 and 3421 may include one piece of DL TCI state information, and the TCI state ID_{U,0,0} field 3425 may include information on a first UL TCI state among the two UL TCI states. In addition, the fourth octet may be ignored, and the TCI state ID_{U,1,0} field 3435 may include information on a second UL TCI state among the two UL TCI states.

The C₀ field having a value of “101” indicates that one separate TCI state set includes two DL TCI states, the TCI state ID_{D,0,0} fields 3420 and 3421 may include information on a first DL TC state among the two DL TCI states, and the TCI state ID_{U,0,0} field 3425 and the fifth octet may be ignored. A TCI state ID_{D,1,0} field 3430 may include information on a second DL TCI state among the two DL TCI states.

The C₀ field having a value of “110” indicates that one separate TCI state set includes two DL TCI states and one UL TCI state, the TCI state ID_{D,0,0} fields 3420 and 3421 may include information on s first DL TCI state among the two DL TCI states, the TCI state ID_{U,0,0} field 3425 may include one piece of UL TCI state information, the TCI state ID_{D,1,0} field 3430 may include information on a second DL TCI state among the two DL TCI states, and the fifth octet may be ignored.

The C₀ field having a value of “11” indicates that one separate TCI state set includes two DL TCI states and two UL TCI states, the TCI state ID_{D,0,0} fields 3420 and 3421 may include information on a first DL TCI state among the two DL TCI states, the TCI state ID_{U,0,0} field 3425 may include information on a first UL TCI state among the two UL TCI states, the TCI state ID_{D,1,0} field 3430 may include information on a second DL TCI state among the two DL TCI states, and the TCI state ID_{U,1,0} field 3435 may include information on a second UL TCI state among the two UL TCI states.

FIG. 34 may illustrate an example of a MAC CE used when a UL TCI state in separate TCI states uses a higher-layer signaling structure different from that for a joint TCI state and for a DL TC state in the separate TCI states, as described above. Accordingly, since a UL TCI state requires 6 bits capable of expressing up to 64 UL TCI states, the TCI state ID_{U,0,0} to TCI state ID_{U,1,N} fields expressing a UL TCI state may be expressed using 6 bits, whereas the TCI state ID_{D,0,0} to TCI state ID_{D,1,N} fields expressing a DL TCI state may be expressed using 7 bits.

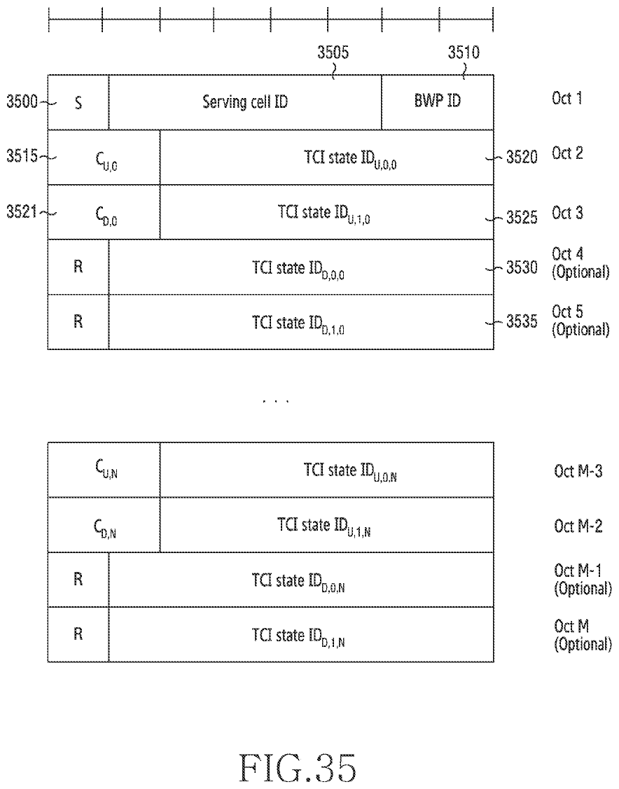

FIG. 35 illustrates an example of another MAC-CE structure for activation and indication of multiple separate TCI states in the wireless communication system according to an embodiment of the disclosure. Referring to FIG. 35, a serving cell ID field 3505 and a BWP ID field 3510 may indicate a serving cell ID and a bandwidth part ID, respectively. According to an embodiment, when a value of an S field 3500 is 1, a corresponding MAC-CE may indicate one separate TCI state set and may have a length of only up to a fifth octet.

According to an embodiment, when the value of the S field 3500 is 0, the MAC-CE may include information on multiple separate TCI state sets. The MAC-CE may activate one separate TCI state set corresponding to each codepoint of a TCI state field in DCI format 1_1 or 1_2, or activate one separate TCI state set corresponding to each codepoint of two TCI state fields of DCI format 1_1 or 1_2, and activate, as described above, separate TCI state sets corresponding to up to 8 or 16 codepoints via higher-layer signaling.

In the MAC-CE structure of FIG. 35, from a second octet, every 4 octets may correspond to one separate TCI state set. A C_{U,0} field 3515 and a C_{D,0} field 3521 may refer to the numbers of UL TCI states and DL TCI states included in one separate TCI state set, respectively, and may have meaning for each codepoint as follows.

The C_{U,0} field having a value of “0” indicates including no UL TCI state, and thus a TCI state ID_{U,0,0} 3520 and a TCI state ID_{U,1,0} 3525 may be ignored.

The C_{U,0} field having a value of “01” indicates including one UL TCI state, and thus the TCI state ID_{U,0,0} 3520 may include one piece of UL TCI state information and the TCI state ID_{U,1,0} 3525 may be ignored.

The C_{U,0} field having a value of “10” indicates including two UL TCI states, and thus the TCI state ID_{U,0,0} 3520 may include information on a first UL TCI state among the two UL TCI states, and the TCI state ID_{U,1,0} 3525 may include information on a second UL TCI state among the two UL TCI states.

The C_{U,0} field having a value of “0” indicates including no DL TCI state, and thus fourth and fifth octets may be ignored.

The C_{U,0} field having a value of “01” indicates including one DL TCI state, and thus the TCI state ID_{U,0,0} 3530 may include one piece of DL TCI state information, and the fifth octet may be ignored.

The C_{U,0} field having a value of “10” indicates including two DL TCI states, and thus a TC state ID_{U,0,0} 3530 may include information on a first DL TCI state among the two DL TCI states, and a TCI state ID_{U,1,0} field 3535 may include information on a second DL TCI state among the two DL TCI states.

FIG. 35 may illustrate an example of a MAC CE used when a UL TCI state in separate TCI states uses a higher-layer signaling structure different from that for a joint TCI state and for a DL TC state in the separate TCI states, as described above. Accordingly, since a UL TCI state requires 6 bits capable of expressing up to 64 UL TCI states, the TCI state ID_{U,0,0} to TCI state ID_{U,1,N} fields expressing the UL TCI state may be expressed using 6 bits, whereas the TCI state ID_{D,0,0} to TCI state ID_{D,1,N} fields expressing a DL TCI state may be expressed using 7 bits.

In the aforementioned examples of the MAC CE in FIG. 33 to FIG. 35, it is possible that at least one of the elements are coupled to each other.

### Third Embodiment: Method of Applying a TCI State Indicated by the Unified TCI Scheme to PUCCH Transmission

According to an embodiment of the disclosure, descriptions are provided for a method of, when a single TCI state or multiple TCI states are indicated based on the unified TCI scheme, determining and applying an uplink transmission beam required for a UE to transmit a scheduled PUCCH.

In NR Release 17, only a single TCI state based on the unified TCI scheme has been indicated in consideration of only a single TRP, but in subsequent NR Releases, multiple TCI states may be indicated as described in the second embodiment. Before describing specific operations of the disclosure, for the convenience of description in the disclosure, a period subsequent to a start point of a first slot, which appears a time equal to a BAT after receiving DCI for updating a TCI state and then transmitting a PUCCH including ACK for the same, may be expressed as “after BAT”. The indicated multiple TCI states or single TCI state may be applied to uplink channel transmission or downlink channel reception after the beam application time (BAT). As described above, a TCI state indicated by DCI is applied to an uplink and a downlink after a certain period of time. This may be to ensure agreement of understanding on beam update between a base station and a UE, by transmitting ACK indicating that the UE has successfully received a PDCCH indicating the TCI state, and then receiving the ACK by the base station. However, there may be a disadvantage of incapability of supporting a faster beam update in a highly reliable channel environment. Definition may be provided so that, according to an indicated TCI state based on the unified TCI scheme, the indicated TCI state is applied, collectively after a BAT, to all uplink channels and all downlink channels (e.g., when operating in the joint TCI state scheme) or to all uplink channels so as to be transmitted and received. The description above may indicate that the UE needs to transmit a corresponding channel only with the indicated TCI state even for a PUCCH and a PUSCH. If two TCI states are indicated, this may indicate that the UE unconditionally applies the two TCI states to a PUCCH or PUSCH after a BAT, which may be interpreted to be the same as indicating only multi-TRP transmission. However, in NR Release 17, a dynamic switching function has been introduced so that, when a UE supports multiple TRPs, single-TRP transmission or multi-TRP transmission during PUCCH or PUSCH transmission can be supported. This dynamic switching function supportable for uplink channels may not be available when indicated TCI states are collectively applied to the uplink channels after a BAT as in the unified TCI scheme. Therefore, additional methods may be required to support the dynamic switching function for the UE operating in the unified TCI scheme.

When the UE transmits a PUCCH based on scheduling information, a PUCCH resource may be determined according to a UCI payload and a PUCCH resource indicator (PRI) area in the scheduling DCI. Based on this operation, various uplink transmission beam application methods may be selected according to scheduled PUCCH resources. For example, even for PUCCH resources configured with the same resources, the number of beams to be applied and a beam application method may be configured differently, so that the number of beams to be applied and the beam application method may be selected by considering a channel state between a base station and a UE. In a 3-1st embodiment, a description is provided for a method capable of selecting and supporting the number of beams to be applied and a beam application method, based on information of a scheduled PUCCH according to higher-layer signaling. According to the 3-1st embodiment, a description is provided for an operation of, based on a higher-layer configuration for PUCCH transmission of a UE, transmitting a PUCCH by selecting the number of single or multiple TCI states to be applied and a method of applying the TCI states, which are indicated based on the unified TCI scheme. According to a 3-2nd embodiment and a 3-3rd embodiment, a description is provided for an operation of, based on an operation indicated via DCI or information activated using a new MAC CE for PUCCH transmission of a UE, transmitting a PUCCH by selecting the number of single or multiple TCI states to be applied and a method of applying the TCI states, which are indicated based on the unified TCI scheme.

### 3-1st Embodiment: Operations of Transmitting a PUCCH by Selecting the Number of Single or Multiple TCI States to be Applied and a Method of Applying the TCI States According to a Higher-Layer Configuration for PUCCH Transmission

According to an embodiment of the disclosure, a description is provided for a method of transmitting a PUCCH by selecting the number of single or multiple TCI states to be applied and a method of applying the TCI states according to a higher-layer configuration for PUCCH transmission.

In an embodiment of the disclosure, a base station may receive a UE capability report from a UE and configure higher-layer parameters based on the UE capability report. In this case, for configuration of the higher-layer parameters, PUCCH-Config or higher-layer parameters included therein, such as PUCCH-FormatConfig, PUCCH-ResourceSet, PUCCH-Resource, and PUCCH-ResourceGroup, higher-layer parameters defining a list related to PUCCH-Config, etc. may be configured. When configuring the higher-layer parameters, the base station may configure a part or all of single or multiple TCI states, which are indicated based on the unified TCI scheme, to be transmitted via scheduled PUCCH resources. Furthermore, the base station may additionally consider a method of differently configuring a time (updating time) for applying an indicated TCI state for corresponding PUCCH resources.

Hereinafter, in a specific example, a case where two TCI states (e.g., a joint TCI state or a UL TCI state) are indicated via DCI received by the UE may be assumed. However, this is merely an example, and even in a case where one TCI state is indicated or more than two TCI states are indicated, the method described below can be applied similarly by expansion or reduction, so that the method is not limited to the case where two TCI states are indicated. In addition, for the convenience of description, it may be assumed that additionally configured configurations are included in the PUCCH resource configuration. However, this is merely an example, and as described below, a configuration added to other PUCCH-related higher-layer configurations may be included.

New higher-layer parameters which may be included in the higher-layer configuration related to PUCCH transmission may include the following configurations.

[Additional configuration 1: Method of selecting a TCI state to be applied]A configuration for indicating a TCI state to be applied to a corresponding PUCCH among two TCI states (e.g., a joint TCI state or a UL TCI state) indicated based on the unified TCI scheme may be configured via new higher-layer parameters. According to an embodiment, when two TCI states are indicated and applied to a specific PUCCH resource via DCI, the base station may configure a higher-layer parameter to apply both of the indicated two TCI states to PUCCH transmission or to apply one TCI state to PUCCH transmission. In this case, the base station may indicate, using candidate values enabling indication, such as “AlITCIState”, “FirstTCIState”, and “SecondTCIState”, that a part or all of the TCI states are applied to transmission of a corresponding PUCCH resource.

[Additional configuration 2: Method of applying a TCI state] When two TCI states indicated based on the unified TCI scheme are applied to a PUCCH, whether the TCI state indicated by DCI is applied to the PUCCH after a BAT or whether the TCI state is applied to the PUCCH earlier than the BAT may be configured via a newly added higher-layer parameter. According to an embodiment, similar to NR Release 17, for a specific PUCCH resource, the indicated TCI state may be configured to be applied from a first slot after the BAT from a transmission time of the PUCCH including ACK for DCI including a corresponding TCI. In this case, for a value to be configured, “legacy”, “AfterBAT”, or any other value that may similarly indicate an operation of applying the indicated TCI state after the BAT may be configured. For another PUCCH resource, unlike NR Release 17, a value may be configured via a new higher-layer parameter to apply the indicated TCI state to the PUCCH resource immediately after a certain time for receiving and processing DCI for TCI updating, even in a slot other than the first slot after the BAT. For example, the value to be configured may be “BeforeBAT”, “FastBeamSwitching”, or any other value that may similarly indicate an operation of applying the indicated TCI state before the BAT. In this way, even if a time equal to the BAT is not secured, when a fast PUCCH transmission beam change is made, a certain amount of threshold may need to be secured after receiving the DCI including a TCI state for TCI updating. This threshold may include a time for the UE to receive and decode the DCI, a time for changing an uplink transmission beam, based on the receiving and decoding time, and the like. An example of the threshold required to apply the updated TCI state, at least a time equal to “timeDurationForQCL” added in NR Release 16 may be required. Based on the method above, in a higher-layer configuration for some PUCCH resources, as in NR Release 17, an operation of updating a beam with the indicated TCI state from the first slot after the BAT may be indicated, and in configuration for some other PUCCH resources, an operation of receiving TCI state update information via DCI and then changing/updating a beam quickly before the BAT may be indicated.

In this way, during the higher-layer configuration for PUCCH transmission, higher-layer parameters considering both or only a part of [additional configuration 1] and [additional configuration 2] may be configured as described above. When the higher-layer parameters are configured by considering both [additional configuration 1] and [additional configuration 2], one higher-layer parameter considering both configurations may be added, or respective higher-layer parameters for two configurations may be added. When one higher-layer parameter considering both configurations is added, the following candidate values may be considered.

[Candidate value 1: Applying a single beam by considering BAT] When one new higher-layer parameter considering both configurations is configured to be candidate value 1, the UE may use (update) an uplink beam indicated via one (e.g., a first TCI state) of the indicated TCI states for PUCCH transmission. Then, the UE may transmit a PUCCH including ACK for DCI including the indicated TCI state and apply the uplink beam indicated by the TCI state to PUCCH transmission from a first slot after a BAT. For example, the UE may transmit the PUCCH including ACK for the DCI including the TCI state according to a previously indicated and applied uplink beam before the BAT based on the unified TCI scheme. When a number for the previously indicated and applied uplink beam is greater than 1, the UE may transmit the PUCCH including ACK for the DCI including the TCI state by using only one beam (e.g., a first TCI state) among multiple indicated and applied uplink beams.

[Candidate value 2: Applying a single beam quickly before BAT] When one new higher-layer parameter considering both configurations is configured to be candidate value 2, the UE may use (update) an uplink beam indicated via one (e.g., the first TCI state) of the indicated TCI states for PUCCH transmission. In addition, when a certain threshold time is satisfied, the UE may update a single uplink beam according to a TCI state indicated via DCI for PUCCH scheduling and apply the same to scheduled PUCCH transmission even if the BAT according to the unified TCI scheme has not elapsed. For example, unlike indication by candidate value 1, when transmitting the PUCCH including ACK for the DCI including the TCI state, the UE may transmit the PUCCH by updating to the TCI state. In this case, a threshold may be determined by a UE capability. As an example of the threshold, the threshold time may be a higher-layer parameter introduced in Release 16, such as “timeDurationForQCL”. Alternatively, a new higher-layer parameter or a conventional higher-layer parameter other than “timeDurationForQCL” may be used as a threshold for applying the TCI state indicated via DCI before the BAT. This threshold value may also be applied to candidate values 4 to 6 described below.

[Candidate value 3: Applying all beams by considering BAT] When one new higher-layer parameter considering both configurations is configured to be candidate value 3, the UE may use (update) uplink beams indicated via all of TCI states indicated for corresponding PUCCH transmission. Then, the UE may transmit a PUCCH including ACK for DCI including the indicated TCI states and apply the uplink beams indicated by the TCI states to PUCCH transmission from a first slot after the BAT. For example, the UE may transmit the PUCCH including ACK for the DCI including the TCI states according to a previously indicated and applied uplink beam before the BAT based on the unified TCI scheme. When a number for the previously indicated and applied uplink beam is 1, the UE may transmit the PUCCH including ACK for the DCI including the TCI states by using only one beam.

[Candidate value 4: Using all beams, applying a first beam by considering BAT, and applying a second beam quickly before BAT] When one new higher-layer parameter considering both configurations is configured to be candidate value 4, the UE may use (update) uplink beams indicated via all of TCI states indicated for corresponding PUCCH transmission. In addition, if a certain threshold time is satisfied, the UE may update a second uplink beam according to a second TCI state among the TCI states indicated via DCI for PUCCH scheduling and apply the same to scheduled PUCCH transmission even if the BAT according to the unified TCI scheme has not elapsed. For a first uplink beam, an uplink beam indicated via a corresponding TCI state may be updated for PUCCH transmission from a first slot after the BAT based on the unified TCI scheme. For example, the first beam may be determined according to a previously indicated and applied uplink beam before the BAT based on the unified TCI scheme, and the second beam may be determined as the uplink beam according to the second TCI state indicated via the DCI for scheduling of a corresponding PUCCH. When only a TCI state for one uplink beam is indicated via DCI, the UE may apply a corresponding beam only to the first beam from the first slot after the BAT based on the unified TCI scheme, and support uplink transmission with only the corresponding one beam.

[Candidate value 5: Using all beams, applying a first beam quickly before BAT, and applying a second beam by considering BAT] When one new higher-layer parameter considering both configurations is configured to be candidate value 5, the UE may use (update) uplink beams indicated via all of TCI states indicated for corresponding PUCCH transmission. In addition, when a certain threshold is satisfied, the UE may update a first uplink beam according to a first TCI state among the TCI states indicated via DCI for PUCCH scheduling and apply the same to scheduled PUCCH transmission even if the BAT according to the unified TCI scheme has not elapsed. For a second uplink beam, an uplink beam indicated via a corresponding TCI state may be updated for PUCCH transmission from a first slot after the BAT based on the unified TCI scheme. For example, the first beam may be determined as an uplink beam according to the first TCI state indicated via the DCI for scheduling of a corresponding PUCCH, and the second beam may be determined according to a previously indicated and applied uplink beam before the BAT based on the unified TCI scheme. When only a TCI state for one uplink beam is indicated via the DCI, the UE may support, only for the first beam, uplink transmission with one beam according to the TCI state indicated via the DCI for scheduling of the PUCCH.

[Candidate value 6: Using all beams and applying the all beams quickly before BAT] When one new higher-layer parameter considering both configurations is configured to be candidate value 6, the UE may use (update) uplink beams indicated via all of TCI states indicated for corresponding PUCCH transmission. In addition, when a certain threshold is satisfied, the UE may update a first uplink beam and a second uplink beam according to all TCI states indicated via DCI for PUCCH scheduling and apply the same to scheduled PUCCH transmission even if the BAT according to the unified TCI scheme has not elapsed. For example, the first uplink beam and the second uplink beam may be determined as uplink beams according to a first TCI state and a second TCI state indicated via the DCI for scheduling of a corresponding PUCCH. When only a TCI state for one uplink beam is indicated via DCI, the UE may support, only for the first beam, uplink transmission with one beam according to the TCI state indicated via the DCI for scheduling of the PUCCH.

As described above, one new higher-layer parameter may be considered for configuring the number of TCI states to be applied to PUCCH transmission and a method of applying the TCI states, and one of candidate values 1 to 6 may be configured. According to an embodiment, although a total of 6 values from candidate value 1 to candidate value 6 are specifically described, the candidate values of the higher-layer parameters may be defined by considering a case of a number greater than 6. For example, [candidate value 1] may be defined more specifically, wherein a case where the first TCI state among the two indicated TCI states is selected to apply an uplink beam may be distinguished as [candidate value 1-1] so as to be supported, and a case where the second TCI state among the two indicated TCI states is selected to apply an uplink beam may be distinguished as [candidate value 1-2] so as to be supported. Similarly, not only [candidate value 2] but also other candidate values may be defined more specifically and operated. In this way, a method of configuring each higher-layer parameter, as in the specific examples of additional configuration 1 and additional configuration 2, may be used instead of configuring one higher-layer parameter for the number of TCI states to be applied and the method of application.

The aforementioned new higher-layer parameter for uplink beam determination and beam application method determination according to TCI states during PUCCH transmission may be included in one of higher-layer parameters for PUCCH configuration. Higher-layer parameter candidates for PUCCH configuration including the new higher-layer parameter may be PUCCH-Resource, PUCCH-FormatConfig, PUCCH-ResourceSet, PUCCH-ResourceGroup, or the like. When a new higher-layer parameter is included in PUCCH-Resource, different operations may be supported for each scheduled PUCCH resource. For example, PUCCH resource 1 may be transmitted using only one uplink beam according to one TCI state, and PUCCH resource 2 may be transmitted using two uplink beams according to two TCI states. Similarly, for some PUCCH resources, an uplink beam may be applied according to an updated TCI state and the PUCCH resources may be transmitted from a first slot after a BAT based on the unified TCI scheme, and for some other PUCCH resources, an uplink beam indicated via a TCI state may be applied and the PUCCH resources may be transmitted immediately after a certain threshold before the BAT. Similarly, when a new higher-layer parameter is configured in PUCCH-FormatConfig, the number of TCI states to be applied among TCI states indicated via DCI and a method of applying the TCI states may be determined based on the unified TCI scheme according to a format of a scheduled PUCCH resource.

As the method described above, by adding, to PUCCH resources or other PUCCH-related higher-layer parameters, a new higher-layer parameter for uplink beam determination and beam application method determination according to TCI states during PUCCH transmission, various PUCCH resource configurations may be supported. More specifically, with respect to PUCCH resources having different PUCCH resource IDs, even if resource configurations, such as a PUCCH format, a time domain, and a frequency domain, are the same, different values are configured for a new higher-layer parameter, so that the same resource amount may be scheduled to be transmitted by selecting either single TRP transmission or multi-TRP transmission. In addition, by indicating a TC state application method, a PUCCH transmission beam may be quickly updated in an environment where quick uplink beam application is possible. Therefore, the maximum number of PUCCH resource configurations configured via a higher layer or the number of PUCCH resources included in a PUCCH resource set may be up to 32 for a first PUCCH resource set and may be up to 8 for other PUCCH resource sets, but a method of increasing this may be considered. When the number of PUCCH resources included in a PUCCH resource set increases, a PUCCH resource indicator (PRI) area in DCI (e.g., DCI format 1_1 or 1_2 including a TCI state area or all DCI formats capable of PUCCH scheduling) needs to be reinforced accordingly. According to an embodiment, as an example of a reinforcement method, the UE may determine scheduled PUCCH resources by using a 3-bit PRI area in DCI and equation 3 so that the maximum of 32 PUCCH resources instead of the maximum of 8 PUCCH resources may be configured also for a PUCCH resource set other than the first PUCCH resource set. Alternatively, the number of bits in the PRI area in DCI formats for PUCCH scheduling may be increased. To this end, the UE may report a UE capability of supporting the operations described above, and the base station may receive the UE capability and configure a higher-laver parameter for the UE. In this case, the number of bits in the PRI area in the DCI may be a value greater than 3 depending on whether a new higher-layer parameter for indicating that the operation is supported is configured (explicit indication) or whether a new higher-layer parameter for uplink beam determination and beam application method determination according to TCI states during PUCCH transmission, which is described above, is configured (implicit indication). According to an embodiment, the first PUCCH resource set may be configured to include a maximum number of PUCCH resources greater than 32 (e.g., 64), and the other PUCCH resource sets may be configured to include a maximum number of PUCCH resources greater than 8 (e.g., 16), and the number of bits in the PRI area may be reinforced to 4. The first PUCCH resource set may indicate up to 64 PUCCH resources by using a 4-bit PRI area and modified equation 3. In this case, modified equation 3 may be operated by changing a value of 8 in equation 3 to any other value. For example, the value of 8 included in equation 3 may be changed to a value, such as 16, for operation.

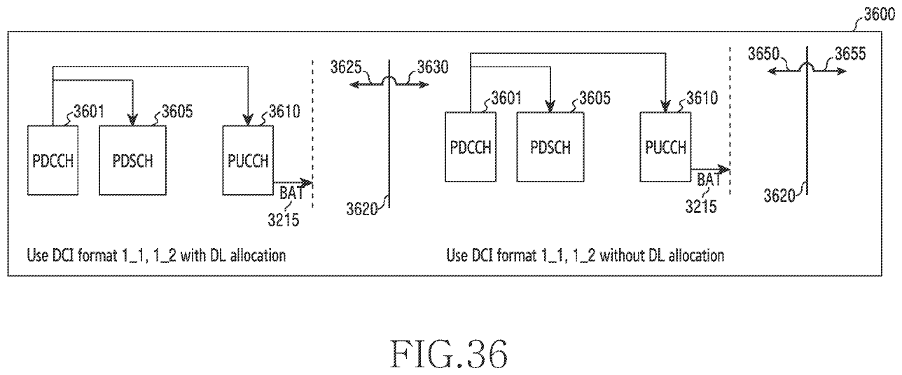

FIG. 36 illustrates a procedure of receiving a PDSCH and transmitting a PUCCH by a UE in accordance with PDCCH reception indicating a TCI state based on the unified TCI scheme according to an embodiment of the disclosure.

Referring to FIG. 36, a base station may transmit a PDCCH 3601 including a TCI state based on the unified TCI scheme to a UE. In this case, the PDCCH 3601 may schedule a PDSCH 3605 and a PUCCH 3610 including HARQ-ACK for reporting whether the PDSCH has been received. The PDCCH 3601 may include a PUCCH resource indicator (PRI) area for the PUCCH 3610. Via the PRI area, the UE may determine a PUCCH resource to be transmitted. As specifically described in the 3-1st embodiment, the number of TCI states to be applied among TCI states based on the unified TCI scheme included in the PDCCH 3605 and the method of applying the TCI states may be determined according to a higher-layer parameter configuration (PUCCH-Resource) for a scheduled PUCCH resource or a higher-layer parameter configuration (e.g., PUCCH-Config, PUCCH-FormatConfig, PUCCH-ResourceSet, PUCCH-ResourceGroup, or the like) which may be associated with the PUCCH resource. For example, if a PUCCH resource ID of a PUCCH 3640 scheduled with a PDCCH 3631 is 1, and a new higher-layer parameter for a corresponding PUCCH resource is configured to be candidate value 3, the UE may determine an uplink beam according to all TCI states indicated from the PDCCH 3601, for which a beam application time of the unified TCI scheme has been considered, and may transmit the PUCCH 3640. For example, the PUCCH 3640 (in which the PUCCH resource ID is 1) may be transmitted according to the TCI state indicated by the first PDCCH 3601 to which a beam application time considering the BAT has been applied, other than a TCI state indicated by the second PDCCH 3631 in FIG. 36. On the other hand, when the PUCCH resource ID of the PUCCH 3640 scheduled by the PDCCH 3631 is 2, and a new higher-layer parameter for a corresponding PUCCH resource is configured to candidate value 2, the UE may transmit the PUCCH 3640 (in which the PUCCH resource ID is 2) via an uplink beam determined according to one TCI state (e.g., the first TCI state) among the TCI states indicated via the PDCCH 3631. In this case, it may be assumed that a start time between PDCCH 3631 transmission and PUCCH 3640 transmission satisfies a specific threshold (e.g., a required time, such as timeDurationForQCL). If a time offset between a time after a last symbol of the PDCCH 3631 for scheduling of the PUCCH 3640 and a time before transmission of a first symbol of the PUCCH 3640 is less than the threshold, the UE may operate according to one of or a combination of the following operations.

[Operation 1] Transmitting the PUCCH 3640 via an uplink beam determined according to a previously indicated TCI state (TCI state included in the PDCCH 3601 in FIG. 36).

[Operation 2] When uplink transmission is possible using a reception filter via which the UE has received the PDCCH 3631, transmitting the PUCCH 3640 via an uplink beam determined according to the same TCI state used to receive the PDCCH 3631 for scheduling of the PUCCH 3640.

[Operation 3] Transmitting the PUCCH 3640 via an uplink beam determined according to a default beam (e.g., TCI state or QCL assumption for a CORESET having a smallest index in an activated downlink bandwidth part (BWP)) defined in advance by the base station and the UE.

[Operation 4] The UE may not expect that the time offset between the time after the last symbol of the PDCCH 3631 for scheduling of the PUCCH 3640 and the time before transmission of the first symbol of the PUCCH 3640 is less than the threshold.

[Operation 5] For the PUCCH resource configuration of the scheduled PUCCH 3640, when some TCI states are updated 3655 by considering the BAT based on the unified TCI scheme, and updating 3650 of the remaining TCI states is possible even before the BAT, the UE may transmit the PUCCH 3640 via an uplink beam determined only by the TCI states updated in consideration of the BAT.

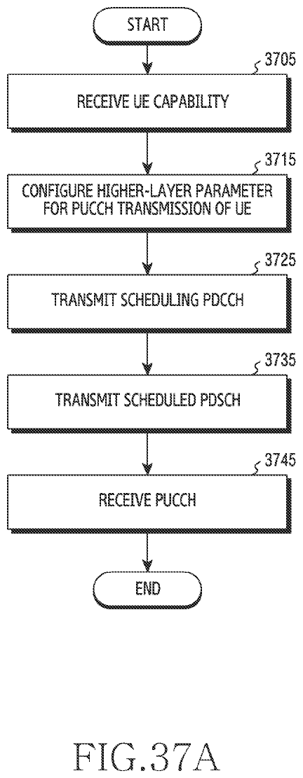

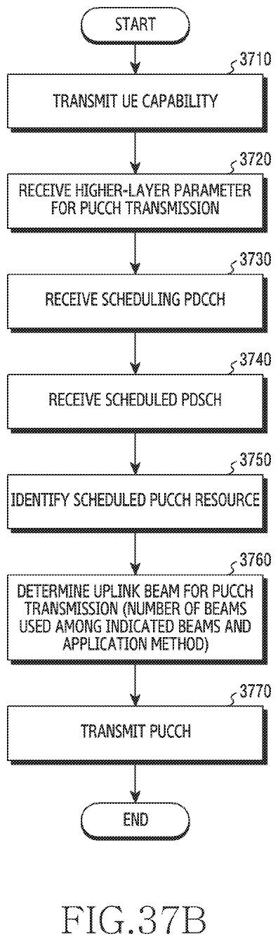

FIG. 37A illustrates an operation flow of a base station when an uplink transmission beam of a PUCCH is determined based on a higher-layer parameter.

In operation 3705, a base station may receive a UE capability from a UE. In this case, the UE capability reported by the UE may include information, such as whether the UE supports unified TCI-based operation, whether the UE is able to determine the number of TCI states to be applied, based on a higher-layer parameter as shown in the aforementioned 3-1st embodiment, whether the UE is able to determine a TCI state application method based on a higher-layer parameter as shown in the aforementioned 3-1st embodiment, or a PUCCH transmission-related UE capability.

In operation 3715, the base station may configure a higher-layer parameter for the UE, based on the UE capability reported by the UE. The base station may add a higher-layer parameter to support unified TCI-based operation and a new higher-layer parameter within the PUCCH-related configuration described above, and configure the same to the UE. The added new higher-layer parameter within the PUCCH-related configuration may be defined to be at least one of one higher-layer parameter considering both [additional configuration 1] and [additional configuration 2], two higher-layer parameters considering the additional configurations respectively, or one higher-layer parameter considering only a part of the additional configurations, as described above.

In operation 3725, the base station may transmit a PDCCH for scheduling to the UE. In this case, the base station may schedule a PDSCH and a PUCCH by including a grant in the PDCCH or may schedule only a PUCCH due to including no grant.

In operation 3735, when the PDCCH includes a grant, the base station may transmit the scheduled PDSCH. When the base station schedules only a PUCCH due to including no grant, operation 3735 may be omitted.

In operation 3745, the base station may receive the PUCCH including ACK for reception of the PDCCH or PDSCH (if scheduled) from the UE. The base station may identify transmission beam information for the PUCCH transmitted by the UE according to a currently activated/indicated TCI state and the higher-layer parameter configuration (or related higher-layer parameter configuration for the PUCCH) for a scheduled PUCCH resource, and may receive the PUCCH by using a single TRP or multiple TRPs, based on the transmission beam information.

FIG. 37B illustrates an operation flow of a UE when an uplink transmission beam of a PUCCH is determined based on a higher-layer parameter according to an embodiment of the disclosure.

In operation 3710, a UE may transmit a UE capability to a base station. In this case, as described above, the UE capability may include information, such as whether the UE supports unified TCI-based operation, whether the UE is able to determine the number of TCI states to be applied, based on a higher-layer parameter as shown in the aforementioned 3-1st embodiment, whether the UE is able to determine a TCI state application method based on a higher-layer parameter as shown in the aforementioned 3-1st embodiment, or a PUCCH transmission-related UE capability. The UE may report the UE capability including the described information to the base station.

In operation 3720, the UE may receive a higher-layer parameter from the base station. Here, the UE may receive a higher-layer parameter to support unified TCI-based operation and a new higher-layer parameter within the PUCCH-related configuration described above. The added new higher-layer parameter within the PUCCH-related configuration may be defined to be one higher-layer parameter considering both [additional configuration 1] and [additional configuration 2], two higher-layer parameters considering the additional configurations respectively, or one higher-layer parameter considering only a part of the additional configurations, as described above.

In operation 3730, the UE may receive a PDCCH (e.g., DCI format 1_1 or 1_2) for scheduling from the base station. In this case, the PDCCH may be a PDCCH including a grant to schedule a PDSCH and a PUCCH, or a PDCCH for scheduling only a PUCCH due to including no grant.

In operation 3740, when the PDCCH includes a grant, the UE may receive the scheduled PDSCH. When only a PUCCH is scheduled due to including no grant, operation 3740 may be omitted.

In operation 3750, the UE may identify a scheduled PUCCH resource to prepare for PUCCH transmission, and perform PUCCH transmission preparation. Operation 3750 may be performed after receiving 3740 the PDSCH or after receiving 3730 the scheduling PDCCH, but for convenience of description, it is assumed that the operation is performed as illustrated in FIG. 37B.

In operation 3760, the UE may identify the scheduled PUCCH resource so as to configure resources for PUCCH transmission, such as a PUCCH resource amount and a format, as well as identify, as described in the 3-1st embodiment, new higher-layer parameter(s) for indicating, the unified TCI, whether to use all beams among multiple indicated uplink transmission beams or to use only one or a part of the uplink transmission beams, and a method for applying the TCI states. Based on this, the UE may determine a beam for PUCCH transmission.

In operation 3770, the UE may transmit the PUCCH via a single TRP or multiple TRPs by using the determined uplink transmission beam.

### 3-2nd Embodiment: Operations of Transmitting a PUCCH by Selecting the Number of Single or Multiple TCI States to be Applied and a Method of Applying the TCI States According to a MAC CE for PUCCH Transmission

According to an embodiment of the disclosure, a detailed description is provided for a method of transmitting a PUCCH by selecting the number of single or multiple TCI states to be applied and a method of applying the TCI states according to MAC CE signaling for PUCCH transmission.

According to an embodiment of the disclosure, a base station may receive a UE capability report of a UE and based on this, the base station may perform MAC CE signaling to activate, to the UE, the number of TCI states to be applied and the method of applying the TCI states. In this case, a configuration method of activation to the UE via MAC CE signaling may include, in the same manner as described in the 3-1st embodiment, information on whether to use only a single TCI state among the indicated multiple TCI states or to use all the TCI states (or whether to use some TCI states greater than 1 may also be considered), whether to update a TCI state indicated via DCI from a first slot after a BAT considering the unified TCI scheme, or whether to perform updating to the indicated TCI state even before the BAT considering the unified TCI scheme if only a certain threshold time (e.g., a time for which a DCI decoding and beam application time, such as “timeDurationForQCL”, has been considered) is satisfied.

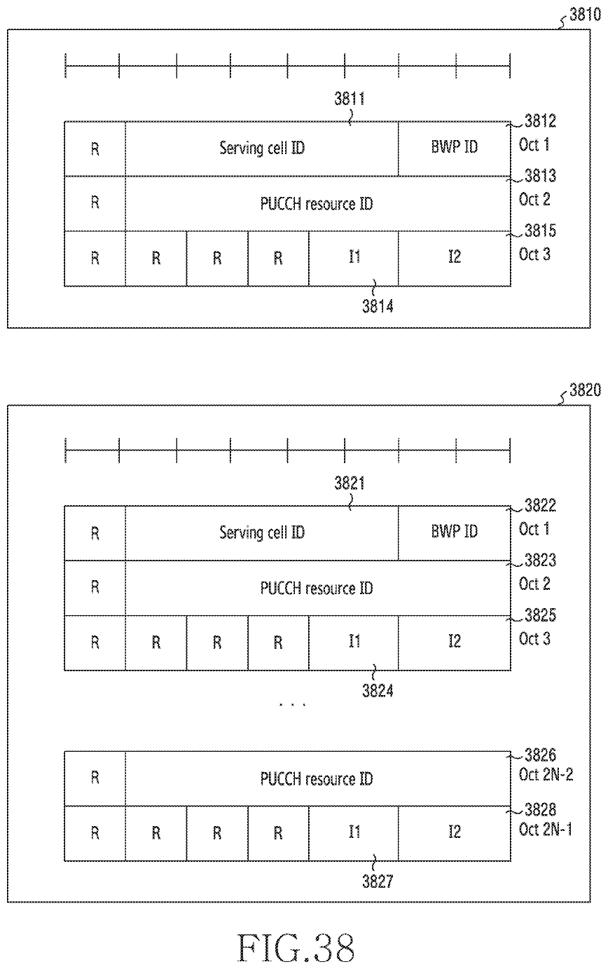

FIG. 38 illustrates an example of a MAC CE for activating the number of indicated TCI states to be applied and a method of applying the TCI states according to an embodiment of the disclosure.

Referring to FIG. 38, when up to two unified TCI states (or two UL TCI states) can be indicated using one codepoint based on the unified TCI, whether a PUCCH resource 3813, which is indicated via a MAC CE as in 3810 among two TCI states indicated using the MAC CE, is to be transmitted using all beams among uplink beams (uplink beams indicated by two unified TCI states or UL TCI states) or transmitted using only one of the two uplink beams may be indicated via an area I1 3814 in the MAC CE. As an example of one of various method of interpreting I1 including 2 bits, when I1 is configured to be “00”, an uplink beam indicated via a first TCI state among the two indicated TCI states may be indicated to be used for the corresponding PUCCH resource transmission. When I1 is configured to be “01”, an uplink beam indicated via a second TCI state among the two indicated TCI states may be indicated to be used for the PUCCH resource transmission. When I1 is configured to be “10”, uplink beams indicated by both the two indicated TCI states may be indicated to be used for the PUCCH resource transmission. In this case, the first TCI state may be used as a first uplink beam during the PUCCH transmission, and the second TCI state may be used as a second uplink beam during the PUCCH transmission. When I1 is configured to be “11”, the uplink beams indicated by both the two indicated TCI states may be indicated to be used for the PUCCH resource transmission. In this case, the first TCI state may be used as the second uplink beam during the PUCCH transmission, and the second TCI state may be used as the first uplink beam during the PUCCH transmission. This is merely an example, and the relationship between uplink beams used during PUCCH resource transmission and multiple indicated TCI states of various methods may be defined using 2 bits. Alternatively, an I1 area may include 1 bit to determine an uplink beam by using only a first TCI state among multiple indicated TCI states and transmit a corresponding PUCCH resource (e.g., 1 bit of the I1 area has a value of “0”), or to determine an uplink beam by considering all TCI states and transmit the PUCCH resource (e.g., 1 bit of the I1 area has a value of “1”). Alternatively, if the number of TCI states greater than two can be indicated by DCI, a method of configuring the number of bits in the I1 area of the MAC CE to be greater than 2 may also be considered. In reference numeral 3810, an I2 area 3815 may be used to indicate a method of applying TCI states. The I2 area 3815 includes 2 bits and may be interpreted in various ways. According to an embodiment, when 12 is configured to be “00”, a base station may indicate a UE to update two uplink beams which may be for corresponding PUCCH resource transmission from a first slot after a time considering a BAT based on the unified TCI scheme (hereinafter, simply described as “after BAT”). When 12 is configured to be “01”, the base station may indicate the UE to update a first uplink beam among the two uplink beams, which may be used for the PUCCH resource transmission, after the BAT and to update a second uplink beam at a time before the BAT (hereinafter, simply described as “before BAT”), which satisfies only a specific threshold time. When I2 is configured to be “10”, the base station may indicate the UE to update the first uplink beam among the two uplink beams, which may be used for the PUCCH resource transmission, before the BAT and to update the second uplink beam after the BAT. When I2 is configured to be “11”, the base station may indicate the UE to update both the uplink beams, which may be used for the PUCCH resource transmission, before BAT. As another MAC CE signaling configuration method, the number 3824 or 3827 of indicated TCI states and a method 3825 or 3828 of applying the TCI states may be indicated using a structure as in reference numeral 3820 with respect to all PUCCH resources in a PUCCH resource group including an indicated PUCCH resource 3823 or 3826. A specific operation according to a value configured for each of the I1 area and I2 area is the same as that described for the I1 area and I2 area of reference numeral 3810, but there may be a difference that an operation indicated via a corresponding area is collectively indicated for all PUCCH resources in a PUCCH group including a corresponding PUCCH resource configured by a higher-layer configuration, instead of being applied to only one PUCCH resource. For example, when a first PUCCH resource group includes PUCCH resources 1, 2, and 3, and PUCCH resource 2 is configured in the region 3823, the number of TCI states to be applied and the method of applying the TCI states, which are indicated via the I1 area and the I2 area, may be updated for all PUCCH resources 1, 2, and 3.

As shown in FIG. 38, MAC CE signaling may include each of the I1 area and I2 area, but MAC CE signaling may include only one of the two areas, and an operation for an area that is not included may not be supported. Alternatively, an operation not configured in MAC CE signaling may be supported based on a higher-layer configuration or DCI indication instead of MAC CE signaling. In addition, the MAC CE signaling configuration method as in FIG. 38 is merely an example among various MAC CE signaling configuration methods and may be indicated via other similar forms of MAC CE, and as in an example, a method in which a MAC CE is applied to PUCCH configuration levels (e.g., for each PUCCH resource set or PUCCH format, etc.) other than a PUCCH resource or a PUCCH resource group may also be considered.

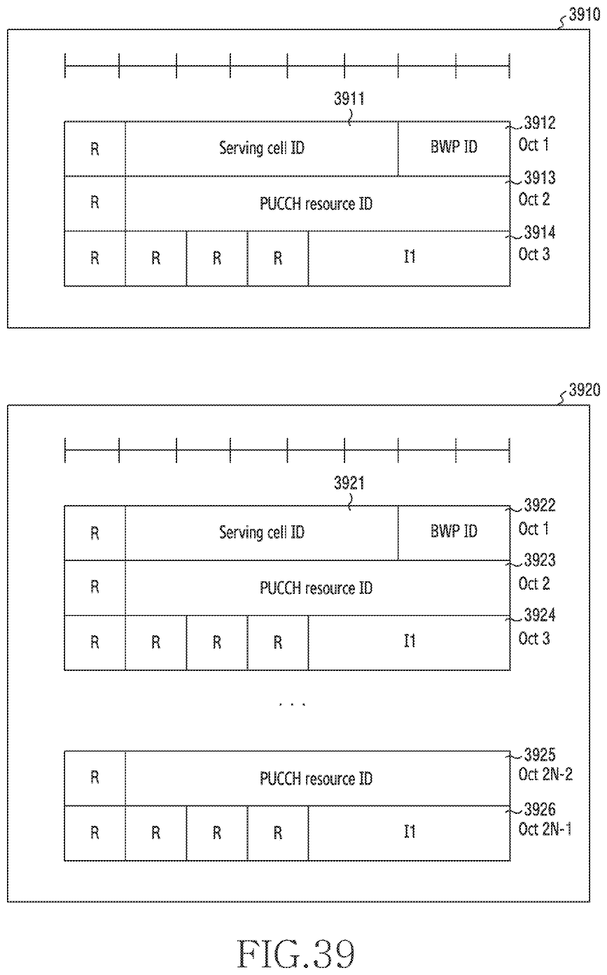

FIG. 39 illustrates an example of a MAC CE for activating the number of indicated TCI states to be applied and a method of applying the TCI states according to an embodiment of the disclosure.

Referring to FIG. 39, FIG. 39 is similar to FIG. 38, but may be configured by integrating areas for indicating the number of indicated TCI states to be applied and a method of applying the TCI states. This may be similar to adding one higher-layer parameter that considers both additional configurations 1 and 2 in the 3-1st embodiment, and values indicated via an I area may be mapped one-to-one to candidate values 1 to 6 described above, respectively. For example, when MAC CE signaling is configured as in reference numeral 3910, and a value of the I area is “000”, an indication may be made to perform operation in the same way as in [candidate value 1: applying a single beam by considering BAT] described in the 3-1st embodiment. An uplink transmission beam for a corresponding PUCCH resource may be determined using only one of indicated TCI states, and this may be applied after a BAT. The value of the I area “101” may indicate to perform operation in the same way as in [candidate value 6: using all beams and applying the all beams quickly before BAT] described in the 3-1st embodiment. For example, uplink transmission beam(s) for PUCCH resources are determined using all the indicated TCI states, and these may be quickly applied before the BAT. When an operation number greater than 6 is defined or more than two TCI states are supported, the I area including 3 bits in FIG. 39 may be configured to be an area with greater than 3 bits. If reference numeral 3910 is a MAC CE signaling configuration method for a single PUCCH resource, reference numeral 3920 may be a MAC CE signaling configuration method applicable in units of PUCCH resource groups. The number of indicated TCI states to be applied and a method of applying the TCI states for all PUCCH resources in a PUCCH resource group including indicated PUCCH resource 3923 or 3925 may be indicated via one field 3924 or 3926. According to an embodiment, if it is assumed, as described in the 3-1st embodiment, that operations according to a total of 6 candidate values are supported, a first PUCCH resource group includes PUCCH resources 1, 2, and 3, and PUCCH resource 1 is configured in the 3923 area, when the I area 3924 for PUCCH resource 1 3923 is configured to be “001”, this may indicate a UE to operate in the same way as in [candidate value 2: applying a single beam quickly before BAT] in the 3-1st embodiment with respect to all PUCCH resources 1, 2, and 3 in the PUCCH resource group including PUCCH resource 1. For example, the UE may determine uplink transmission beams for PUCCH resources in the PUCCH resource group by using only one TCI state among the indicated TCI states, and apply the same before the BAT. Similarly, when the I area 3926 for another PUCCH resource group including another PUCCH resource 3925 is configured, all PUCCH resources in the PUCCH resource group including the PUCCH resource may be collectively updated to the operation indicated by the I area.

For the MAC CE-based operations for PUCCH resources described in the 3-2nd embodiment, information on the number of TCI states to be applied among TCI states indicated by DCI and a method of applying the TCI states are indicated by an MAC CE, and updated operations may be applied to the UE from 3 ms after a time when ACK indicating that the UE has successfully received the MAC CE is transmitted on a PUCCH.

### 3-3rd Embodiment: Operations of Transmitting a PUCCH by Selecting the Number of Single or Multiple TCI States to be Applied and a Method of Applying the TCI States According to DCI for PUCCH Transmission

According to an embodiment of the disclosure, a detailed description is provided for a method of transmitting a PUCCH by selecting the number of single or multiple TCI states to be applied and a method of applying the TCI states, via a DCI-based indication for PUCCH transmission.

According to an embodiment of the disclosure, a base station may receive a UE capability report of a UE, and based on this, the base station may define and use a new area in DCI for indicating, to the UE, the number of TCI states to be applied and a method of applying the TCI states. In this case, a configuration method indicated to the UE via DCI may include, in the same manner as described in the 3-1st embodiment, information on whether to use only a single TCI state among the indicated multiple TCI states or to use all the TCI states (or whether to use some TCI states greater than 1 may also be considered), whether to update a TCI state indicated via DCI from a first slot after a BAT considering the unified TCI scheme, or whether to perform updating to the indicated TCI state even before the BAT considering the unified TCI scheme if only a certain threshold time (e.g., a time for which a DCI decoding and beam application time, such as “timeDurationForQCL”, has been considered) is satisfied.

A new area may be added to the DCI identically or similarly to the I area added during the MAC CE configuration in the 3-2nd embodiment described above. For example, as described in FIG. 38, two different areas may be added to the DCI, such as I1 and I2, so that the number of indicated TCI states to be applied and the method of applying the TCI states may be indicated, respectively. In this case, each of the DCI areas I1 and I2 may be interpreted identically or similarly to the above description in FIG. 38. Alternatively, as described in FIG. 39, one new area, such as 1, may be added to the DCI so that the number of indicated TCI states to be applied and the method of applying the TCI states may be indicated in a unified manner. In this case, the DCI area I may be interpreted identically or similarly to the above description in FIG. 39. The largest difference from the MAC CE-based operation in the 3-2nd embodiment is that a time required for the UE to indicate, update, and apply the number of indicated TCI states to be applied and the method of applying the TCI states is different. As described in the 3-2nd embodiment, the UE may successfully receive the MAC CE including the updated information, and 3 ms after a time when ACK indicating the successful reception is transmitted on the PUCCH, the UE may perform updating using the information and perform PUCCH transmission based thereon. However, when the information is indicated via DCI as in the 3-3rd embodiment, the UE may update the information similarly to the method of applying TCI states indicated via DCI, and may perform PUCCH transmission based the updated information. For example, the UE may apply the updated information from a point in time when a certain threshold time is satisfied or may apply the updated information from a first slot after a BAT based on the unified TCI scheme. This may be advantageous in that information updating faster than 3 ms is possible after ACK transmission for MAC CE reception. On the other hand, DCI overhead may increase due to the newly added I1 and I2 areas or I area.

The methods, such as using higher-layer parameters, MAC CE signaling, or DCI indications, for determining the number of uplink beams according to TCI states and an application method thereof during PUCCH transmission, described in the third embodiment, may be applicable to signals other than a PUCCH. When the methods for determining the number of beams and the beam application method described above for PUSCH are supported, a PUSCH transmission-related higher-layer parameter, new MAC CE signaling, new area in DCI for scheduling/activation of PUSCH transmission, etc. may be used.

The operations described in the third embodiment specifically describes a method of indicating one of various operations, such as dynamic switching (PUCCH transmission via only a single TCI state or PUCCH transmission via all indicated TCI states) and fast beam switching (operation of updating a beam even before a BAT or updating a beam at a time considering the BAT), by using a TCI state indicated based on the unified TCI scheme during PUCCH transmission. However, these operations are not limited to a PUCCH, and the methods may be reinforced to operate in conjunction with a PDSCH. The aforementioned operations based on a higher-layer configuration, MAC CE signaling, or a DCI indication may be applied not only to determination of information on the number of TCI states used among TCI states indicated via DCI for PUCCH transmission and a method of applying the TCI states, but also to PDSCH reception of a UE. In order to extend to PDSCH in this way, a base station and a UE may define in advance that the PUCCH-related higher-layer configuration, MAC CE signaling, or DCI area described above should be applied not only to PUCCH transmission but also to PDSCH. Alternatively, the new parameters described in the 3-1st embodiment may be configured for a non-PUCCH-related configuration, such as a corresponding support cell configuration, a corresponding activated BWP configuration, or any other higher-layer configuration which may be associated with both uplink and downlink. The application scope of MAC CE signaling may also be defined so that application of MAC CE signaling may be extended to PDSCH instead of PUCCH. The newly added I1 and I2 areas or I area in DCI may also be defined so as to be applicable to PDSCH as well as to PUCCH transmission. Alternatively, separately from PUCCH, the new higher-layer parameter, MAC CE signaling, or new area in DCI described in the third embodiment may be newly introduced to determine a method of indicating the number of TCI states used for PDSCH and applying the TCI states. In this case, the number of TCI states used for transmission or reception of a PUCCH or PDSCH among TCI states indicated via DCI according to a separate configuration or indication for the PUCCH and PDSCH may be determined according to each configuration or indication, and a method of applying the TCI states may also be determined according to each configuration or indication. This method is described as an example for PUCCH and PDSCH, but various configuration or indication methods may be used by considering not only PUCCH and PDSCH but also PUSCH and PDCCH.

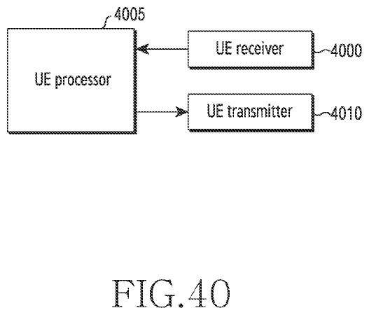

FIG. 40 illustrates a structure of a UE in a wireless communication system according to an embodiment of the disclosure.

Referring to FIG. 40, the UE may include a transceiver, which refers to a UE receiver 4000 and a UE transmitter 4010 as a whole, a memory (not illustrated), and a UE processor 4005 (or UE controller or processor). The UE transceiver 4000 and 4010, the memory, and the UE processor 4005 may operate according to the above-described communication methods of the UE. Components of the UE are not limited to the above-described example. For example, the UE may include a larger or smaller number of components than the above-described components. Furthermore, the transceiver, the memory, and the processor may be implemented in the form of a single chip.

The transceiver may transmit/receive signals with the base station. The signals may include control information and data. To this end, the transceiver may include an RF transmitter configured to up-convert and amplify the frequency of transmitted signals, an RF receiver configured to low-noise-amplify received signals and down-convert the frequency thereof, and the like. This is only an embodiment of the transceiver, and the components of the transceiver are not limited to the RF transmitter and the RF receiver.

In addition, the transceiver may receive signals through a radio channel, output the same to the processor, and transmit signals output from the processor through the radio channel.

The memory may store programs and data necessary for operations of the UE. In addition, the memory may store control information or data included in signals transmitted/received by the UE. The memory may include storage media such as a ROM, a RAM, a hard disk, a CD-ROM, and a DVD, or a combination of storage media. In addition, the UE may include multiple memories.

In addition, the processor may control a series of processes such that the UE can operate according to the above-described embodiments. For example, the processor may control components of the UE so as to receive DCI configured in two layers such that multiple PDSCHs are received simultaneously. The UE may include multiple processors, and the processors may perform the UE's component control operations by executing programs stored in the memory.

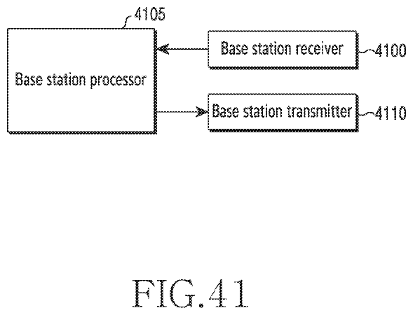

FIG. 41 illustrates a structure of a base station in a wireless communication system according to an embodiment of the disclosure.

Referring to FIG. 41, the base station may include a transceiver, which refers to a base station receiver 4100 and a base station transmitter 4110 as a whole, a memory (not illustrated), and a base station processor 4105 (or base station controller or processor). The base station transceiver 4100 and 4110, the memory, and the base station processor 4105 may operate according to the above-described communication methods of the base station. Components of the base station are not limited to the above-described example. For example, the base station may include a larger or smaller number of components than the above-described components. Furthermore, the transceiver, the memory, and the processor may be implemented in the form of a single chip.

The transceiver may transmit/receive signals with the UE. The signals may include control information and data. To this end, the transceiver may include an RF transmitter configured to up-convert and amplify the frequency of transmitted signals, an RF receiver configured to low-noise-amplify received signals and down-convert the frequency thereof, and the like. This is only an embodiment of the transceiver, and the components of the transceiver are not limited to the RF transmitter and the RF receiver.

In addition, the transceiver may receive signals through a radio channel, output the same to the processor, and transmit signals output from the processor through the radio channel.

The memory may store programs and data necessary for operations of the base station. In addition, the memory may store control information or data included in signals transmitted/received by the base station. The memory may include storage media such as a ROM, a RAM, a hard disk, a CD-ROM, and a DVD, or a combination of storage media. In addition, the base station may include multiple memories.

The processor may control a series of processes such that the base station can operate according to the above-described embodiments of the disclosure. For example, the processor may control components of the base station so as to configure DCI configured in two layers including allocation information regarding multiple PDSCHs and to transmit the same. The base station may include multiple processors, and the processors may perform the base station's component control operations by executing programs stored in the memory.

According to various embodiments of the disclosure, a method performed by a base station in a wireless communication system may include receiving UE capability information related to a transmission configuration indication (TCI) from a UE, determining, based on the received UE capability information, a higher-layer parameter related to the TCI, which includes at least one of information on a method of selecting a TCI state applied to uplink transmission or information on a method of applying the TCI state, transmitting the determined higher-layer parameter related to the TCI to the UE, transmitting at least one of a scheduled physical downlink control channel (PDCCH) or a scheduled physical downlink shared channel (PDSCH) to the UE, and receiving, from the UE, a physical uplink control channel (PUCCH) transmitted based on the determined higher-layer parameter related to the TCI.

According to an embodiment, the method performed by the base station may further include transmitting a medium access control (MAC) control element (CE) related to the TCI to the UE, wherein the MAC CE includes information indicating activation of an application method and an application number of the TCI state.

According to an embodiment, the method performed by the base station may further include transmitting downlink control information (DCI) related to the TCI to the UE, wherein the DCI includes information indicating the application method and the application number of the TCI state.

According to various embodiments of the disclosure, a method performed by a UE in a wireless communication system may include transmitting UE capability information related to a transmission configuration indication (TCI) to a base station, receiving, from the base station, a higher-payer parameter related to the TCI, which is determined based on the UE capability information related to the TCI, and includes at least one of information on a method of selecting a TCI state applied to uplink transmission or information on a method of applying the TCI state, receiving at least one of a scheduled physical downlink control channel (PDCCH) or a scheduled physical downlink shared channel (PDSCH) from the base station, determining an uplink beam for physical uplink control channel (PUCCH) transmission, based on the received higher-layer parameter, and transmitting the PUCCH based on the determined beam.

According to an embodiment, the method performed by the UE may further include receiving a medium access control (MAC) control element (CE) related to the TCI from the base station, wherein the MAC CE includes information indicating activation of an application method and an application number of the TCI state.

According to an embodiment, the method performed by the UE may further include receiving downlink control information (DCI) related to the TCI from the base station, wherein the DCI includes information indicating the application method and the application number of the TC state.

According to various embodiments of the disclosure, a base station may include at least one processor configured to receive UE capability information related to a transmission configuration indication (TCI) from a UE, determine, based on the received UE capability information, a higher-layer parameter related to the TCI, which includes at least one of information on a method of selecting a TCI state applied to uplink transmission or information on a method of applying the TCI state, transmit the determined higher-layer parameter related to the TCI to the UE, transmit at least one of a scheduled physical downlink control channel (PDCCH) or a scheduled physical downlink shared channel (PDSCH) to the UE, and receive, from the UE, a physical uplink control channel (PUCCH) transmitted based on the determined higher-layer parameter related to the TCI.

According to an embodiment, the base station may include at least one processor further configured to transmit a medium access control (MAC) control element (CE) related to the TCI to the UE, wherein the MAC CE includes information indicating activation of an application method and an application number of the TCI state.

According to an embodiment, the base station may include at least one processor further configured to transmit downlink control information (DCI) related to the TCI to the UE, wherein the DCI includes information indicating the application method and the application number of the TCI state.

According to various embodiments of the disclosure, a UE may include at least one processor configured to transmit UE capability information related to a transmission configuration indication (TCI) to a base station, receive, from the base station, a higher-payer parameter related to the TCI, which is determined based on the UE capability information related to the TCI, and includes at least one of information on a method of selecting a TCI state applied to uplink transmission or information on a method of applying the TCI state, receive at least one of a scheduled physical downlink control channel (PDCCH) or a scheduled physical downlink shared channel (PDSCH) from the base station, determine an uplink beam for physical uplink control channel (PUCCH) transmission, based on the received higher-layer parameter, and transmit the PUCCH based on the determined beam.

According to an embodiment, the UE may include at least one processor further configured to receive a medium access control (MAC) control element (CE) related to the TCI to from the base station, wherein the MAC CE includes information indicating activation of an application method and an application number of the TCI state.

According to an embodiment, the UE may include at least one processor further configured to receive downlink control information (DCI) related to the TCI from the base station, wherein the DCI includes information indicating the application method and the application number of the TCI state.

According to various embodiments of the disclosure, a UE in a wireless communication system may include: at least one transceiver; and a controller coupled to the at least one transceiver, wherein the controller is configured to receive, from a base station, configuration information on one or more physical uplink control channel (PUCCH) resources indicating at least one transmission configuration indicator (TCI) state and information on a TCI state application time point, receive, from the base station, first downlink control information (DCI) including information indicating first one or more TCI states, receive, from the base station, second DCI which is for scheduling of a PUCCH and includes information indicating second one or more TCI states and an indicator for at least one PUCCH resource, and transmit the PUCCH to the base station based on the first DCI, the second DCI, and the TCI state application time point.

According to an embodiment, the configuration information on the one or more PUCCH resources indicating the at least one TCI state and the information on the TCI state application time point may be received via at least one of a radio resource control (RRC), a medium access control (MAC) control element (CE), or DCI.

According to an embodiment, the information on the TCI state application time point may indicate one of application at a time point before a beam application time (BAT) or application at a time point after the BAT, and the BAT may be a time from a last symbol of the PUCCH to a symbol after a certain period of time.

According to an embodiment, in order to transmit the PUCCH based on the first DCI, the second DCI, and the TCI state application time point, the controller may be configured to identify at least one TCI state corresponding to the at least one PUCCH resource among the second one or more TCI states, identify a time point to be individually applied to the identified at least one TCI state, based on the information on the TCI state application time point, and transmit the PUCCH based on the identified at least one TCI state and the identified time point to be applied.

According to an embodiment, the one or more PUCCH resources indicating the at least one TCI state may include at least one of a PUCCH resource indicating a first TCI state among the second one or more TCI states, a PUCCH resource indicating a second TCI state among the second one or more TCI states, or a PUCCH resource indicating the first TCI state and the second TCI state among the second one or more TCI states.

According to an embodiment, the time point before the BAT may be a time point between after a certain threshold period from a time point, at which the second DCI is received, and the time point before the BAT.

According to various embodiments of the disclosure, a base station in a wireless communication system may include: at least one transceiver; and a controller coupled to the at least one transceiver, wherein the controller is configured to transmit, to a UE, configuration information on one or more physical uplink control channel (PUCCH) resources indicating at least one transmission configuration indicator (TCI) state and information on a TCI state application time point, transmit, to the UE, first downlink control information (DCI) including information indicating first one or more TCI states, transmit, to the UE, second DCI which is for scheduling of a PUCCH and includes information indicating second one or more TCI states and an indicator for at least one PUCCH resource, and receive the PUCCH from the UE based on the first DCI, the second DCI, and the TCI state application time point.

According to an embodiment, the configuration information on the one or more PUCCH resources indicating the at least one TCI state and information on the TCI state application time point may be transmitted via at least one of a radio resource control (RRC), a medium access control (MAC) control element (CE), or DCI.

According to an embodiment, the information on the TCI state application time point may indicate one of application at a time point before a beam application time (BAT) or application at a time point after the BAT, and the BAT may be a time from a last symbol of the PUCCH to a symbol after a certain period of time.

According to an embodiment, the PUCCH may be received based on a time point to be individually applied to the at least one TCI state, which is identified based on the information on the TCI state application time point, and the at least one TCI state corresponding to the at least one PUCCH resource among the second one or more TCI states.

According to an embodiment, the one or more PUCCH resources indicating the at least one TCI state may include at least one of a PUCCH resource indicating a first TCI state among the second one or more TCI states, a PUCCH resource indicating a second TCI state among the second one or more TCI states, or a PUCCH resource indicating the first TCI state and the second TCI state among the second one or more TCI states.

According to an embodiment, the time point before the BAT may be a time point between after a certain threshold period from a time point, at which the second DCI is received, and the time point before the BAT.

According to various embodiments of the disclosure, a method performed by a terminal in a wireless communication system may include: receiving, from a base station, configuration information on one or more physical uplink control channel (PUCCH) resources indicating at least one transmission configuration indicator (TCI) state and information on a TCI state application time point; receiving, from the base station, first downlink control information (DCI) including information indicating first one or more TCI states; receiving, from the base station, second DCI which is for scheduling of a PUCCH and includes information indicating second one or more TCI states and an indicator for at least one PUCCH resource; and transmitting the PUCCH to the base station based on the first DCI, the second DCI, and the TCI state application time point.

According to an embodiment, the configuration information on the one or more PUCCH resources indicating the at least one TCI state and the information on the TCI state application time point may be received via at least one of a radio resource control (RRC), a medium access control (MAC) control element (CE), or DCI.

According to an embodiment, the information on the TCI state application time point may indicate one of application at a time point before a beam application time (BAT) or application at a time point after the BAT, and the BAT may be a time from a last symbol of the PUCCH to a symbol after a certain period of time.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

Moreover, the programs may be stored in an attachable storage device which may access the electronic device through communication networks such as the Internet, Intranet, Local Area Network (LAN), Wide LAN (WLAN), and Storage Area Network (SAN) or a combination thereof. Such a storage device may access the electronic device via an external port. Furthermore, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

The embodiments of the disclosure described and shown in the specification and the drawings are merely specific examples that have been presented to easily explain the technical contents of embodiments of the disclosure and help understanding of embodiments of the disclosure, and are not intended to limit the scope of embodiments of the disclosure. That is, it will be apparent to those skilled in the art that other variants based on the technical idea of the disclosure may be implemented. Furthermore, the above respective embodiments may be employed in combination, as necessary. For example, a part of one embodiment of the disclosure may be combined with a part of another embodiments to operate a base station and a terminal. As an example, embodiment 1 and 2 of the disclosure may be partially combined with each other to operate a base station and a terminal. Moreover, although the above embodiments have been described based on the FDD LTE systems, other variants based on the technical idea of the embodiments may also be implemented in other systems such as TDD LTE, 5G, or NR systems.

In the drawings in which methods of the disclosure are described, the order of the description does not always correspond to the order in which steps of each method are performed, and the order relationship between the steps may be changed or the steps may be performed in parallel.

Alternatively, in the drawings in which methods of the disclosure are described, some elements may be omitted and only some elements may be included therein without departing from the essential spirit and scope of the disclosure.

In addition, in methods of the disclosure, some or all of the contents of each embodiment may be implemented in combination without departing from the essential spirit and scope of the disclosure.

Various embodiments of the disclosure have been described above. The above description of the disclosure has been given by way of example, and embodiments of the disclosure are not limited to the embodiments disclosed herein. Those skilled in the art will appreciate that other specific modifications and changes may be easily made thereto without changing the technical idea or essential features of the disclosure. The scope of the disclosure is defined by the appended claims, rather than the above detailed description, and the scope of the disclosure should be construed to include all changes or modifications derived from the meaning and scope of the claims and equivalents thereof.

1. A user equipment (UE) in a wireless communication system, the UE comprising:
at least one transceiver; and
a controller coupled to the at least one transceiver,
wherein the controller is configured to:
receive, from a base station, configuration information on one or more physical uplink control channel (PUCCH) resources indicating at least one transmission configuration indicator (TCI) state and information on a TCI state application time;
receive, from the base station, first downlink control information (DCI) comprising information indicating first one or more TCI states;
receive, from the base station, second DCI which is for scheduling of a PUCCH and comprises information indicating second one or more TCI states and an indicator for at least one PUCCH resource; and
transmit the PUCCH to the base station based on the first DCI, the second DCI, and the TCI state application time.

2. The UE of claim 1, wherein the configuration information on the one or more PUCCH resources indicating the at least one TCI state and the information on the TCI state application time are received via at least one of a radio resource control (RRC), a medium access control (MAC) control element (CE), or DCI.

3. The UE of claim 1, wherein the information on the TCI state application time indicates one of application at a time before a beam application time (BAT) or application at a time after the BAT, and
wherein the BAT is a time from a last symbol of the PUCCH to a symbol after a certain period of time.

4. The UE of claim 1, wherein in order to transmit the PUCCH based on the first DCI, the second DCI, and the TCI state application time, the controller is configured to:
identify at least one TCI state corresponding to the at least one PUCCH resource among the second one or more TCI states;
identify a time to be individually applied to the identified at least one TCI state, based on the information on the TCI state application time; and
transmit the PUCCH based on the identified at least one TCI state and the identified time to be applied.

5. The UE of claim 1, wherein the one or more PUCCH resources indicating the at least one TC state comprises at least one of a PUCCH resource indicating a first TCI state among the second one or more TCI states, a PUCCH resource indicating a second TCI state among the second one or more TCI states, or a PUCCH resource indicating the first TCI state and the second TCI state among the second one or more TCI states.

6. The UE of claim 3, wherein the time before the BAT is a time between after a certain threshold period from a time, at which the second DCI is received, and the time before the BAT.

7. A base station in a wireless communication system, the base station comprising:
at least one transceiver; and
a controller coupled to the at least one transceiver,
wherein the controller is configured to:
transmit, to a user equipment (UE), configuration information on one or more physical uplink control channel (PUCCH) resources indicating at least one transmission configuration indicator (TCI) state and information on a TCI state application time;
transmit, to the UE, first downlink control information (DCI) comprising information indicating first one or more TCI states;
transmit, to the UE, second DCI which is for scheduling of a PUCCH and comprises information indicating second one or more TCI states and an indicator for at least one PUCCH resource; and
receive the PUCCH from the UE based on the first DCI, the second DCI, and the TCI state application time.

8. The base station of claim 7, wherein the configuration information on the one or more PUCCH resources indicating the at least one TCI state and the information on the TCI state application time are transmitted via at least one of a radio resource control (RRC), a medium access control (MAC) control element (CE), or DCI.

9. The base station of claim 7, wherein the information on the TCI state application time point indicates one of application at a time before a beam application time (BAT) or application at a time after the BAT, and
wherein the BAT is a time from a last symbol of the PUCCH to a symbol after a certain period of time.

10. The base station of claim 7, wherein the PUCCH is received based on a time to be individually applied to the at least one TCI state, which is identified based on the information on the TCI state application time, and the at least one TCI state corresponding to the at least one PUCCH resource among the second one or more TCI states.

11. The base station of claim 7, wherein the one or more PUCCH resources indicating the at least one TCI state comprises at least one of a PUCCH resource indicating a first TCI state among the second one or more TCI states, a PUCCH resource indicating a second TCI state among the second one or more TCI states, or a PUCCH resource indicating the first TCI state and the second TCI state among the second one or more TCI states.

12. The base station of claim 9, wherein the time before the BAT is a time between after a certain threshold period from a time, at which the second DCI is received, and the time before the BAT.

13. A method performed by a user equipment (UE) in a wireless communication system, the method comprising:
receiving, from a base station, configuration information on one or more physical uplink control channel (PUCCH) resources indicating at least one transmission configuration indicator (TCI) state and information on a TCI state application time;
receiving, from the base station, first downlink control information (DCI) comprising information indicating first one or more TCI states;
receiving, from the base station, second DCI which is for scheduling of a PUCCH and comprises information indicating second one or more TCI states and an indicator for at least one PUCCH resource; and
transmitting the PUCCH to the base station based on the first DCI, the second DCI, and the TCI state application time.

14. The method of claim 13, wherein the configuration information on the one or more PUCCH resources indicating the at least one TCI state and the information on the TCI state application time are received via at least one of a radio resource control (RRC), a medium access control (MAC) control element (CE), or DCI.

15. The method of claim 13, wherein the information on the TCI state application time indicates one of application at a time before a beam application time (BAT) or application at a time after the BAT, and
wherein the BAT is a time from a last symbol of the PUCCH to a symbol after a certain period of time.
